(19) United States
(12) Patent Application Publication
(10) Pub. No.: US 2012/0013462 A1
(43) Pub. Date: Jan. 19, 2012

(54) Personal radio location system

(76) Inventors: Edward F. Tuck, West Covina, CA (US); Martie g. Haselton, Culver City, CA (US); Christine E. Garver-Apgar, Lafayette, CO (US)

(21) Appl. No.: 13/066,536

(22) Filed: Apr. 14, 2011

Related U.S. Application Data
(63) Continuation-in-part of application No. 11/239,603, filed on Sep. 28, 2005, now Pat. No. 7,969,301.
Application No. 11/239,603 is a continuation-in-part of application No. 11/286,143, filed on Nov. 23, 2005, now abandoned.
Application No. 11/286,143 is a continuation-in-part of application No. 11/360,025, filed on Feb. 21, 2006, now abandoned.
Application No. 11/360,025 is a continuation-in-part of application No. 11/405,001, filed on Apr. 14, 2006, now abandoned.
Application No. 11/405,001 is a continuation-in-part of application No. 11/881,153, filed on Jul. 24, 2007, now abandoned.
Application No. 11/881,153 is a continuation-in-part of application No. 12/290,877, filed on Nov. 3, 2008.
Application No. 12/290,877 is a continuation-in-part of application No. 12/313,263, filed on Nov. 17, 2008.
Application No. 12/313,263 is a continuation-in-part of application No. 12/590,433, filed on Nov. 5, 2009, now Pat. No. 7,940,174.
Application No. 12/590,433 is a continuation-in-part of application No. 12/590,515, filed on Oct. 24, 2008.
Application No. 12/590,515 is a continuation-in-part of application No. 12/799,210, filed on Apr. 19, 2010.

(51) Int. Cl. G08B 1/08

(52) U.S. Cl. 340/539.13

(57) ABSTRACT

Methods and apparatus for using an energy emanating device to find a person (17a,b) or an object based on preselected attributes (33) stored in the energy emanating device (10) are disclosed. An alternative embodiment provides a relationship prediction based on the correlation of personal characteristics and the analysis of genetic characteristics.

### CROSS-REFERENCE TO A RELATED PENDING U.S. PATENT APPLICATION & CLAIM FOR PRIORITY

The Present Application is a Continuation-in-Part Application, and is related to the following related Patent Applications:

| | | |
|---|---|---|
| U.S.S.N. 11/239,603 | 28 Sep. 2005 | Pending |
| U.S.S.N. 11/286,143 | 23 Nov. 2005 | Pending |
| U.S.S.N. 11/360,025 | 21 Feb. 2006 | Pending |
| U.S.S.N. 11/405,001 | 14 Apr. 2006 | Pending |
| U.S.S.N. 11/881,153 | 24 Jul. 2007 | Pending |
| U.S.S.N. 12/290,877 | 3 Nov. 2008 | Pending |
| U.S.S.N. 12/313,263 | 17 Nov. 2008 | Pending |
| U.S.S.N. 12/590,433 | 5 Nov. 2009 | Pending |
| U.S.S.N. 12/590,515 | 24 Oct. 2008 | Pending |
| U.S.S.N. 12/799,210 | 19 Apr. 2010 | Pending |

The Applicants hereby claim the benefit of priority under Title 35, Sections 119 and/or 120, for any subject matter which is commonly disclosed in the Present Patent Application, and in any of these related Patent Applications. The contents of all the related Patent Applications that are listed above and which have been published are hereby incorporated by reference into the Present Patent Application.

### FEDERALLY SPONSORED RESEARCH OR DEVELOPMENT

None.

### FIELD OF THE INVENTION

The present invention pertains to methods and apparatus for using an electronic device to find a person or system who meets criteria specified by a user and/or to establish mutual compatibility between or among two or more people or systems. More particularly, one preferred embodiment of the invention uses a small radiating device using radio, optical, supersonic or other means that automatically and continuously or periodically emits a signal which interrogates other similar devices. When the user's device finds another person or system whose device returns a signal that matches the user's pre-specified criteria, the user is alerted by a visual and/or audible signal. Alternatively, the other user's or users' device(s) might passively receive the emitted signals and give its user an indication that a criteria-meeting device is within range. In alternative embodiments, the present invention furnishes relationship predictions directly to customers.

### BACKGROUND OF THE INVENTION

For almost all of their existence as a separate species, humans have lived in relatively isolated groups (“hunting-gathering camps”) of ten to forty people. See Tuck, Edward F. and Earle, Timothy “Why CEOs Succeed and Why They Fail,” published in Strategy and Business, Issue 5 (Fourth Quarter 1996). The group behaviors of humans, and their bodies and senses, have evolved to fit this manner of living.

All animals, including insects and bacteria, and many plants, have some means of communicating with others of their species. The most common means use the chemical senses: taste and smell. Some of the substances that activate these senses for information transfer are called pheromones. Pheromones are defined in the Merriam-Webster Office Dictionary as “a chemical substance that is produced by an animal and serves especially as a stimulus to other individuals of the same species for one or more behavioral responses.”

Some pheromones are sexual attractants. The few pheromones still retained by humans are specific odors that seem to be for that purpose. However, many animals use odors other than pheromones to provide far more detailed information. Researchers have found, for example, that some rodents select their mates on the basis of complementary Major Histocompatibility Complexes (MHC) defined in the Merriam-Webster Office Dictionary as “a group of genes in mammals that function especially in determining the Histocompatibility antigens found on cell surfaces.” The MHC contributes to the animal's personal smell and provides a unique identifier of the animal. The MHC, and therefore that personal odor, also carries information on the animal's immune system. Researchers have found that many mammals, such as mice, select their mate on the basis of complementary MHCs, thus maximizing the number of different immune responses. See Boyse E A, Beauchamp G K, Yamazaki K., et al. “Chemosensory Communication—A New Aspect of the Major Histocompatibility Complex and Other Genes in the Mouse,” Journal of Oncodevelopmental Biology and Medicine, Vol. 4 No. 1-2: pages 101-116, 1982. This makes for more disease-resistant, and, thus fitter, offspring. Animals with distinct MHCs are not closely related, and selection based on these criteria also avoids the hazards of consanguinity, which amplifies genetic defects. This is analogous to the human taboo against marrying one's close relatives.

The predominant pheromones among mammals are odors. These odors are produced in the skin or passed along in breath or urine. The sense of smell in free-ranging mammals is exquisitely sensitive and complex: it can identify a range of odors far greater than is required to avoid danger or seek prey. The major use of this sense is to detect and understand pheromones and to analyze the MHCs of others. To understand the profound importance of smell, one must know that the first organ to evolve after the spinal cord was an olfactory bulb at its end. The rest of a chordate's brain evolved from this base (vertebrates, including humans, are among the members of the phylum Chordata).

Unlike most mammals, humans and some apes have poor senses of smell, and also few pheromones. They have, however, kept their ability to detect and analyze MHC, even though their body odors still carry that information. This is best shown by the behavior of tracking dogs, who cannot distinguish between identical twins. This may be the result of the natural selection that took place in three million years of living in small camps, because they were no longer needed (human females do not have an estrus cycle like most other mammals. They are always receptive, and thus have no need to signal their receptiveness; degrees of consanguinity are public information in a small group. Camp dwellers historically found their mates in neighboring camps, which provided genetic separation; because they were usually in sight of one another, camp dwellers had no need for odors to advertise their gender, pregnancy, age, state of health and other visible features; humans in committed relationships usually adorn themselves with special marks, such as wedding rings, tattoos, hair length, and special clothing; other information on mood, such as fear, is easy to gain from the context of a person's actions).

In addition, pheromones may have been detrimental to the fitness of the camp (constant reminders of sex are distracting, and lead to jealousy and strife, which is deadly in a confined group; animals with strong odors are at more risk of predation.)

Between 10,000 and 100,000 years ago, depending on the society, most hunting-gathering societies combined into either pastoral or agricultural tribes. Tribes are much larger groups, and bring two new metrics: social rank and wealth. In human society, which by then relied entirely on visual cues, clothes, posture, jewelry, tattoos and scarification were used as markers for these metrics. There was still no need for “long-distance” chemical pheromones, because in a typical tribe of a few hundred people, everyone was seen by everyone else over a reasonable period of time.

In summary, identifying odors and behavior-modifying odors such as pheromones evolved and became of vital importance in creatures that were solitary or which lived in closely-related family groups. They became less important, and finally counterproductive, in species that tended to aggregate themselves into clumps of up to a few hundred individuals. In human societies the ability to detect and discriminate among those odors was essentially lost (and in some cultures the odors themselves are often intentionally suppressed, as with perfume and frequent bathing) and were replaced by their visual equivalents, some of which were eventually suppressed by clothing.

Modern urban society is radically different from life in a tribe or hunting-gathering camp, especially for singles. In 2005, over 30% of the households in the United States are inhabited by “single” people: unmarried people, married people living apart from their spouses, and single-parent households with small children. Specifically, in the year 2000, the United States had a population of 281 million, of which 224 million, or about 80%, lived in cities or metropolitan area of 100,000 or more people. These people lived in 105 million households, of which 33 million, or 31%, were nonfamily households (up from 26% in 1980), and 27 million, or 26%, were one-person households (up from 23% in 1980). See U.S. Census Bureau, Statistical Abstract of the United States: 2001, (121st edition) Washington, D.C. 2001.

Unlike his or her ancestors in a tribe or camp, the average person in the United States has a very poor chance of meeting a compatible stranger, either for friendship or matrimony, without exposure to embarrassment or danger. The traditional mechanisms for singles to meet are attendance at churches and bars; in the first case, it is considered bad form to “go shopping” from church to church, and in the second, there is very little protection against predators and chemically impaired judgment, and no mechanism to filter the compatible from the incompatible.

Note that while this analysis is, for simplicity's sake, cast in terms of singles seeking singles, it is recognized that in urban areas, families which would like to establish social contact with other families suffer an even greater disadvantage because of their lower mobility and more complex selection criteria. In addition, purely inanimate objects, such as cranes and containers in a shipyard, can benefit from a mechanism that establishes mutual compatibility on a peer-to-peer level, without intervention of clerks or computers.

Many individuals have difficulty finding a mate. According to www.eHarmony.com, 21 million Americans spent $313 million dollars in 2004 on Internet dating services. There are many other services similar to eHarmony.com, such as Match.com in the United States and Soulmates in the United Kingdom.

These are efficient, profitable and useful services. They not only find and filter acquaintance candidates, but also provide a sanctioned (though virtual) arena, like a church or small private party, in which strangers can meet without danger or embarrassment. They have the disadvantage of being cumbersome, time-consuming, and involving an elaborate contact ritual designed to avoid disappointment, embarrassment and danger; and the element of spontaneity, in which the best decisions are often made, is missing. See Gladwell, Malcolm, Blink: The Power of Thinking Without Thinking, Little, Brown & Co., 2005.

There is also the disadvantage that online selection does not correspond well to the selection process that takes place in real-life acquaintance scenarios. Recent studies involving “Instant Dating” tests have shown that physical appearance is by far the most important consideration in the early stages of acquaintance. This is true for both genders (though more so for men). Therefore, an acquaintance process that does not quickly include face-to-face contact is somewhat artificial.

Since it does not appear that natural pheromones and odors are greatly effective in helping men and women find each other, it would be extremely helpful if some type of man-made device could help enable people to find friends or mates based on specific criteria, retaining some of the precision and safety of the online dating sites, while maintaining the efficiency and naturalness of the church and the bar. It would also help to avoid some of the abusive and demeaning behavior now invading the dating process. See Netburn, Deborah, “Danger: Pickup Artists Ahead,” Los Angeles Times, Wednesday, Aug. 10, 2005, p. E1.

The development of such a device or system would constitute a major technological advance, and would satisfy long-felt needs and aspirations in the Internet dating industry.

### SUMMARY OF THE INVENTION

The present invention provides a simple miniaturized electronic device that enables individuals to find a friend, a mate or someone with a specific interest or skill. In one embodiment of the invention, a man or a woman may program a MateFinder™ to help find an ideal match. In one particular embodiment, the MateFinder™ comprises a radio and a microprocessor with a non-volatile memory, such as a static RAM. Information that describes both the user and the ideal match can be written to the non-volatile memory. The radio automatically and periodically broadcasts a “seeking signal” over a short range. When the seeking signal is received by another MateFinder™, it is analyzed to determine the degree of correlation with the receiver's preferences. If the degree of correlation exceeds a preset minimum, the sender, the receiver, or both are alerted. In another embodiment, the present invention provides methods and apparatus for providing a relationship prediction based on the correlation of personal characteristics and the analysis of genetic characteristics.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 offers a view of men and women attending a party. The man has a MateFinder™ clipped to his belt. Some of the women at the party have a MateFinder™ clipped to a purse or belt, or concealed in their clothing. The man's MateFinder™ produces a short-range radio signal that interrogates other MateFinders™ that are nearby. The interrogation signal may broadcast a description of the man and seeks another MateFinder™ that stores a list of qualities, characteristics or criteria that describe the gentleman's aspirations, preferences or requirements in a mate. When the interrogation signal finds a good match, the man is alerted by a visual or audible alert. If the man's own attributes match those sought by one of the women, the MateFinder™ may alert her to the presence of the man.

FIG. 2 supplies a perspective view of one particular embodiment of the invention, which may be clipped to a man's belt or to a lady's purse, or which may be concealed in the clothing of either. The MateFinder may also be incorporated into a bracelet, watch, necklace, tietack, shoe, hat or some other fashionable item or article.

FIG. 3 illustrates a woman who has visited a website, www.e-pheromone.com., using her personal computer. She has connected her MateFinder™ device to the USB port of her computer, and is programming her MateFinder™ with her own attributes, as well as with her preferences in a mate.

FIG. 4 is a flowchart that explains how a user employs the MateFinder™ to help find a person with characteristics that match the user's preferences.

FIG. 5 shows the same woman at some sort of social event among a number of men, perhaps at the beach, in a park, at a concert or attending a sporting event. The woman's MateFinder™ has found a match in the crowd, and alerts her to his presence.

FIG. 6 exhibits the operation of a pair of MateFinders™. When the man's device finds a woman's MateFinder™ that presents a good match, his device alerts him. In an alternative embodiment, the woman may respond by using her cellular telephone to send a message back to her prospective match.

FIG. 7 is a simplified schematic diagram of one embodiment of the present invention.

FIG. 8 is a more detailed schematic diagram which exhibits a particular implementation of the present invention.

FIG. 9 is a flow-chart that outlines a basic design for a software program that may be utilized in one embodiment of the invention.

FIGS. 10, 11, 12, 13, 14, 15, 16, 17, 18 and 19 summarize several various implementations and applications of the present invention.

FIG. 20 shows a woman using a personal computer to sign up for an account with a Big Internet Dating Service, and then place an order for an AromaMatch™ Test Kit.

FIG. 21 shows a page from the Big Internet Dating Service website that may be used to place an order.

FIG. 22 shows a page from the Big Internet Dating Service that may be used to enter attributes about the customer and his or her ideal match.

FIG. 23 shows an alternative embodiment of the invention, in which the woman uses a telephone to open the account and to place the order.

FIG. 24 shows a woman purchasing an AromaMatch™ Test Kit at a retail store.

FIG. 25 shows a woman receiving an AromaMatch™ Test Kit in a doctor's office.

FIG. 26 shows a woman receiving an AromaMatch™ Test Kit from a church or some other religious organization.

FIG. 27 depicts the woman opening the AromaMatch™ Test Kit to reveal its contents: a bottle, a cotton ball, a sample patch, a sealable plastic bag and a mailing envelope.

FIG. 28 supplies a detailed view of the sample patch.

In FIG. 29, the woman cleans a patch of skin in preparation for applying the sample patch to her armpit.

In FIG. 30, the woman applies the patch to her armpit.

FIG. 31 shows the woman wearing the patch for a day or longer.

FIG. 32 portrays the woman removing the sample patch from her arm on the next day.

In FIG. 33, the woman places the sample patch that she has worn for a day into the bag, and seals it.

In FIG. 34, the woman writes her password on the sealable bag.

In FIG. 35, the sample that has been sealed in the bag is placed in a mailing envelope.

FIG. 36 shows the woman mailing an envelope which contains the bag, which, in turn, contains the worn sample patch.

FIG. 37 shows a laboratory technician using an analyzer to determine the genetic attributes of the odor sample that has been received from the woman depicted in FIG. 36.

In FIG. 38, the woman uses her computer to visit a website to obtain the results of the laboratory analysis.

In FIG. 39, the website reports the results of a matching process that has been performed using a library of candidates.

FIG. 40 shows the woman receiving test results from a postal worker.

FIG. 41 shows the woman receiving test results from a physician.

FIG. 42 an alternative embodiment of the invention, in which a tissue sample is obtained using a cheek swab.

FIG. 43 exhibits yet another alternative embodiment, which collects a sample directly from the air surrounding a man.

FIG. 44 depicts the collection of a saliva sample in a container.

In FIG. 45, the sample saliva is mixed.

FIG. 46 shows the sample's being placed in a sample bag.

FIG. 47 shows the sample bag's being placed in a mailing box.

FIG. 48 shows the mailing box's being sealed.

FIG. 49 shows the box's being mailed.

FIG. 50 is a flow chart which illustrates laboratory collection kit preparation tasks.

FIG. 51 is a flow chart which illustrates dating service tasks.

FIG. 52 is a flow chart which illustrates customer tasks.

FIG. 53 is a flow chart which illustrates laboratory analysis, matching and reporting tasks.

FIG. 54 is a flow chart which illustrates dating service and laboratory cooperative tasks.

FIG. 55 is a graph of MHC alleles shared on the horizontal axis, a woman's sexual responsivity to partner on the vertical axis.

FIG. 56 is a bar chart showing the number of MHC alleles shared on the horizontal axis, and the woman's expected sexual responsivity to her partner on the vertical axis.

FIG. 57 is a chart that shows the relationship of alleles in the MHC Group on Human Chromosome No. 6.

FIG. 58 reveals the details of the MHC Allele Groups.

FIG. 59 illustrates HLA-A Allele Group Frequency for a European Population Dataset.

FIG. 60 illustrates HLA-B Allele Group Frequency for a European Population Dataset.

FIG. 61 illustrates HLA-DRβ1 Allele Group Frequency for a European Population Dataset.

FIG. 62 depicts Allele Group Frequencies.

FIG. 63 depicts A/B/DRβ1 Group Haplotype Frequency.

FIG. 64 shows a man using a MateFinder™ device.

FIG. 65 provides a more detailed view of a MateFinder™ device.

In FIG. 66, a woman whose tissue sample has already been analyzed receives a custom-formulated perfume which contains aromas that correspond to her genetic attributes.

FIG. 67 depicts a method of manufacturing a customized perfume.

FIG. 68 presents a Genoscope™ graphical aid, which may be used to indicate good or bad matches.

### A DETAILED DESCRIPTION OF PREFERRED & ALTERNATIVE EMBODIMENTS

### I. A Preferred Embodiment of the Invention

The present invention comprises methods and apparatus for finding someone or something with specific attributes using a radio device. In one embodiment of the invention, a MateFinder™ 10, which resembles a pager, may be used by a man or a woman to find a match.

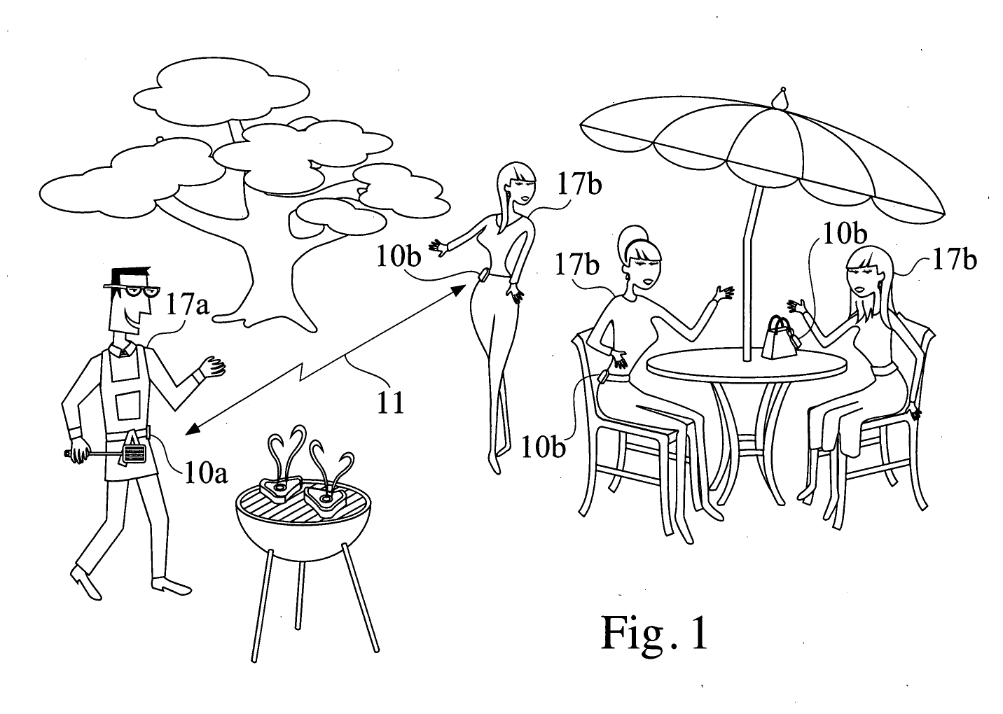

FIG. 1 is a representation of a private party. One of the hopes of some of the men and women who attend the party is that of finding a friend or a mate. In accordance with one embodiment of the present invention, a man 17a is shown wearing a MateFinder™ 10a clipped to his belt. A group of women 17b standing around or sitting at a table also have MateFinders 10b, which are clipped to their belts or purses or are concealed in their clothing. In general, the MateFinder™ 10 is an electronic device which uses a radio to help find someone or something which fits a predetermined description or some preselected criteria. In this Specification and in the Claims that follow, the MateFinders 10 are generally identified as 10a when used by a man or an unspecified “first user” 17a, and as 10b when used by a woman or unspecified “second user” 17b. The use of the reference characters ending in “a” and “b”, which are also recited in the Claims as the “first” and “second” transceivers, 10a and 10b, are intended to assist the reader in understanding the invention, but do not connote any substantive differences in the device 10.

The man's MateFinder™ 10a continuously emits an automatic and generally continuous radio seeking or interrogation signal 11. This signal 11 illuminates or interrogates other MateFinder radios that are within range. The man 17a has programmed his MateFinder 10a with a set of attributes that describes himself, and this information is conveyed by the signal 11 emitted by his MateFinder. This signal 11 may also convey a description of the woman that he is interested in finding. If the man's MateFinder signal finds a woman who fits his preselected set of criteria, his MateFinder issues a visual and/or audible alert. If the man's MateFinder signal contains a description that matches the woman's predetermined description of a suitable man, the woman's MateFinder alerts her to his presence. The location and/or identity of each person carrying the MateFinder is not initially available to the users. For example, in one possible use, exemplars of the device would be worn (possibly concealed) by a number of users attending a large private party or public function. Each user's MateFinder would emit its own interrogation signal, for example, first interrogation signal 11a, and second interrogation signal 11b. Users would be alerted to the presence of compatible types, along with an indication of the degree of correlation found and whether a selected matching signal's position is masked. The user would then have the option of unmasking his or her position to the emitter of a specific signal, possibly by changing the modulation scheme to one that allows its strength to be detected. Users could then approach each other by maximizing their indication of the other's signal strength. It should be possible to see the target person at a safe distance before making further contact. The present invention reduces the risk that is inherent in Internet or other forms of remote or electronic dating by allowing a user to evaluate a prosective match in person before initiating contact.

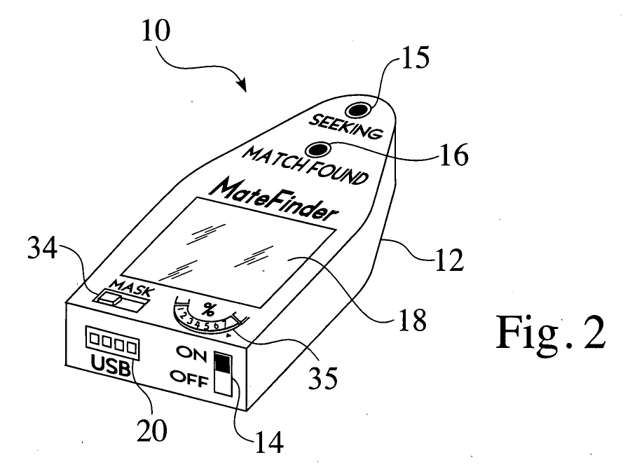

FIG. 2 furnishes a perspective view of one embodiment of the MateFinder device 10. A housing 12 made of plastic or some other suitable material encloses a radio (not shown in FIG. 2). A power switch 14 is located on the base of the housing 12. When the power switch 14 is turned to the “ON” position, an LED 15 labeled “SEEKING” flashes periodically to indicate that the MateFinder™ 10 is emitting a signal. When the MateFinder™ finds a match, an LED 16 labeled “MATCH FOUND” is illuminated. The illumination of the “MATCH FOUND” LED 16 may be accompanied by an audible alarm or tone, vibration or some other suitable means for alerting the user. In an embodiment in which two MateFinders 10 are used, each MateFinder includes a match indicator, 16a and 16b. A miniature LCD screen 18 is situated on one side of the MateFinder 10. This screen 18 is used to read messages which may be sent by the person who is detected by the seeking signal 11, or to view a list of possible matches detected by the MateFinder. A USB 20 or some other suitable port for connecting the MateFinder 10 to a personal computer or some other appliance or device is located on the base of the device. In an alternative embodiment, the USB port 20 may be replaced or enhanced by a wireless connection. A “Mask” switch 34 enables the user to allow the matching MateFinder to locate him or her by electronic means. A correlation switch 35 enables the user to adjust the level of matching that is performed by the MateFinder. For example, if the user turns the thumbwheel 35 toward the “10” indicator on the wheel, he or she is instructing the MateFinder to seek out a stronger or higher level of correlation between the preselected qualities or attributes stored in his or her MateFinder and a potential candidate. By turning the thumbwheel 35 down towards “1”, the MateFinder reports matches that represent lower levels of correlation between preselected attributes and candidates.

In alternative implementations of the invention, the MateFinder 10 may be built into a bracelet, a necklace, a tie-clip, a hat, a shoe or some other suitable fashion item, article of clothing or ornament.

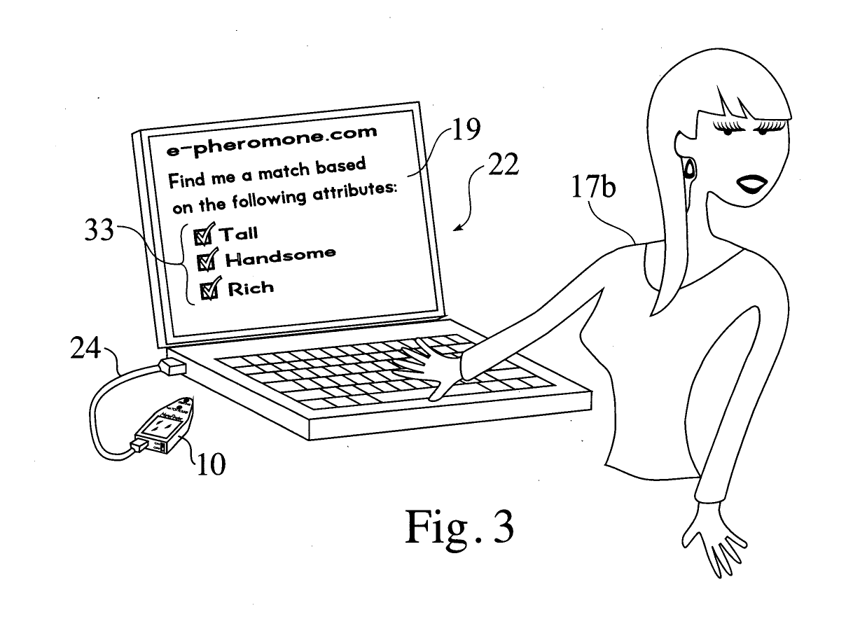

FIG. 3 depicts a woman 17b who has visited a website 19, www.e-pheromone.com. After connecting her MateFinder 10b to the USB port of her personal computer 22 with a cable 24, she is able to program her MateFinder 10b with two sets of attributes 33: a first set of attributes 33a that describes herself, and a second set of attributes 33b that describes her ideal mate. In general, an attribute is any form of data, criteria, information, measure of suitability, complementarity or compatibility; qualities or characteristics that describe a person, item, system, device or thing being sought by a user of the present invention. In one embodiment, two sets of attributes are employed, a first 33a, which pertain to the “seeking” user, and a second 33b, which pertain to the “target” user. Both of these sets of information may be entered into the personal computer 22 in response to prompts from the pages of the website 19. Software running on a server (not shown) which hosts the website then sends the data back to the woman's computer 22, where it is conveyed to the attached MateFinder 10 over the USB cable 24. In an alternative embodiment, the connection between the personal computer 22 and the MateFinder 10 may be wireless.

The attributes 33 which may be selected by the user are virtually unlimited. In the case of a dating service, attributes 33 may be selected from an existing list of attributes 33. As an example, Table One presents attributes 33 which the website 19 displays may include:

TABLE ONE

| Category | Attribute |
|---|---|
| Gender | Male, Female |
| Age | |
| Appearance | Handsome/Knockout, |
| | Attractive/Cute |
| Marital history | Single, Divorced |
| Residence location | |
| Height | Tall, Average, Short |
| Weight | |
| Hair Color | Blonde, Brunette, Redhead |
| Occupation & Income | |
| Religiosity | Yes/No; Denomination |
| Political preferences | Conservative, Liberal, None |
| Interests or hobbies | |
| Educational level | |
| Social Class Marker | |

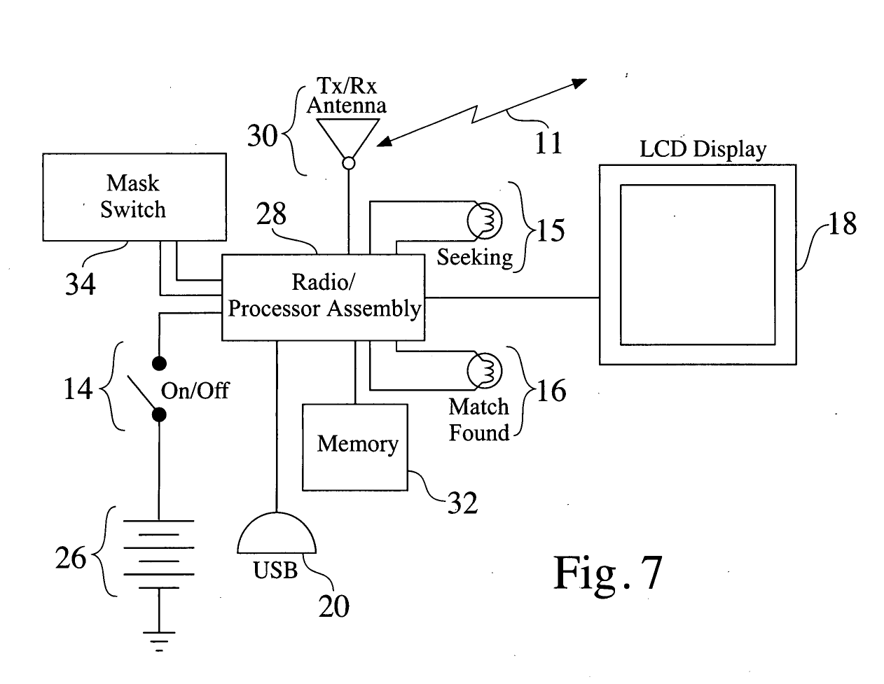

In this “electronic dating” embodiment, the user generally selects two sets of attributes 33—a first set 33a to describe herself or himself, and a second set 33b to describe his or her ideal match. In another embodiment, the user may only select one set, either only attributes that describe herself 33a, or only attributes that describe a mate 33b. A set of attributes 33 may include any number of qualities, numbering from one to a large number. Both sets of attributes 33 are stored in a non-volatile memory that is housed within the MateFinder 10. In one embodiment of the invention, one MateFinder 10a with a first memory 32a (FIG. 7) is employed to find a second MateFinder 10b with a second memory 32b. These preselected attributes may be revised by visiting the website 19, or may be generated using a software template provided with the MateFinder, which is then reprogrammed to incorporate the new data. In an alternative embodiment of the invention, the MateFinder 10 may be programmed directly using voice commands, or by using a keypad built into the device (not shown).

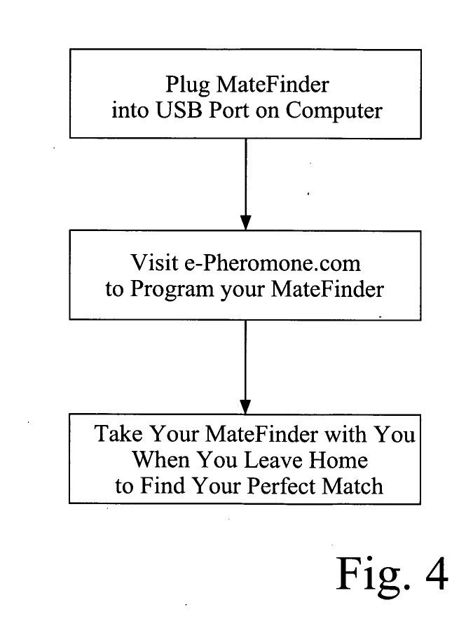

FIG. 4 offers a basic flowchart that describes how this embodiment of the invention is used. After acquiring a MateFinder 10, the user connects it to a personal computer 22. The user visits a website 19 to select two sets of attributes 33 that are stored in his or her device, or uses a software template supplied with the MateFinder. When he or she is ready to enter a social setting, or simply leaves home, he or she then turns the MateFinder on, and takes it along.

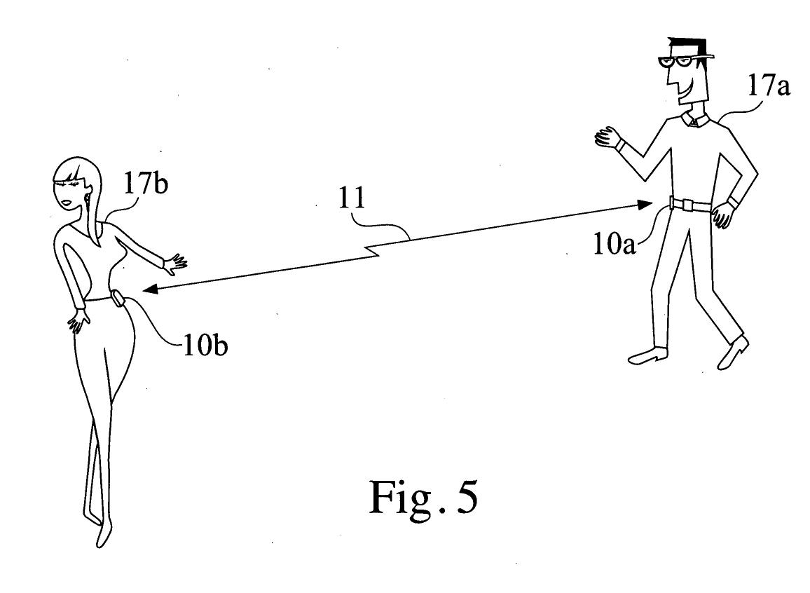

As shown in FIG. 5, the automatic and continuous seeking signal 11 finds a match. The woman 17b shown in FIG. 5, who may be attending a party, a concert or a sporting event, finds a match 17a based on her preselected attributes 33.

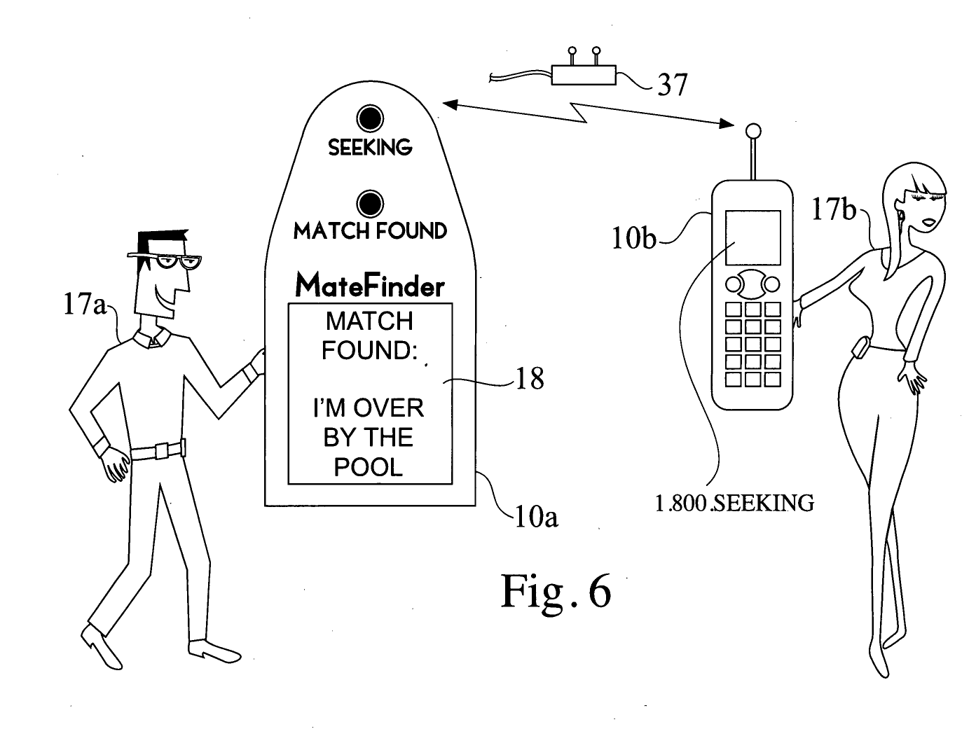

FIG. 6 reveals the operation of a more complex embodiment of the invention. After a man's MateFinder 10a has located a suitable match 17b, the man's MateFinder 10a conveys an address or some other identification message to the woman who has been matched. Her message may appear on the screen 18 of his device 10a. The woman 17b then has the option to communicate with the man 17a immediately. In one embodiment of the invention, the woman 17b may use her cellular phone to call a toll free number, such as 1.800.SEEKING. The address or identification information which has been sent to her MateFinder 10b by the man's MateFinder 10a is displayed on her LCD screen 18. After dialing the toll-free number, she enters this address or identification information, and is then prompted to enter a text message, or to record a voice message.

FIG. 7 is a simplified schematic diagram of the circuitry that may be employed to implement one embodiment of the present invention. The power switch 14 controls the flow of energy from a battery 26 that powers the MateFinder 10. When the MateFinder 10 is turned on, a radio/processor assembly 28 automatically and continuously emits a seeking signal 11 using antenna 30 over a short range. An USB port 20 is connected to the radio/processor assembly 28. The antenna 30 may be contained within the housing 12. When the radio/processor assembly 28 is broadcasting, the “SEEKING” LED 15 flashes periodically. When a match is found, the “MATCH FOUND” LED 16 illuminates, or some other audible or vibrating alarm is activated. The radio/processor assembly 28 is also connected to the LCD screen 18, which may be used to display short text messages from that are received from another MateFinder 10.

The radio/processor assembly 28 is also connected to a memory 32, which is used to store attributes that describe the user and his or her ideal mate. The memory 32 may comprise any suitable non-volatile device, including, but not limited to a flash memory or hard-drive. In an alternative embodiment, a “MASK” switch 34 may be included to allow the user to mask his or her location.

A suitable frequency for the radio emissions, such as one of the unlicensed

“ISM” or “RF device” bands set aside by the United States Federal Communications Commission, is selected to avoid creating unwanted interference. The MateFinder 10 may be configured to emit and/or receive a variety of signals or emanations of energy. In the United States, some embodiments of the invention may use the 900 Mz, 2.1 GHz, 5.8 GHz, 59-64 GHz or some other radio frequency band. In other countries, other suitable frequency bands may be selected for the operation of the present invention. Other embodiments of the invention may employ light energy, voice commands, audible tones or ultrasonic emissions; mechanical, physical or chemical manifestations; radioactivity, or any other suitable means for communication.

In a more advanced embodiment of the invention, some or all of the discrete components described in FIG. 7 may be integrated on a single computer chip.

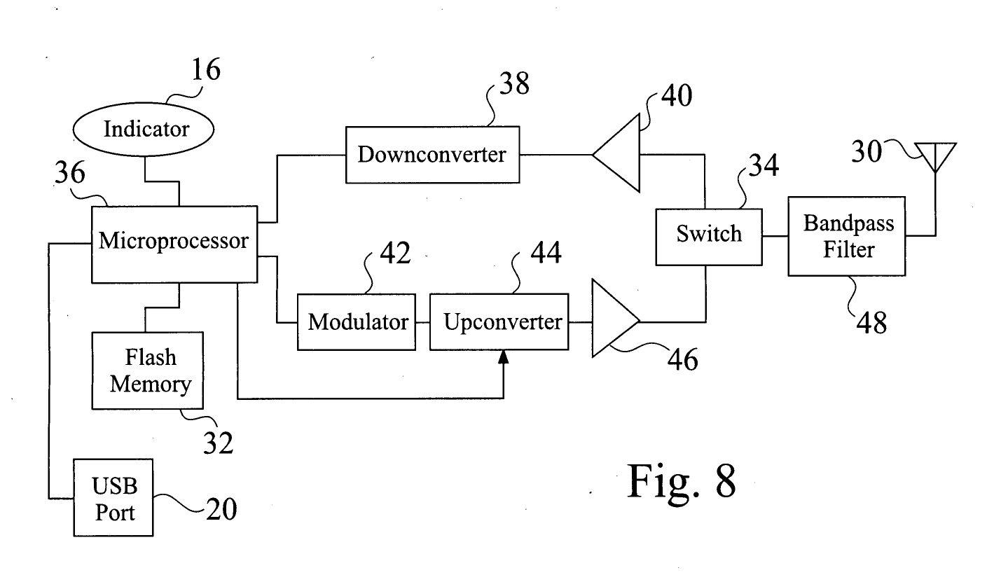

FIG. 8 provides a schematic diagram that illustrates one particular implementation of the invention. A microprocessor 36 is connected to a flash memory 32, a USB port 20 and an indicator 16. The microprocessor 36 is also connected to a downconverter 38, a modulator 42 and an upconverter 44. The input of the downconverter 38 and the output of the upconverter 44 are connected through amplifiers 40 and 46 to a mask switch 34, which, in turn, is connected to a bandpass filter 48 and an antenna 30.

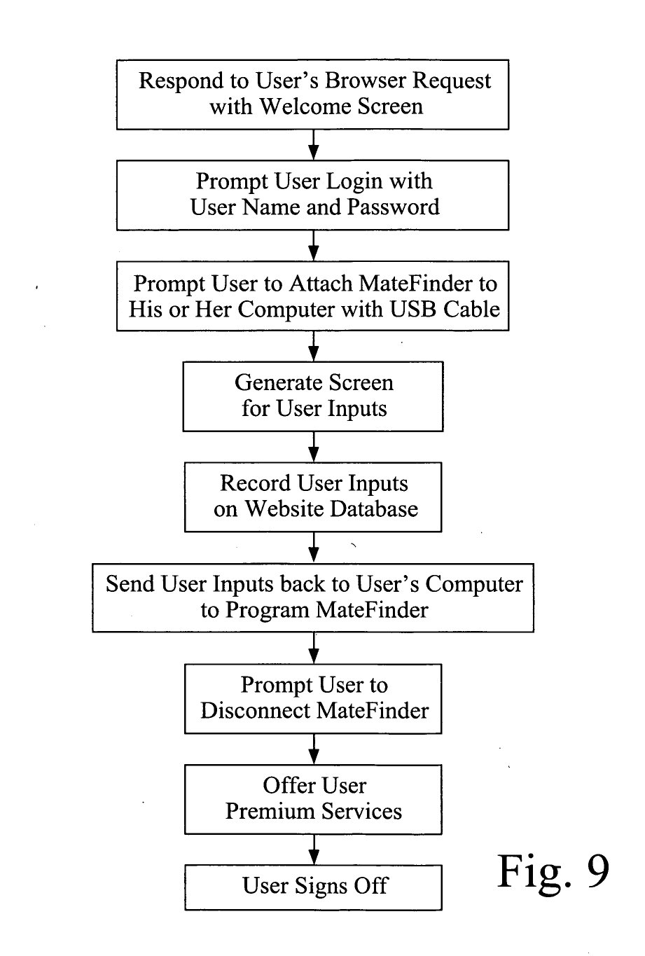

FIG. 9 offers a flowchart which depicts the basic operational steps of a particular software program that may reside at the website 19 used by the present invention. In the first step of the process, a user visits the website 19, such as e-pheromone.com. The user's browser requests information from the website 19, and the website responds by sending the user a welcome screen. The welcome screen invites the user to either create a new account, or to login to his or her existing account with a username and a password.

After the user has logged in for the first time, a new screen prompts the user to attach his or her MateFinder to his or her computer with a USB cable. After the user's computer has reported back to the website that the MateFinder is connected, the website generates a new screen that prompts the user to program his or her MateFinder using menu selections and/or a set of input fields.

After the user completes the selections, this information is recorded on a website database, and the website 19 sends the data back to the user's computer in a form that may be recorded in the MateFinder's memory. The user then disconnects the MateFinder, and may be offered a variety of premium services, such as background checks, certification of attributes or compatibility analysis, before he or she logs off.

In another alternative embodiment of the invention, the MateFinder may be designed to work in combination with an existing WiFi or similar wireless network 37 that is operating in the place where the user happens to be located. The user would be able to employ the wireless LAN or wired network (via a cable to the MateFinder), and would then be able to take advantage of all the connections offered by the Internet.

### II. Applications & Uses of the Invention

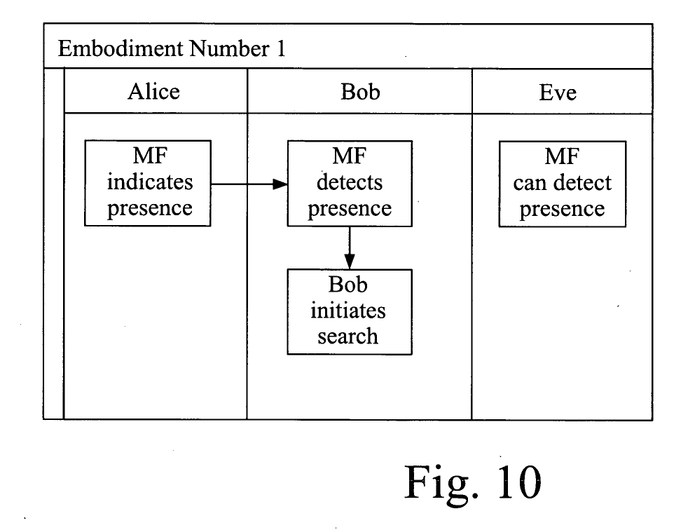

FIGS. 10, 11, 12, 13, 14, 15, 16, 17, 18 and 19 summarize the various combinations of uses of the present invention. FIGS. 10 through 19 use a convention common in the communications industry when describing secure communication systems, in which there are three humans or systems involved in the transaction. The originator is called “A” or “Alice,” regardless of whether it is a man, woman or system; similarly, the first intended recipient is “B” or “Bob.” A third person or system, which may be attempting to eavesdrop, is called, “Eve.”

The attributes 33 that describe Alice or Bob are called labeled “attributes,” sometimes abbreviated “A.” The attributes 33 that describe the entity that Alice or

Bob is seeking are called “preferences,” sometimes abbreviated P. When used in FIGS. 10-19, preferences are subsets, meaning that they are intended to be understood as members of the larger set of attributes 33. Thus, for example, the attributes that Alice uses for self-description are sometimes abbreviated “A's As,” and the attributes Alice seeks are called, “A's Ps.”

Each of the embodiments shown in FIGS. 10-19 are provided only as examples of the many possible uses of the present invention, and are not intended to circumscribe or limit the scope of the Claims.

In Embodiment Number 1, shown in FIG. 10, Alice's MateFinder simply indicates her presence in the vicinity. Bob's MateFinder detects that information and alerts Bob, who may initiate a search. Eve's and other MateFinders in the area can detect the presence of Alice's MateFinder.

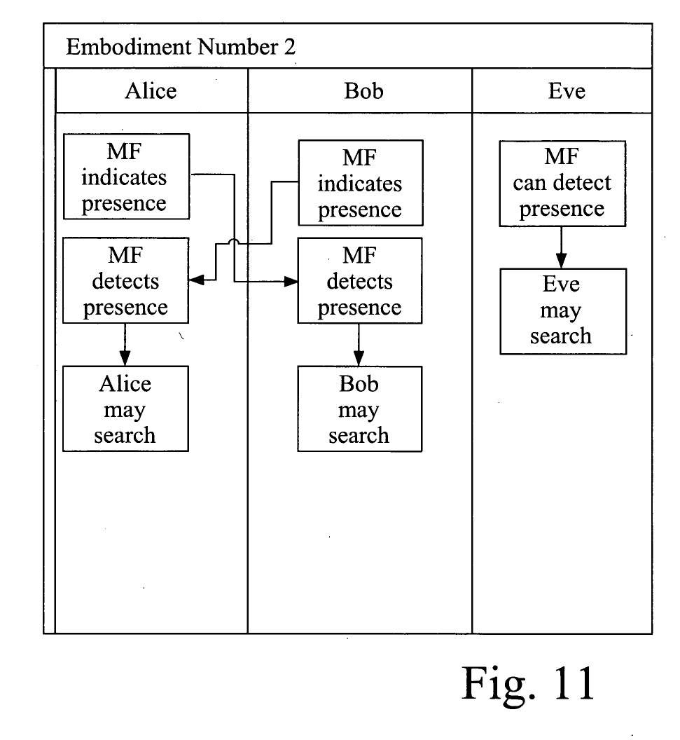

In Embodiment Number 2, shown in FIG. 11, both Alice's and Bob's MateFinders simply indicate their presence in the vicinity. Alice's and Bob's MateFinders detect that information and alert their wearers, who may initiate a search. Eve's and other MateFinders in the area can detect the presence of Alice's and Bob's MateFinders.

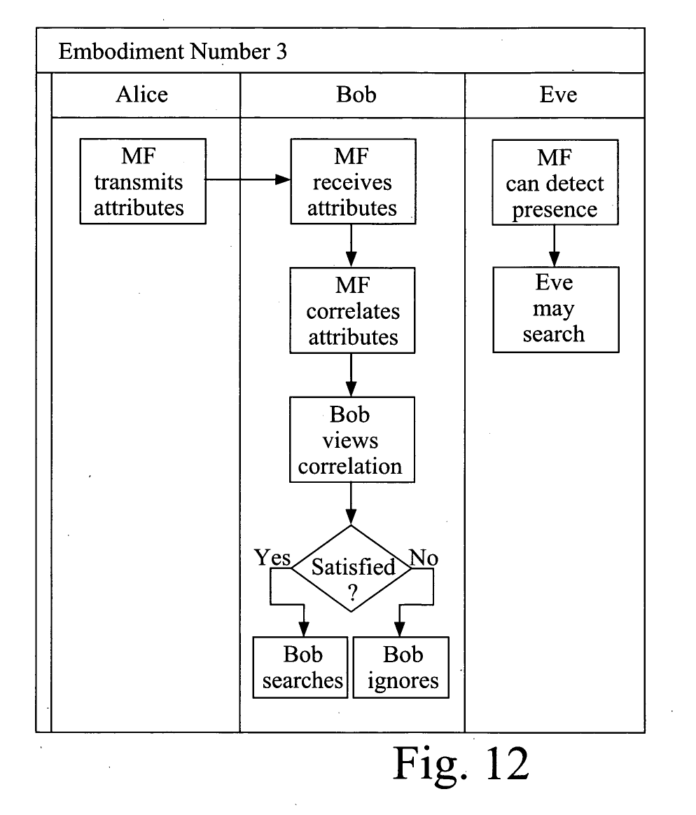

In Embodiment Number 3, shown in FIG. 12, Alice's MateFinder broadcasts Alice's attributes. Bob's MateFinder receives this information and correlates the received attributes with Bob's preferred attributes (hereafter called preferences). Bob views the degree of correlation and decides whether to initiate a search based on that information. Eve's and other MateFinders in the area can detect the presence of Alice's MateFinder.

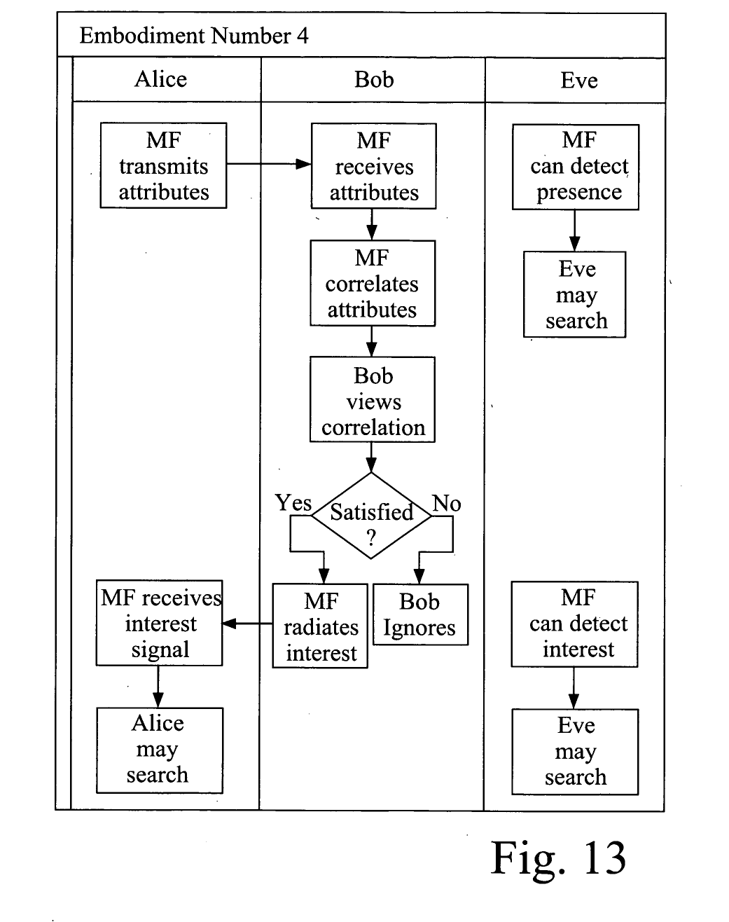

In Embodiment Number 4, shown in FIG. 13, Alice's MateFinder broadcasts Alice's attributes. Bob's MateFinder receives this information and correlates the received attributes with Bob's preferred attributes (hereafter called preferences). Bob views the degree of correlation and decides whether to have his MateFinder radiate an interest signal. If Alice detects that signal, she may initiate a search based on that information. Eve's and other MateFinders in the area can detect the presence of Alice's and Bob's MateFinders, and can detect the interest signal when emitted.

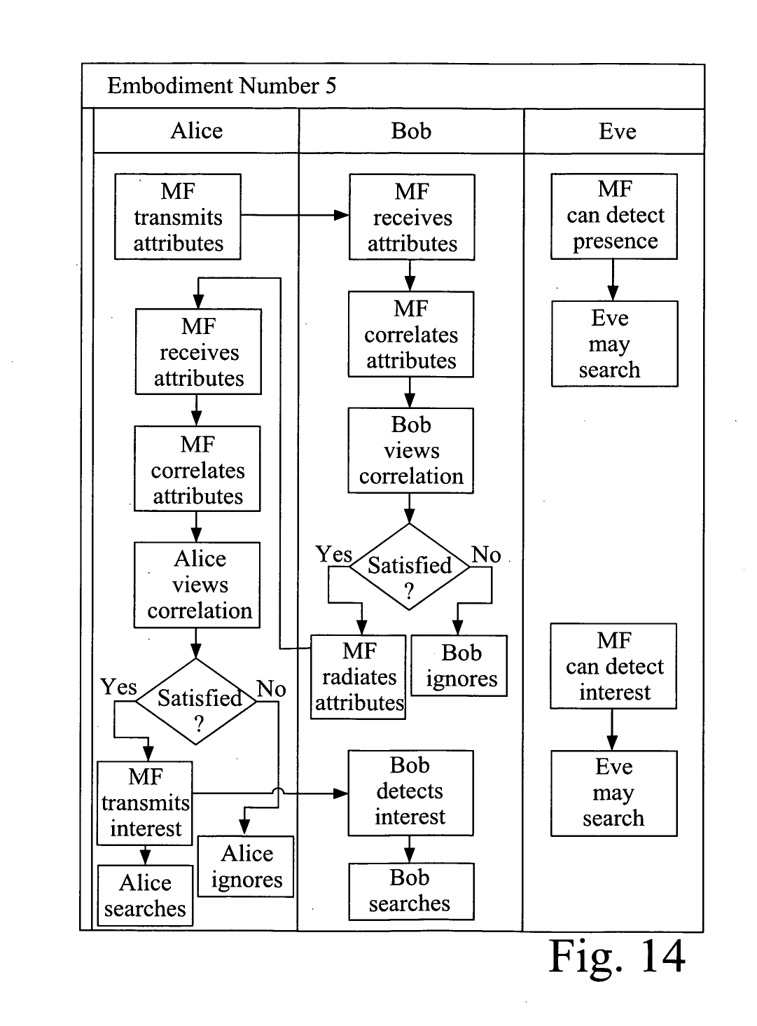

In Embodiment Number 5, shown in FIG. 14, Alice's MateFinder broadcasts Alice's attributes. Bob's MateFinder receives this information and correlates the received attributes with Bob's preferences. Bob views the degree of correlation and decides whether to have his MateFinder radiate his own attributes. If Alice's MateFinder detects that signal, it correlates the received attributes with her preferences. If she is satisfied with the correlation, she directs her MateFinder to emit an interest signal, and she may also search. If Bob's MateFinder detects the interest signal, he may initiate a search. Eve's and other MateFinders in the area can detect the presence of Alice's and Bob's MateFinders, and can detect the interest signal when emitted.

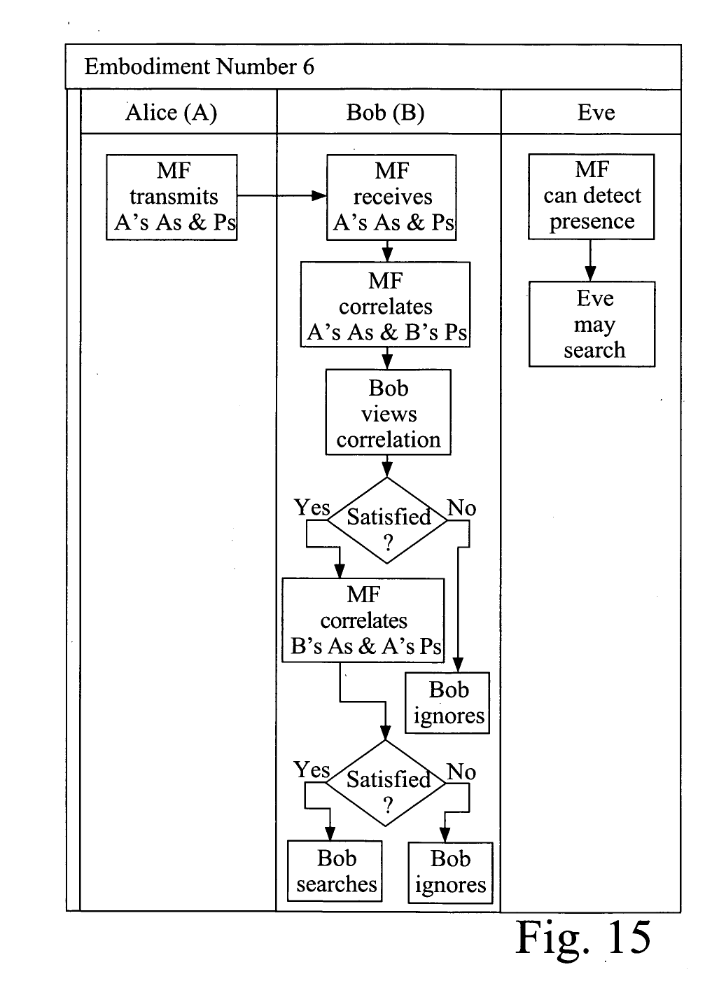

In Embodiment Number 6, shown in FIG. 15, Alice's MateFinder broadcasts both Alice's attributes and her preferences. Bob's MateFinder receives this information and correlates the received attributes with Bob's preferences If Bob is satisfied with the correlation between Alice's attributes and Bob's preferences, he may then have his MateFinder correlate Bob's attributes with the received preferences. Bob views the degree of this second correlation and, if satisfied, may initiate a search. Eve's and other MateFinders in the area can detect the presence of Alice's MateFinder.

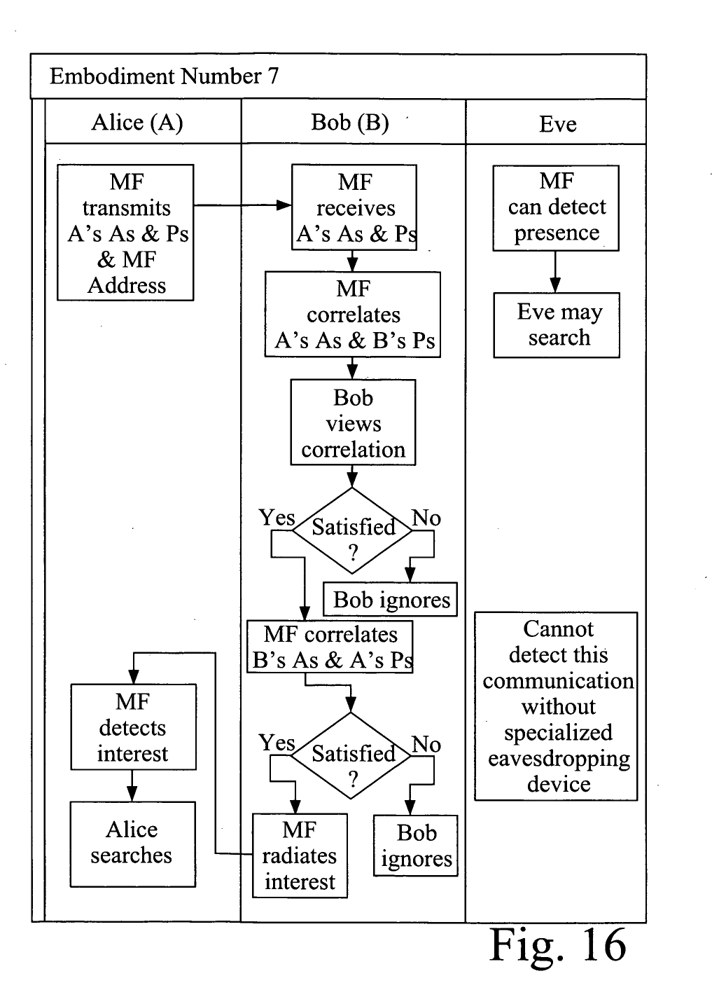

In Embodiment Number 7, shown in FIG. 16, events proceed as shown in FIG. 15, except that Alice's MateFinder adds an encrypted discrete address to her signal. Bob may choose to have his MateFinder radiate an interest signal directed to Alice's MateFinder's address. If Alice's MateFinder detects that signal, she may initiate a search. Eve's and other MateFinders in the area can detect the presence of Alice's and Bob's MateFinders. However, since Bob's interest signal is directed to a discrete address, other MateFinders cannot detect the interest signal.

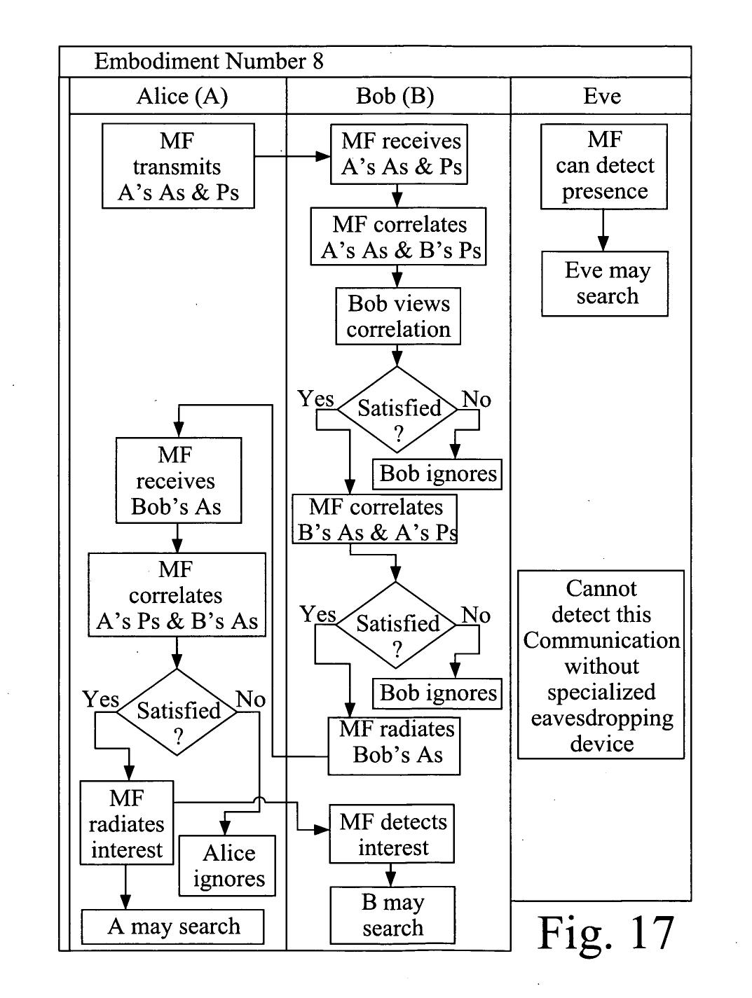

In Embodiment Number 8, shown in FIG. 17, events proceed as shown in FIG. 16, except that Bob may choose to have his MateFinder radiate his own attributes along with its encrypted discrete address. If Alice's MateFinder detects that transmission, it correlates Alice's preferences with the received attributes. If Alice is satisfied with the degree of correlation, she may initiate a search. Eve's and other MateFinders in the area can detect the presence of Alice's and Bob's MateFinders. However, since Alice's interest signal is directed to a discrete address, other MateFinders cannot detect the interest signal.

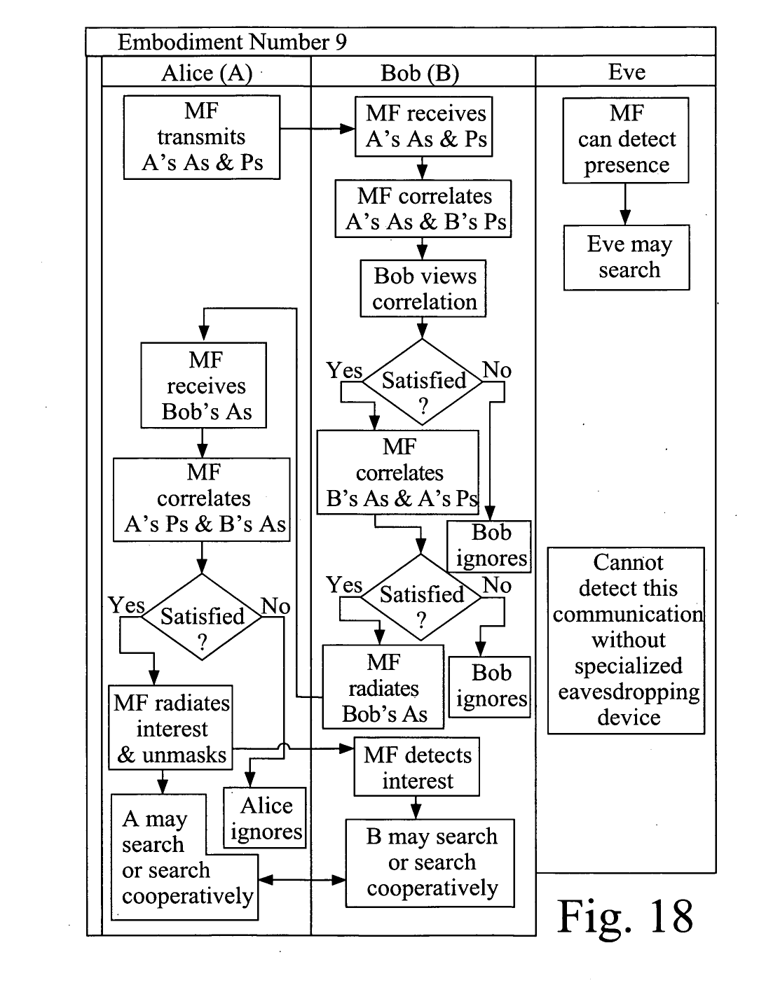

In Embodiment Number 9, shown in FIG. 18, events proceed as shown in FIG. 17, except that Alice may choose to have her MateFinder unmask her location to make her easier to locate, and at the same time to radiate an interest signal directed at the address of Bob's MateFinder. Either Alice or Bob may then decide to initiate a search, or using the location features of their MateFinders, they may choose to search cooperatively. Eve's and other MateFinders in the area can detect the presence of Alice's and Bob's MateFinders. However, since Bob's and Alice's interest signals are directed to the other's discrete address, other MateFinders cannot detect the interest signal.

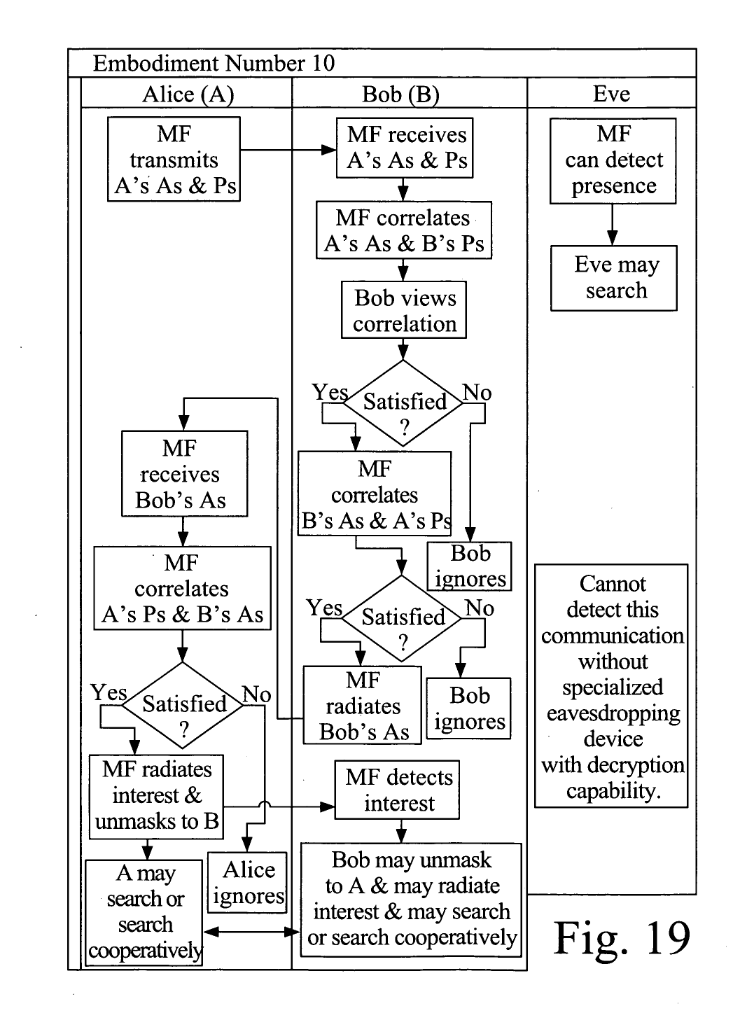

In Embodiment Number 10, shown in FIG. 19, events proceed as shown in FIG. 18, except that Alice may choose to have her MateFinder unmask her location to make her easier to locate, and upon receiving Alice interest signal, Bob may choose to unmask his location to Alice's MateFinder. Either Alice or Bob may then decide to initiate a search, or using the location features of their MateFinders, they may choose to search cooperatively. Eve's and other MateFinders in the area can detect the presence of Alice's and Bob's MateFinders. However, since Bob's interest signal is directed to a discrete address, other MateFinders cannot detect the interest signal. In addition, since unmasking is done only to discrete addresses which may be encrypted, even if equipped with specialized listening equipment, an eavesdropper cannot take advantage of the unmasking.

### III. Alternative Embodiments of the Invention

In an alternative embodiment of the invention, the MateFinder™ may be incorporated into or equipped with another electronic device, such as, but not limited to, a cellular telephone, pager, watch, personal digital assistant, Blackberry™, or laptop computer.

In addition to helping people find a mate, the present invention may be employed to find other persons with specific interests or capabilities. As an example, a student in a grammar school could program his FriendFinder™ to seek out other students who are interested in a similar hobby, such as baseball cards or stamp collecting.

In yet another situation, a person who attends a Home Improvement Convention could program his ContractorFinder™ to seek out a person who is skilled at installing home theater equipment or hardwood flooring.

In yet another alternative embodiment, the present invention may be used to find specific objects instead of other people. A shopper in a large retail store could use a ShoppingHelper™ to find the correct aisle or department that offers home appliances or childrens' toys. In general, the present invention encompasses any device or number of devices that use radio signals to locate a person, a place or an object that has been described in data that is stored in one of the devices.

In yet another alternative embodiment, the device can be used by two inanimate objects, such as a crane and a shipping container in a port, to facilitate the crane's operation.

### IV. Relationship Prediction System: Opening an Account, Obtaining a Test Kit and Submitting Attributes to an Internet Dating Service

The present invention comprises methods and apparatus for predicting good relationships or matches. Merriam-Webster's Online Dictionary defines the word “relationship” as:
“1: the state of being related or interrelated, e.g., studied the relationship between the variables
2a: the relation connecting or binding participants in a relationship: as a kinship
2b: a specific instance or type of kinship
3a: a state of affairs existing between those having relations or dealings, e.g., had a good relationship with his family
3b: a romantic or passionate attachment”

In this Specification, and in the Claims that follow, the term “relationship” is used to connote a connection, association, affiliation or formal union between two persons. In particular, the relationships described and claimed in this Patent Application pertain to relationships which are premised, engendered or motivated by:
1. a correlation of self-describing attributes and the ideal-match attributes of another person; and
2. a first person's natural response to the genetic attributes of second person.

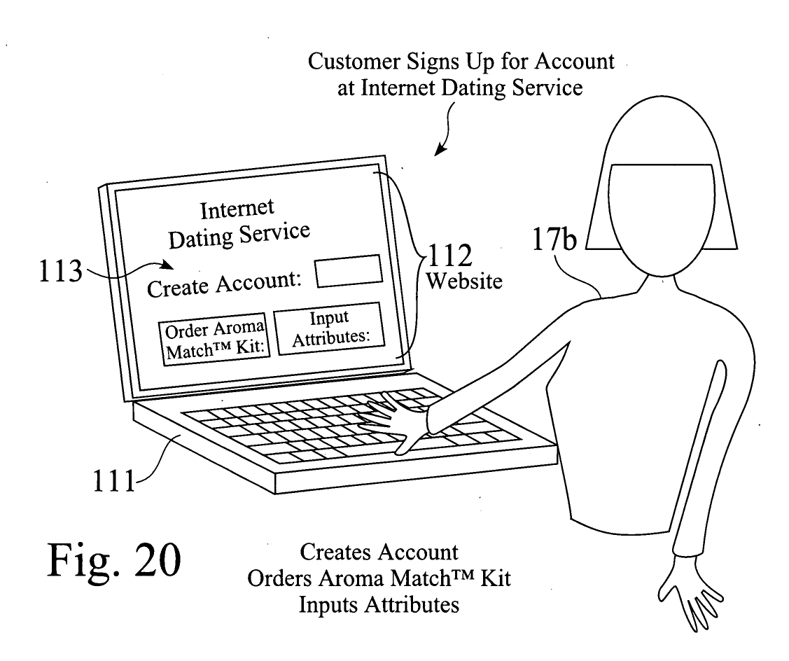

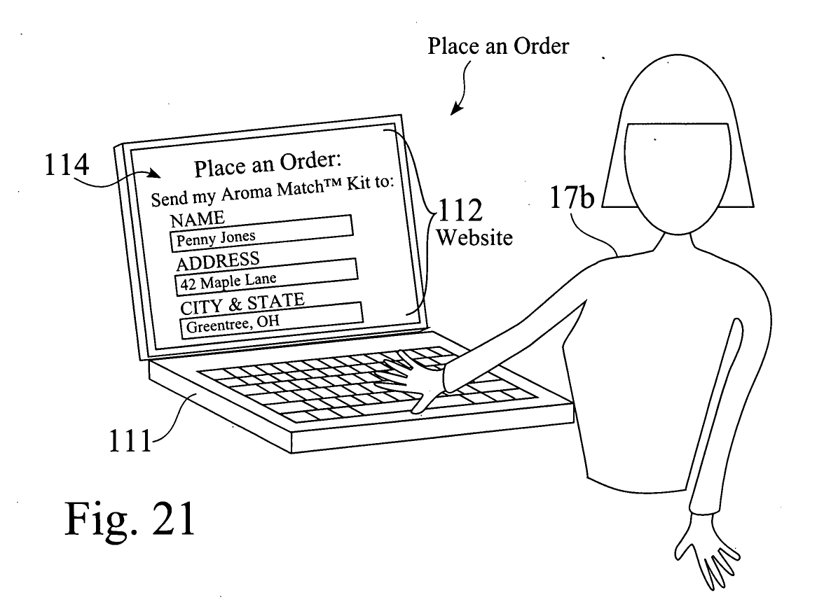

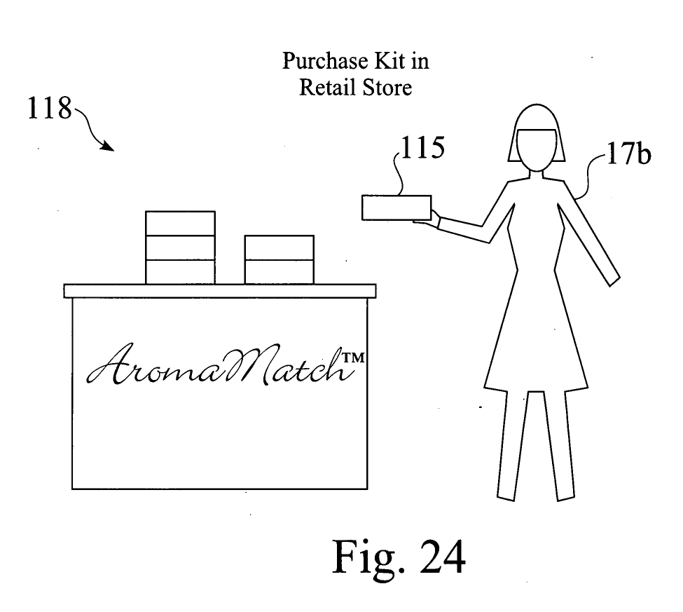

In one particular embodiment of the invention, the prediction of good relationships is predicated on a female's “responsivity.” FIG. 20 shows a woman 17b using a personal computer, personal digital assistant, web-enabled cellular telephone or any other similar information appliance 111 to visit an Internet Dating Service 112 website. The view in FIG. 20 shows a web page 113 for opening a new account. Once the new account is established, the woman 17b proceeds to another page 114 on this website as shown in FIG. 21, which enables the woman 17b to place an order for an AromaMatch™ Test Kit 115 (FIG. 24). “AromaMatch” is a Trade & Service Mark owned by the Assignee of the Present Patent Application. The website “www.aromamatch.com” is also owned by the Assignee of the Present Patent Application. In one embodiment, the Test Kit 115 will be delivered to the customer 10 by the U.S. Mail, or a courier such as UPS™ or Federal Express®.

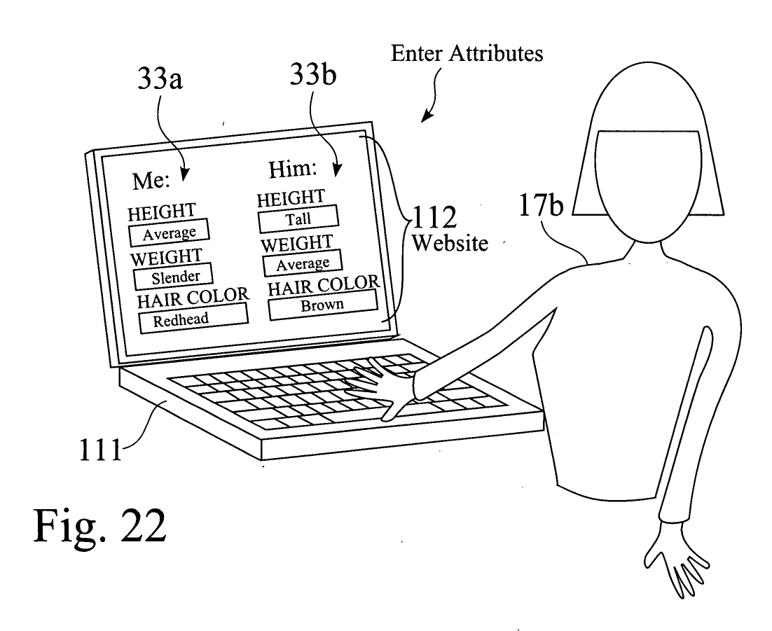

FIG. 22 illustrates the same woman 17b entering attributes which describe herself 33a, as well as attributes which describe her perception of a good match 33b. These attributes 33a & 33b may describe physical characteristics, personality traits, educational levels, jobs or careers, personal goals, hobbies, activities or any other information that may provide a basis for predicting a good match.

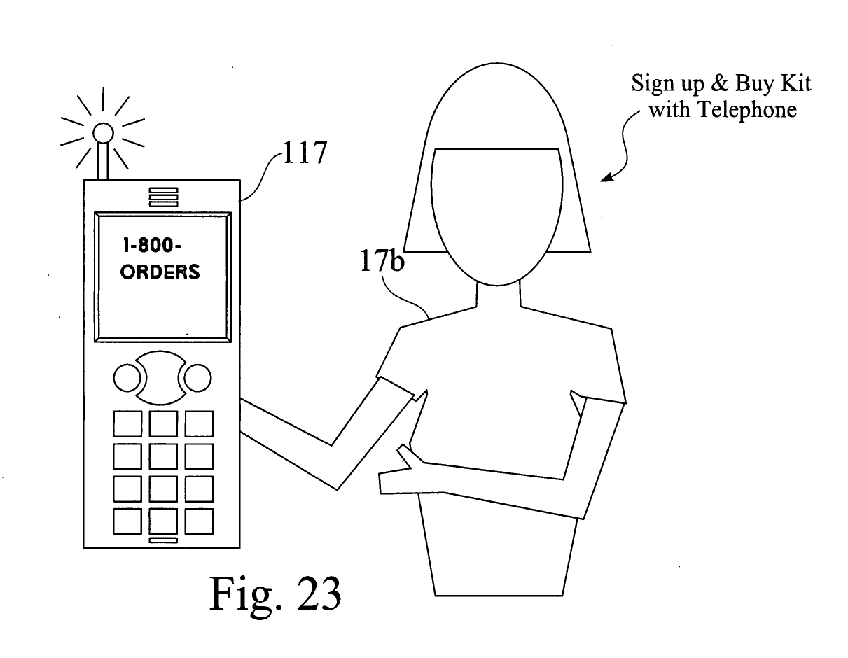

FIG. 23 depicts an alternative embodiment of the invention, in which the woman 17b uses a telephone 117 to open an account, place an order and/or submit attributes 33a and 33b to the Internet Dating Service over the phone.

FIG. 24 reveals another alternative embodiment, in which the woman 17b visits a retail store 118 to open an account, purchase a Test Kit 115, and/or fill out a questionnaire which furnishes attributes 33a and 33b to the Internet Dating Service 112, or other dating or introduction service.

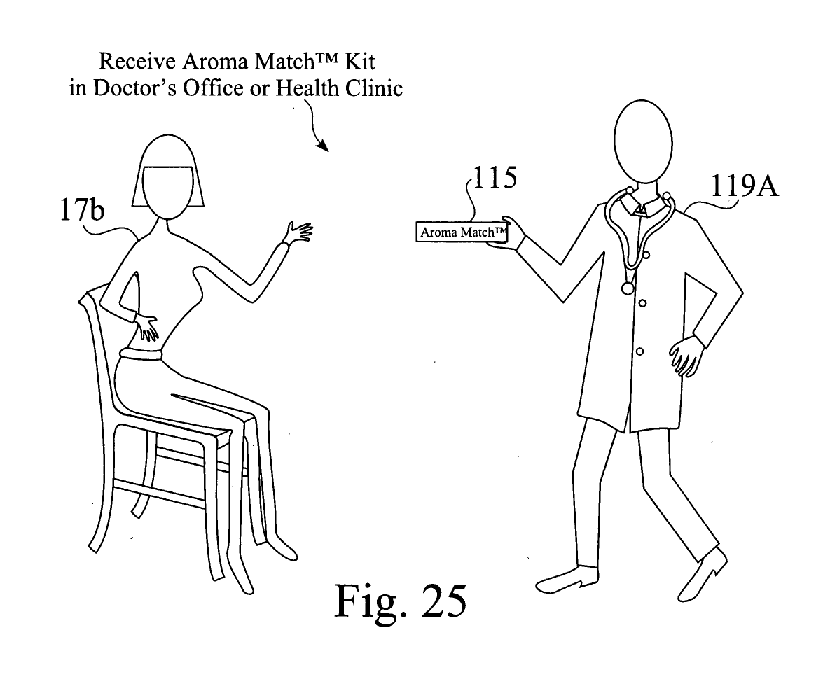

FIG. 25 supplies a view of yet another alternative embodiment of the invention, in which the customer 17b may open an account, purchase a Test Kit 115, and/or fill out a questionnaire to supply attributes 33a and 33b at a doctor's office or health clinic. The woman 17b may receive a Test Kit 115 from a physician, nurse, medical assistant or some other health care provider 119A. The customer 17b may provide her tissue sample while visiting the doctor's office, which is then certified by the doctor 119A before it is submitted to the laboratory. In this embodiment, the physician provides the Test Kit 115, and obtains the tissue sample. The physician 119A then sends the tissue sample to a laboratory for analysis, and also certifies that the sample is from a particular person. In this example, the physician acts as a “notary” who insures the identity of the source of the sample. This implementation of the invention guards against the fraudulent submission of a tissue sample from a person who might attempt to supply a misleading identity.

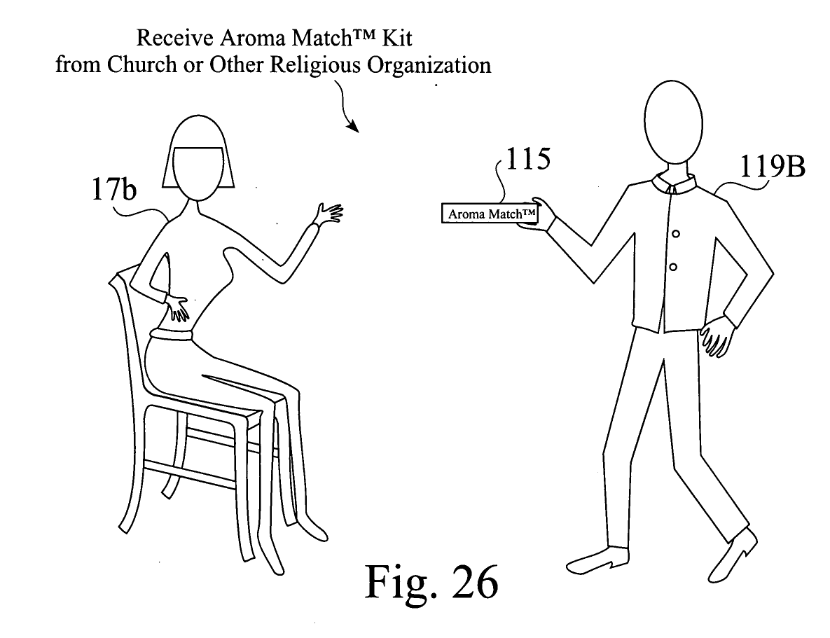

In yet another embodiment, FIG. 26 shows the woman 17b receiving a Test Kit 115 from a priest, minister, rabbi or some other religious leader or cleric 119B. In one embodiment, the invention is promoted by a religious or spiritual organization to promote good relationships and/or marriages.

In one embodiment of the invention, customers visit a website to supply information about themselves, and their ideal match. In this implementation of the invention, information is stored electronically in a computer database. In alternative embodiments, information about customers and their test results may be recorded in some other form of database, whether in electronic, paper or other means of media or storage.

In yet another embodiment of the invention, this database of information and/or records may be maintained by an introduction service, which may include a dating or matching service, or some other means for enabling, furnishing or assisting people find romantic or other matches. The introduction service may or may not utilize the Internet and/or electronic record keeping.

### V. The AromaMatch™ Test Kit

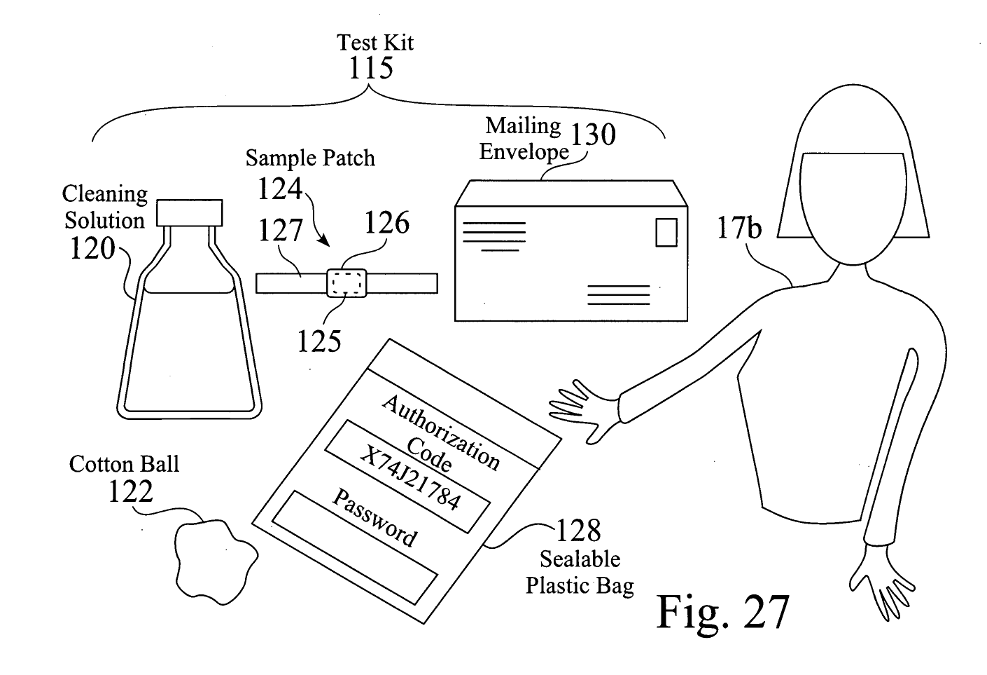

FIG. 27 portrays the woman 17b opening and removing the contents of the AromaMatch™ Test Kit 115. In one embodiment of the invention, the Test Kit 115 comprises:
cleaning solution or skin cleaner 120;
a cotton ball or other cleaning medium 122;
an odor-absorbing sample patch 124, which includes a portion of plaster 125 coated with an antibiotic 126 and portions coated with a skin adhesive 127;
a sealable enclosure 128, such as an envelope or bag; and
a mailing or shipping envelope or pouch 130.
   The skin cleaner 120 may comprise a liquid cleaning solution such as isopropyl alcohol, or any other, gel, solid, spray or substance that cleans and/or sterilizes a portion of the skin. The application of the skin cleaner 120 removes or neutralizes perfumes and other irrelevant smells.

The cleaning medium 122 is generally a small portion of material that is used to apply the skin cleaner 120 to the skin. In one embodiment, the cleaning medium 122 may be a cotton ball, wad, paper, piece of fabric or some other suitable application device.

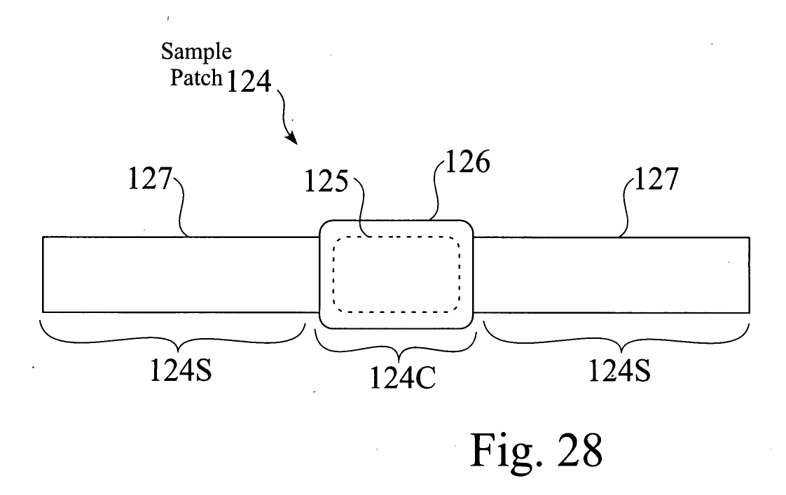

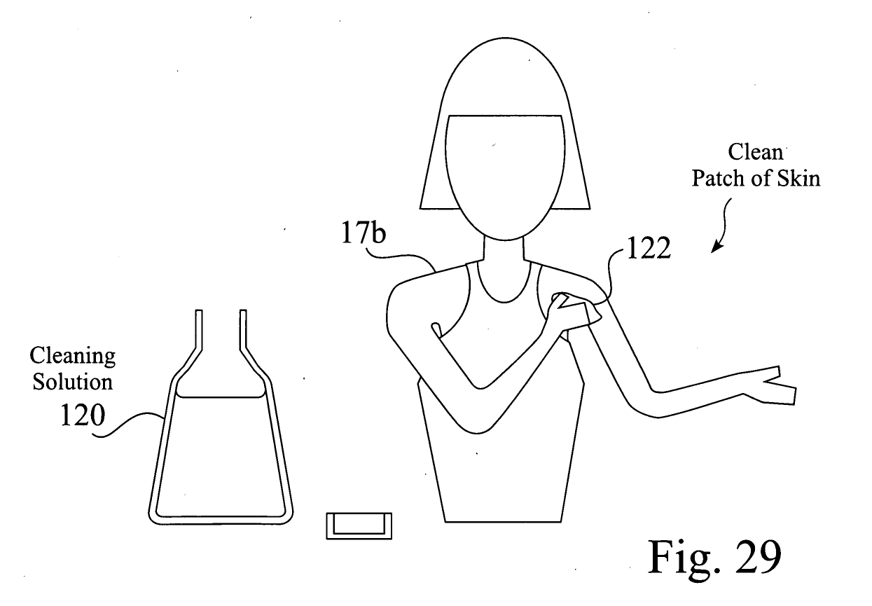

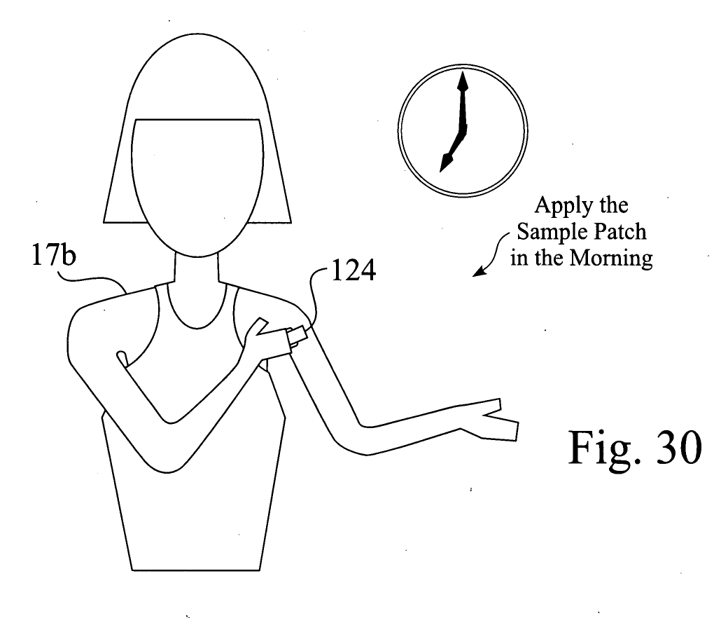

FIG. 28 furnishes an illustration of the sample patch 124, which comprises a small central area 124C with two outwardly extending strips 124S. The central area 124C is coated with a portion of plaster 125 which, in turn, has been coated with an antibiotic 126 or some other suitable agent that prevents bacterial growth which might modify the aroma. The strips 124S on either side of the plaster 125 are coated with an adhesive 127 that is suitable for adhering to the skin for a short period of time. Either side of the patch 124 may be coated with adhesive.

In one embodiment, the patch 124 resembles a conventional “Band-Aid® Brand” Adhesive Bandage, such as that manufactured and sold by Johnson & Johnson of New Brunswick, N.J. The patch 124 may be fabricated from plastic, cloth, paper or any other material that will maintain the plaster 125 in generally continuous contact with the skin. The plaster 125 is generally any material that will absorb and then hold an aroma which has been secreted by the skin. The plaster 125 may be composed of any substance that collects and stores an aroma. In this Specification and in the Claims that follow, the term “aroma” encompasses any scent, smell, odor or olfactory component that may or may not be actively or consciously detected, sensed or smelled by a person. In one embodiment of the invention, the plaster 125 is manufactured from any material that may be used as an odor-absorbing poultice.

The plaster 125 is designed so that it will collect enough aromas to provide a sample which may be reliably analyzed. The aromas captured by the plaster 125 must be able to survive for a duration of time that is required for the patch 124 to be mailed to a laboratory.

After the Test Kit 115 is opened, the woman 17b cleans a patch of skin on her arm in preparation for applying the sample patch 124, as shown in FIG. 29. In a preferred embodiment, the patch is placed on the armpit. In FIG. 30, patch 124 has been attached to her skin. The patch 124 may be worn on any portion of the body which allows direct and intimate contact with the skin, and which enables a sufficient collection of body odor.

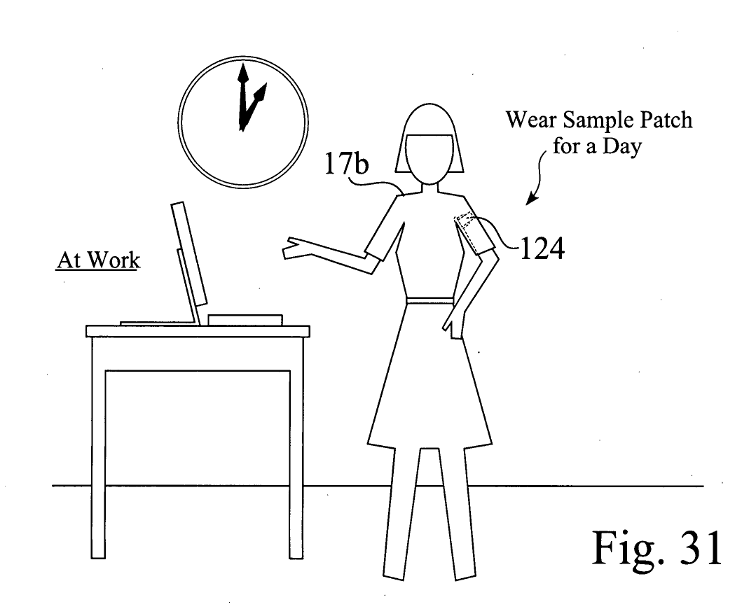

The woman wears the patch 124 all day, as shown in FIG. 31. The time that is required for the patch 124 to remain in place varies with the effectiveness of the plaster 125 and the sensitivity of the equipment used to analyze the patch 124. In one embodiment of the invention, the user is instructed to leave the patch 124 in place on the skin for at least eight hours. In some instances, the time that is required to wear to patch to obtain a good sample may take longer. One alternative method that may be used to collect a sample is using a simply wearing a shirt or some other article of clothing for an extended time, and then analyzing this worn article of clothing.

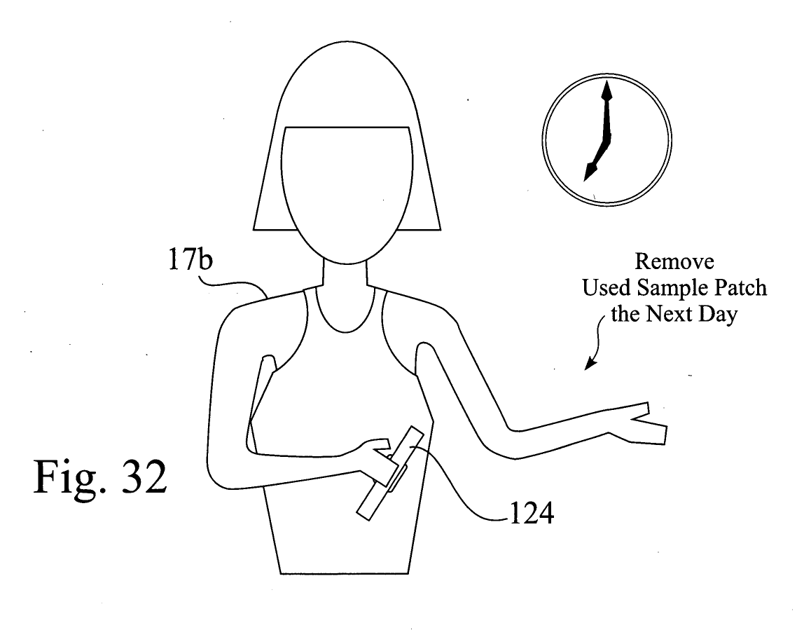

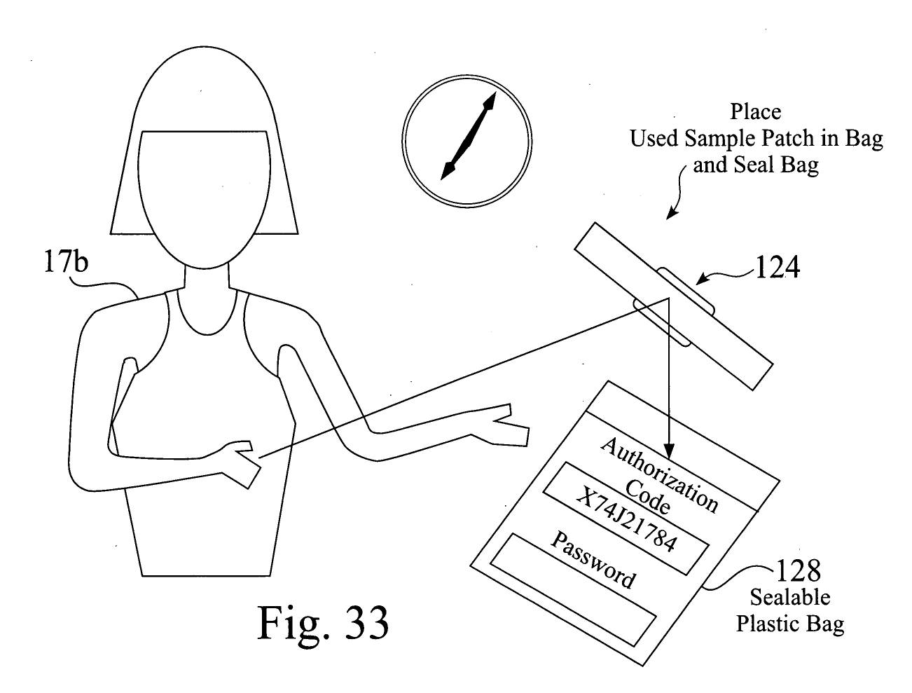

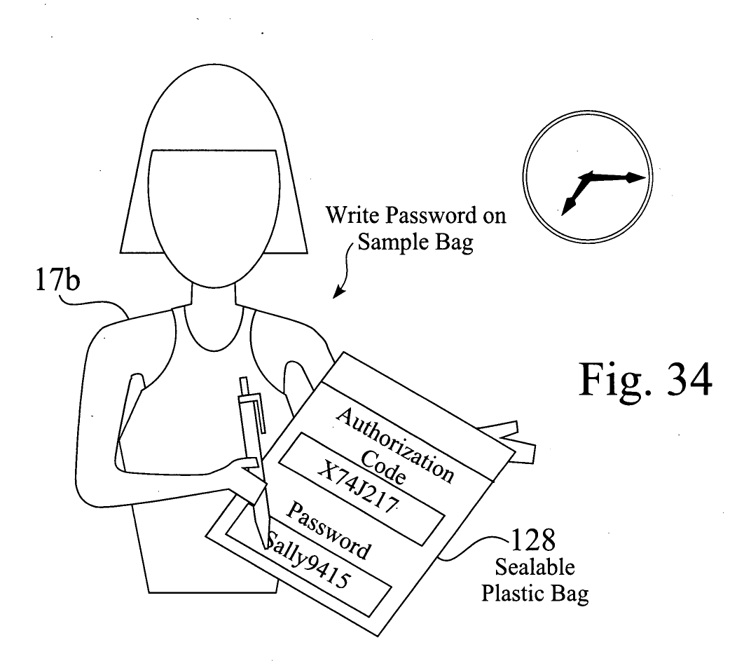

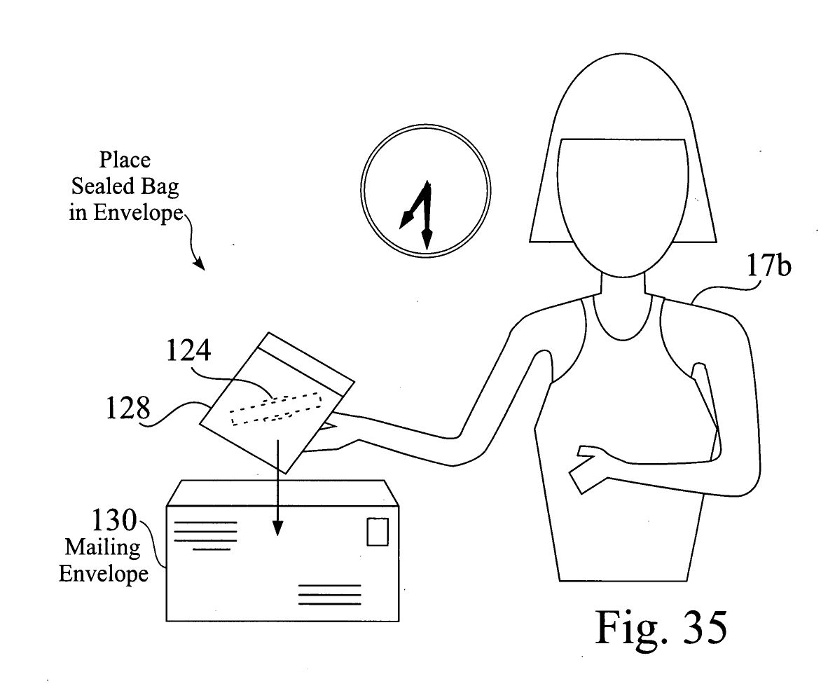

After wearing the patch 124 all day, the woman 17b removes the patch 124 later that evening, as shown in FIG. 32. After the patch 124 is removed, she then immediately places the patch 124 in the enclosure 128, as illustrated in FIG. 33. The enclosure is sealed 128 to prevent any degradation of the aromas stored in the plaster 125.

She then writes her username, password, code or some other identifying information on the bag 128, as shown in FIG. 34. This enclosure 128 is large enough to hold the sample patch 124, may be easily sealed against the intrusion of outside air by the user, and is generally an impermeable container or barrier that preserves the aromas imparted to the plaster 125 on the patch 124. In one embodiment of the invention, the enclosure 128 is a plastic bag with a compression seal, which is commonly known as a “zip-lock” or “slide-lock” closure. In one implementation, the bag 128 bears a pre-printed authorization code.

The patch 124 which stores the odor sample which has been sealed in the bag 128 is then placed in the mailing envelope, as shown in FIG. 35.

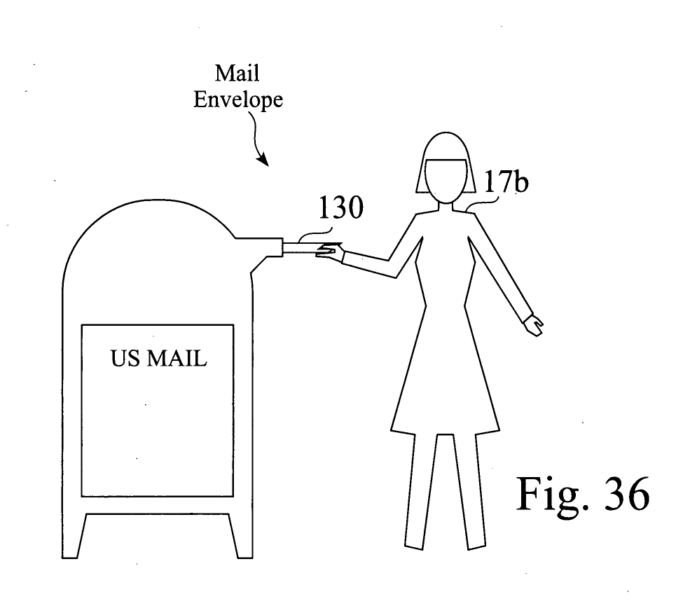

FIG. 36 portrays the customer 17b posting the pre-addressed mailing envelope 30 which contains the worn patch 124 in the bag 128. This envelope 30 will convey the patch 124 to a laboratory where the plaster 125 will be analyzed. As an alternative, the patch 124 may be shipped to a laboratory using a courier. The patch 124 may also be delivered to a local laboratory, doctor's office or pharmacy for analysis. In a more advanced embodiment of the invention, the user may analyze the patch 124 using a home analysis kit.

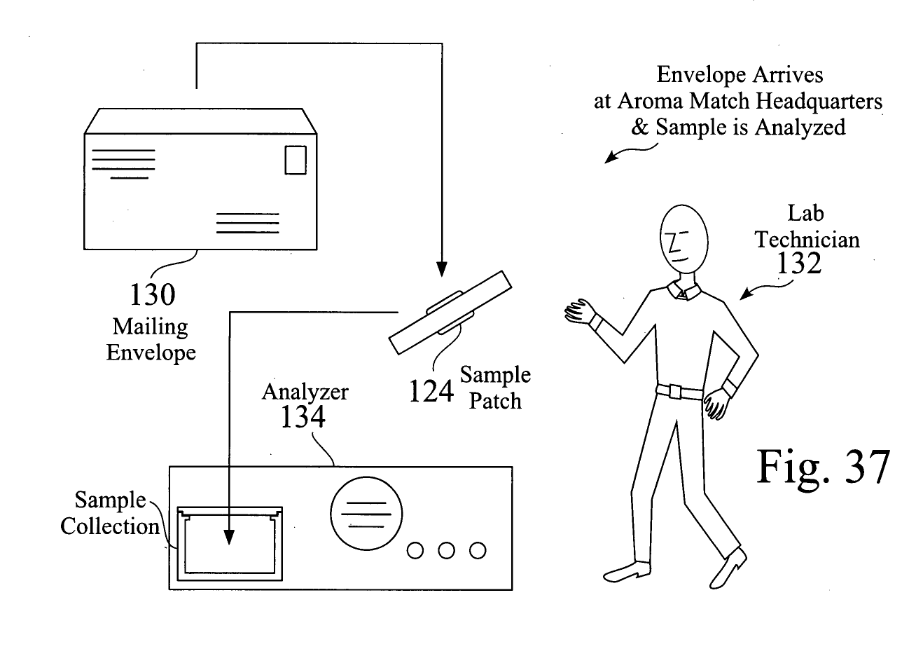

FIG. 37 shows a laboratory technician 132 using an analyzer 134 to determine the genetic attributes of the tissue sample that has been received from the customer 17b. In one embodiment, a probe from an analyzer 134 may be inserted into the bag 128, which will convey the aromas to a chamber where a chemical analysis is conducted.

Several devices and systems for analyzing a sample are currently available which may be used to implement the present invention. One device called an “Electronic Nose” has been described by The Lewis Group of The California Institute of Technology, and is based on readily fabricated, chemically sensitive conducting polymer films. According to information presented on their website:
“An array of sensors that individually respond to vapors can produce a distinguishable response pattern for each separate type of analyte or mixture. Pattern recognition algorithms and or neural network hardware are used on the output signals arising from the electronic nose to classify, identify, and where necessary quantify, the vapor or odors of concern. This response is much like the way the mammalian olfactory sense produces diagnostic patterns and then transmits them to the brain for processing and analysis.
“This approach does not require development of highly specific recognition chemistries, one for each of the many possible analytes of interest. Instead this approach requires a broadly responsive array of sensors that is trainable to the target signature of interest and then can recognize this signature and deliver it to the sensing electronics in a robust fashion for subsequent processing by pattern recognition algorithms. The Caltech electronic nose functions at atmospheric pressure, functions in a variety of ambients, exhibits near-real time detection, and has already been demonstrated to track vapors in air.
“The underlying principle of the Caltech electronic nose is extraordinarily simple. When a polymer film is exposed to a gaseous vapor, some of the vapor partitions into the film and causes the film to swell. In the electronic nose, this swelling is probed electrically because the sensor films each consist of a composite that contains regions of a conductor that have been dispersed into the swellable organic insulator. The vapor-induced film swelling produces an increase in the electrical resistance of the film because the swelling decreases the number of connected pathways of the conducting component of the composite material. The detector films can be formed from conducting polymer composites, in which the electronically conductive phase is a conducting organic polymer and the insulating phase is an organic polymer, or from polymer-conductor composites in which the conductive phase is an inorganic conductor such as carbon black, Au, Ag, etc and the insulating phase is a swellable organic material. The electrical resistance of the device is then read using simple, low power electronics.
“Any individual sensor film responds to a variety of vapors, because numerous chemicals will partition into the polymer and cause it to swell to varying degrees. However, an array of sensors, containing different polymers, yields a distinct fingerprint for each odor because the swelling properties over the entire array are different for different vapors. The pattern of resistance changes on the array is diagnostic of the vapor, while the amplitude of the patterns indicates the concentration of the vapor.”

### See: The Lewis Group, California Institute of Technology, Pasadena, Calif.

A second device that may be used to implement the present invention is called the “Cyranose,” and is described by Rodney M. Goodman, in his article entitled “The Electronic Nose.” According to Goodman:
“The technology uses sensors mixed with carbon black to make them conductive. The polymers swell with an odorant and their resistance changes. An array of different polymers swell to different degrees giving a signature of the odorant. This technology has been commercialized by Cyrano Sciences and a handheld electronic nose has been launched as a product.”

A third device that may be used to implement the present invention is described by Smiths Detection of Danbury, Conn., which produces and sells devices for identifying materials.

In FIG. 38, the customer 17b uses her computer 111 to visit the Internet Dating Service website to obtain the results of the laboratory analysis 135. In one embodiment, the analysis includes a listing of MHC alleles, MHC-determined peptides, MHC-odors or some other MHC-dependent profile. In an alternative embodiment, the results may be dispatched to the customer by regular mail or by e-mail.

In an alternative embodiment of the invention, the customer pays for the Test Kit 115 and the analysis when he or she obtains the results of the analysis.

In FIG. 39, the website reports the results 136 of a matching process that has been performed by comparing the customer's attributes to the attributes of a library of candidates. In one embodiment of the invention, the matching process correlates the set of self-describing attributes and the set of ideal-match attributes provided by the customer. Examples of attributes are supplied in Table One:

TABLE ONE

| Category | Examples of Attributes |
|---|---|
| Gender | Male, Female |
| Age | |
| Appearance | Handsome/Knockout, |
| | Attractive/Cute |
| Marital history | Single, Divorced |
| Residence location | |
| Height | Tall, Average, Short |
| Weight | |
| Hair Color | Blonde, Brunette, Redhead |
| Occupation & Income | |
| Religiosity | Yes/No; Denomination |
| Political preferences | Conservative, Liberal, None |
| Interests or hobbies | |
| Educational level | |
| Social Class Marker | |

The correlation process may involve comparing responses to individual preferences or predilections, or may involve more complex matching methods, such as those described in related U.S. Patent Application U.S. Ser. No. 11/881,153, entitled Searching Methods, which was filed on 24 Jul. 2007.

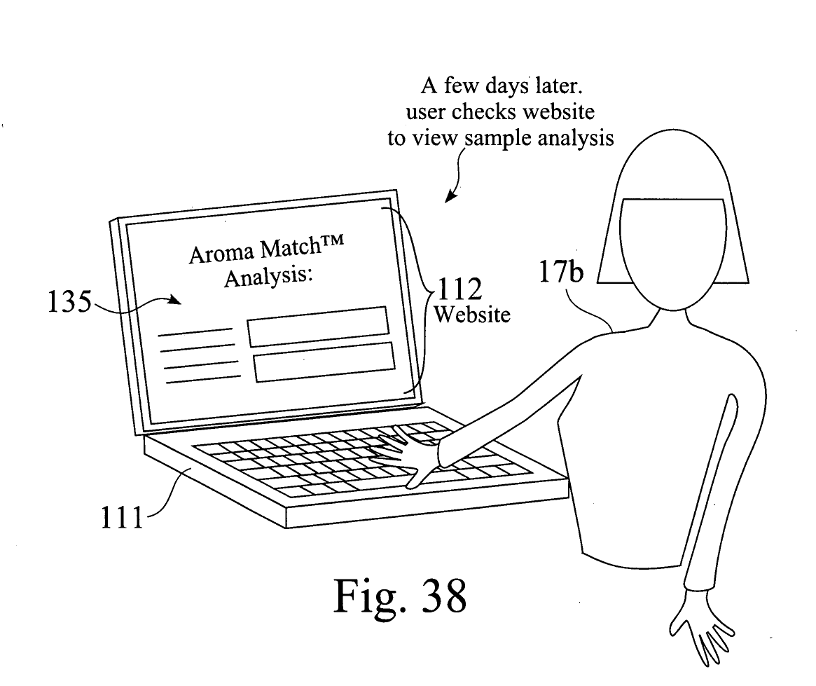

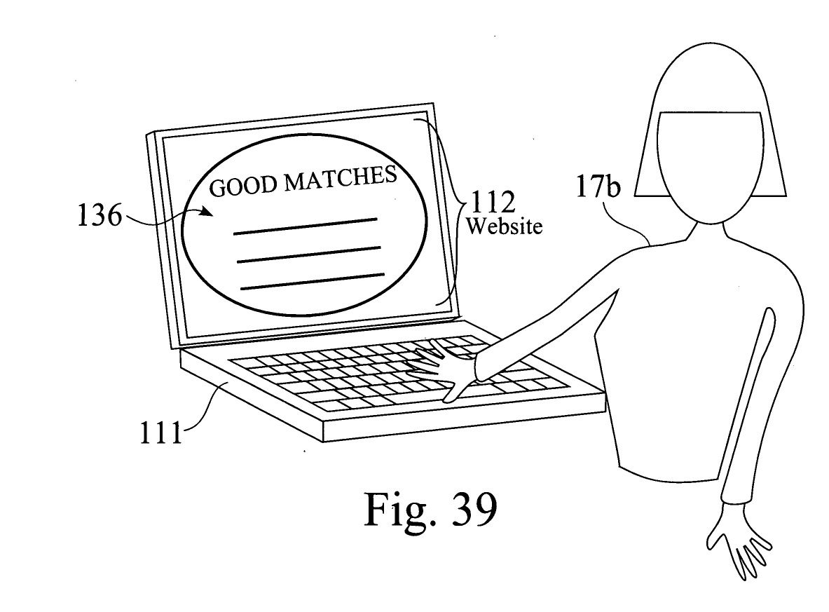

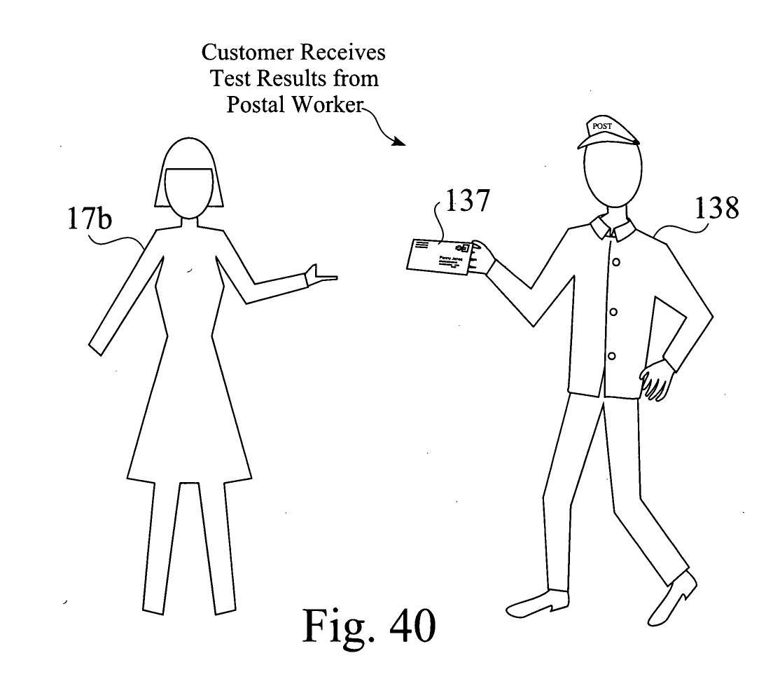

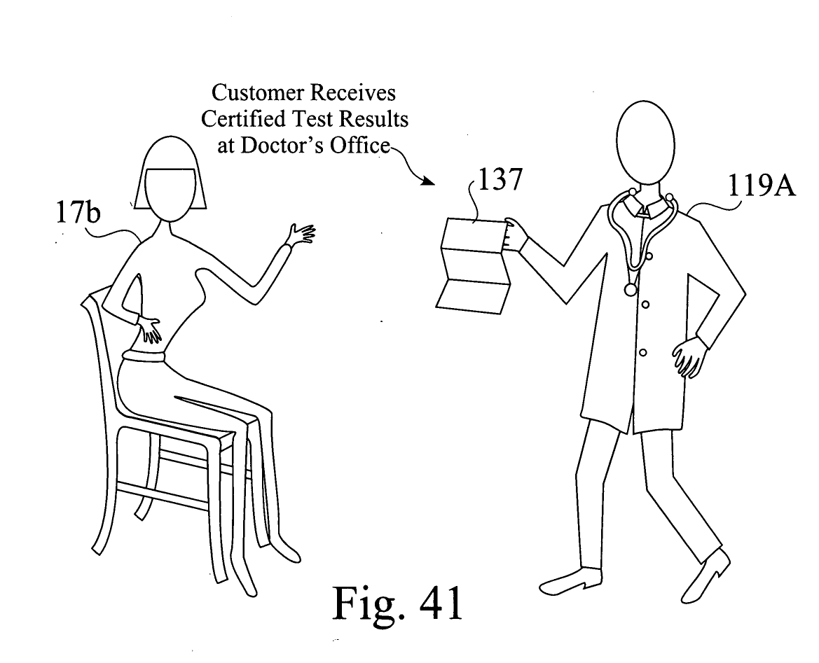

In FIG. 40, the customer 17b is shown receiving her test results 137 from a postal worker 138, while FIG. 41 shows the customer 17b receiving her test results 137 from a physician or other health care worker 119A in a doctor's office or clinic.

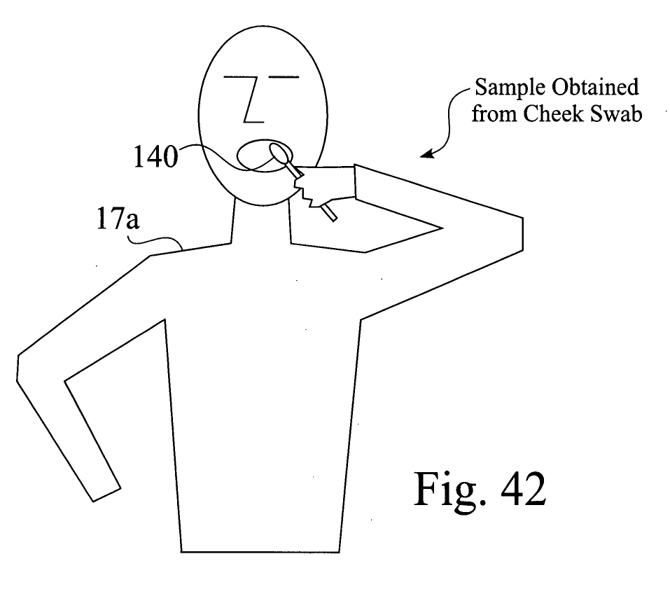

FIG. 42 reveals yet another alternative embodiment, in which a tissue sample 140 is obtained using a cheek swab. In other embodiments, a tissue sample may be obtained from any suitable bodily material or fluid, including, but not limited to, blood, saliva, exhaled breath, fingerprint, urine, hair, nail, or skin. One device that may be used to implement this portion of the present invention is produced and sold by DNA Genotek of Ottowa, Ontario, Canada, which produces and sells the Oragene™ DNA Self-Collection Kit, for collecting and preserving large amounts of DNA from saliva.

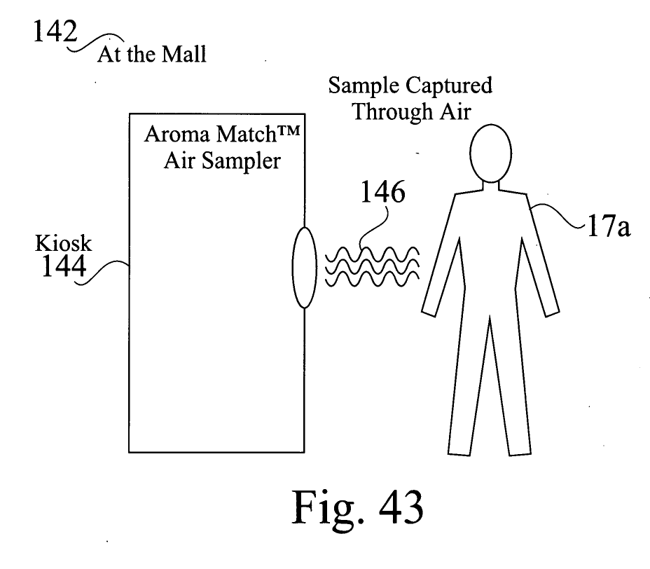

FIG. 43 exhibits an alternative embodiment, which collects a sample directly from the air 146 surrounding a customer 17a standing near a kiosk 144 that has been installed in a shopping mall 142. In yet another embodiment, a sample collecting tube may briefly be placed under a portion of a customer's clothing to obtain an air sample.

In an alternative embodiment of the invention, an automatic machine or device which accepts a DNA sample may be used to obtain an analysis without the intervention of a technician or clerk.

### VI. One Specific Embodiment for Obtaining a Sample: Collection of Saliva

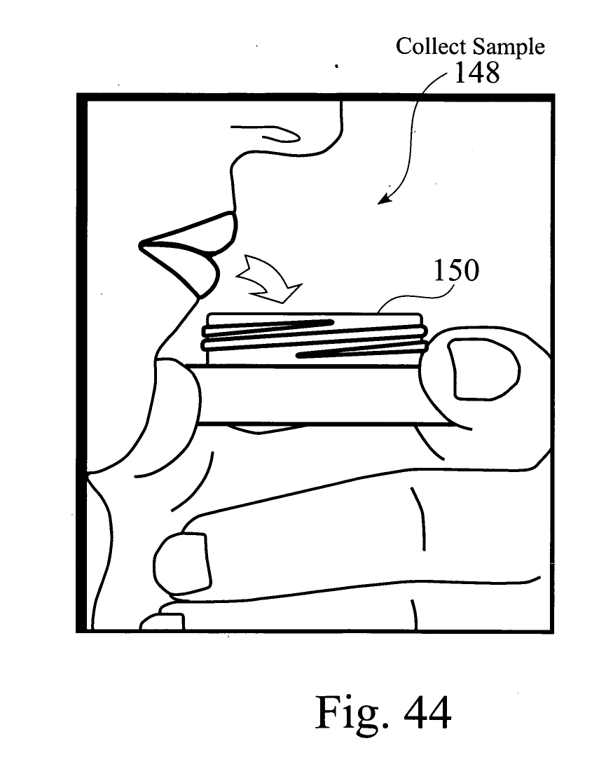

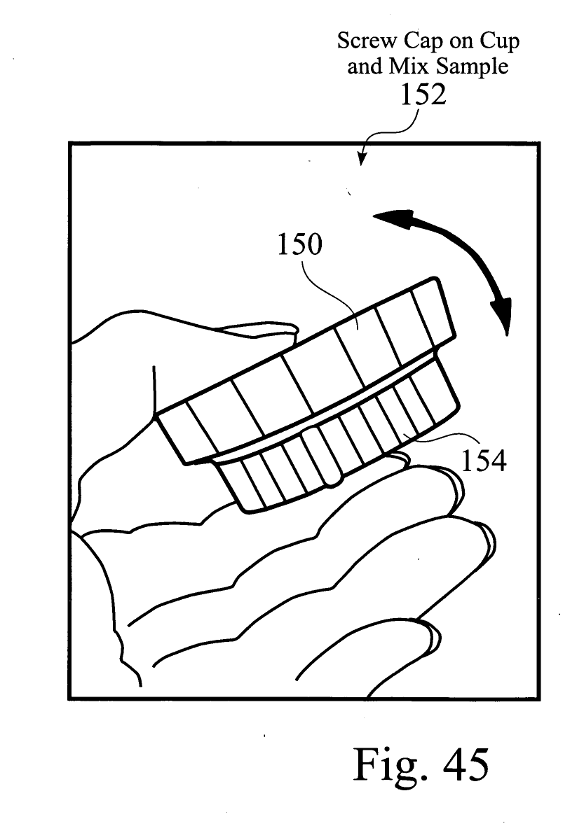

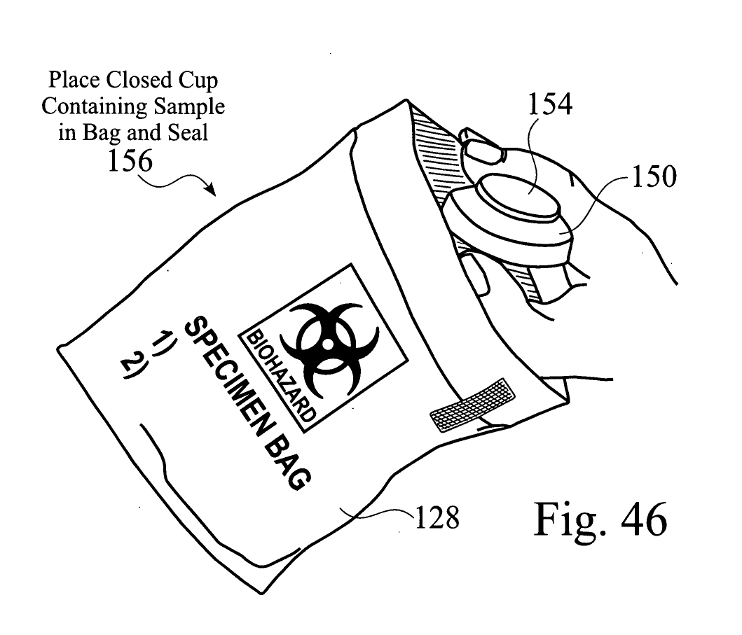

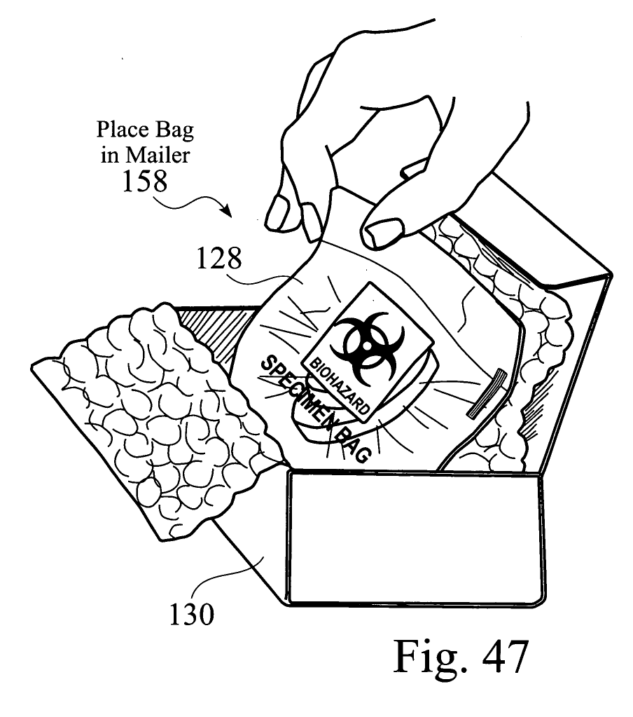

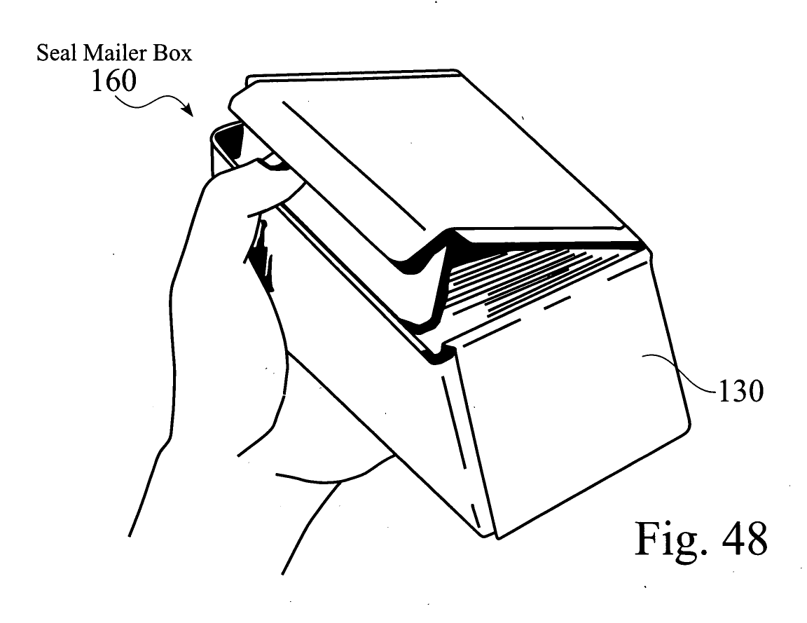

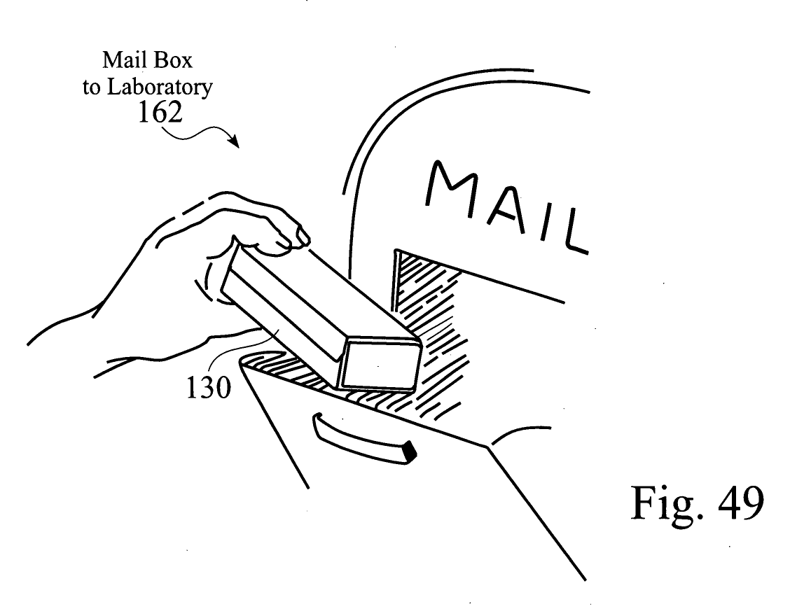

In one particular embodiment of the present invention, the customer 17 provides a saliva sample for analysis by a laboratory. FIG. 44 depicts the collection of a saliva sample 148 in a disc-shaped container or cup 150. In FIG. 45, a cap 154 is screwed on to the cup, and the sample is mixed 152. FIG. 46 illustrates the step 156 of placing the closed cup in a sample bag 128, and the bag 128 is sealed. FIG. 47 shows the step 158 of placing the sample bag 128 in a mailing box 130. FIG. 48 depicts the step 160 of sealing the mailing box 130, and FIG. 49 depicts the step 162 of mailing the box 130. More details concerning particular embodiments of sample collection and analysis that may be used to implement the present invention may be found by visiting the website for DNA Genotek, Inc. of Ottowa, Ontario, Canada.

The present invention may be implemented by obtaining any sample from a customer which may be analyzed to determine genetic characteristics.

### VII. Business Methods: Predicting a Good Match

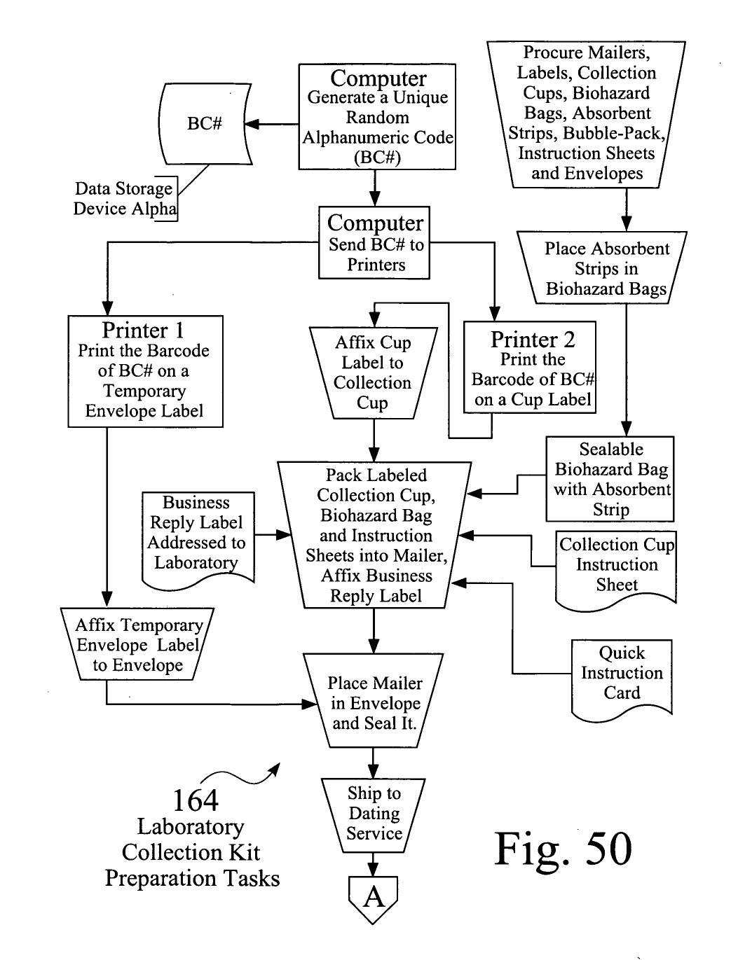

FIG. 50 is a flow chart 164 which illustrates laboratory collection kit preparation tasks.

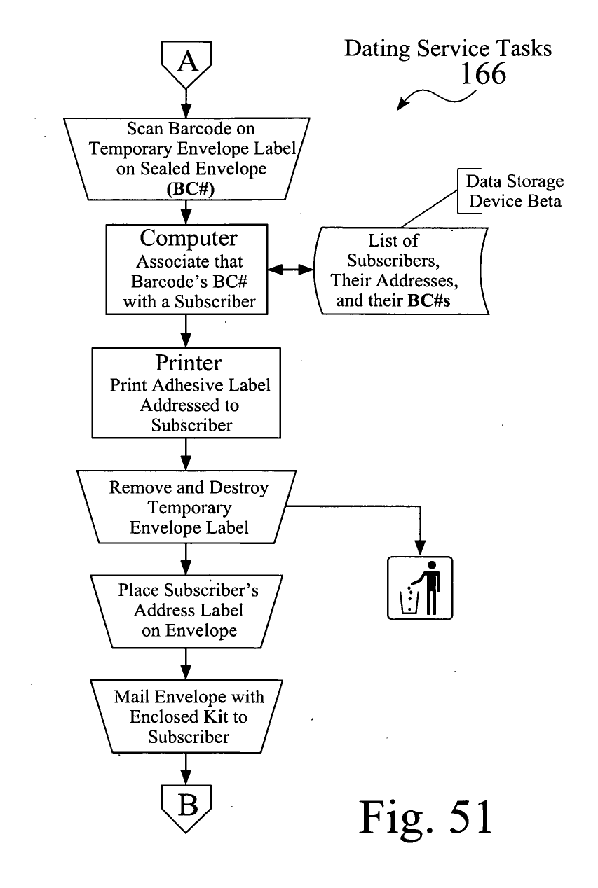

FIG. 51 is a flow chart 166 which illustrates dating service tasks.

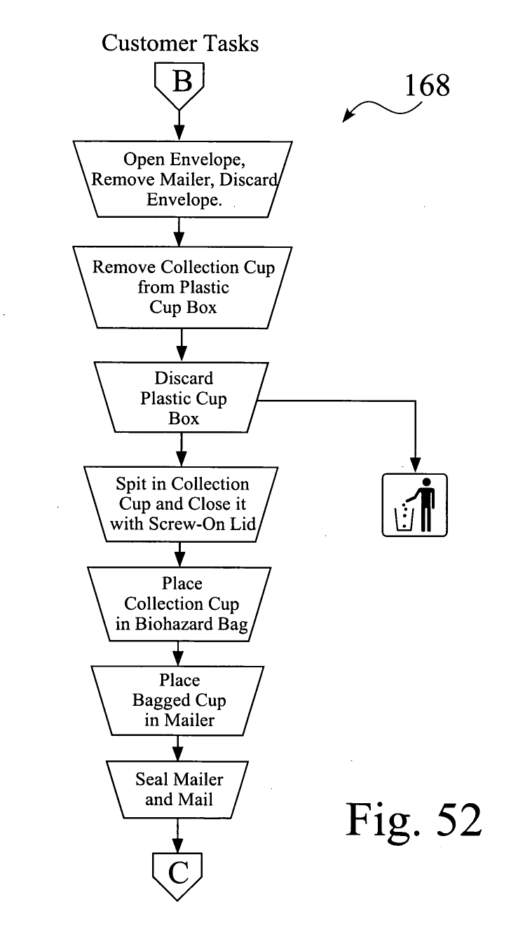

FIG. 52 is a flow chart 168 which illustrates customer tasks.

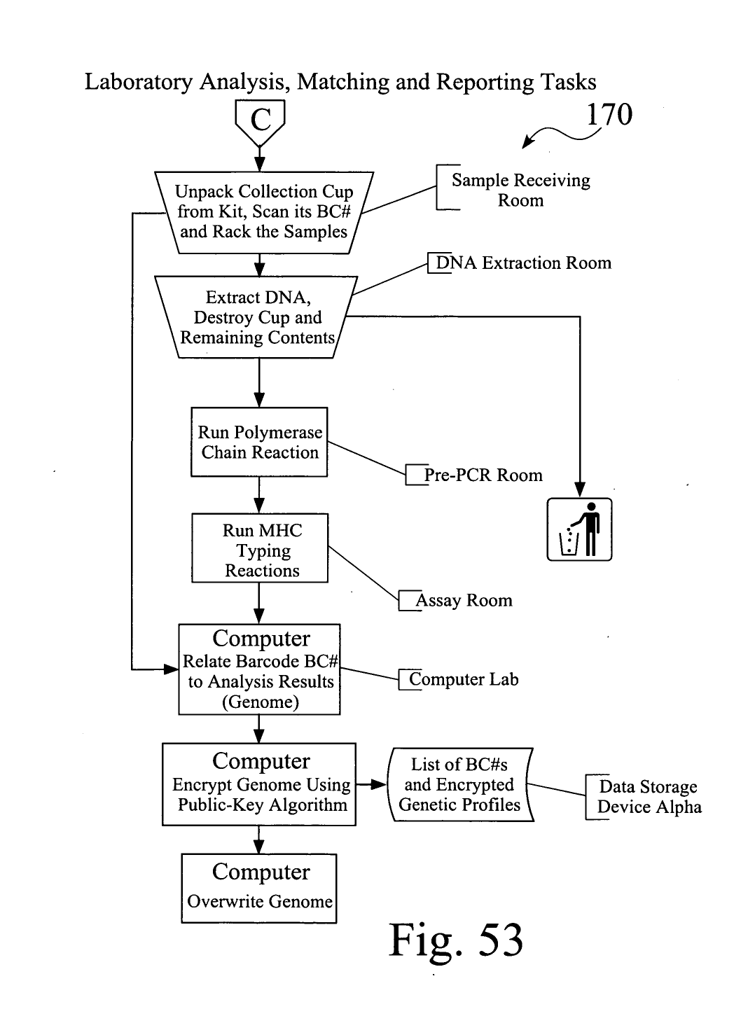

FIG. 53 is a flow chart 170 which illustrates laboratory analysis, matching and reporting tasks.

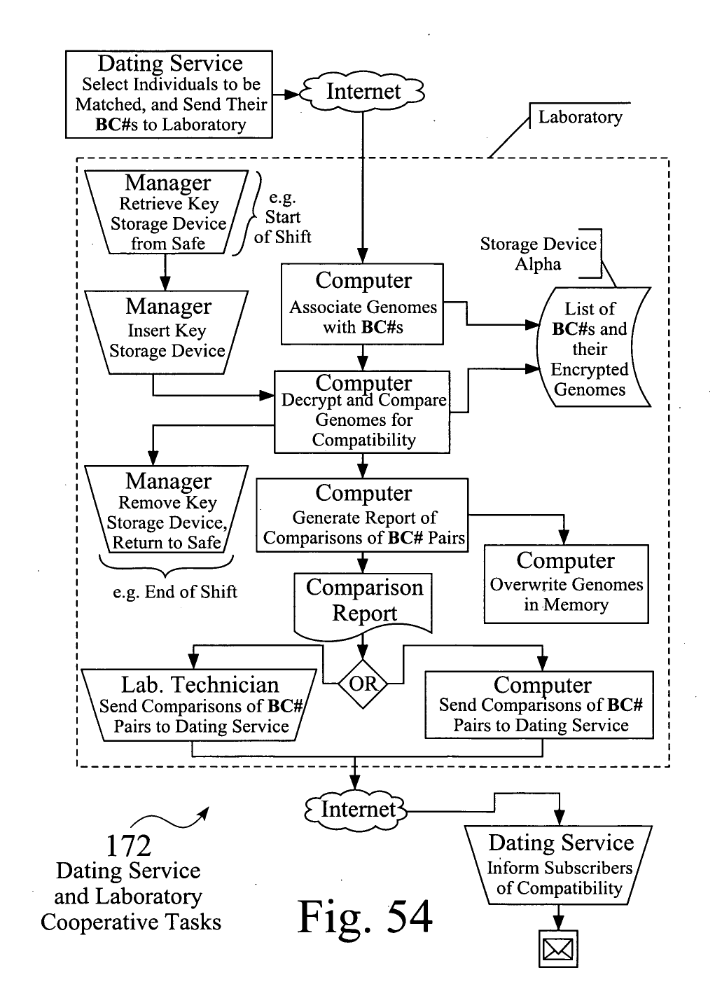

FIG. 54 is a flow chart 172 which illustrates dating service and laboratory cooperative tasks.

### VIII. MHC Biology

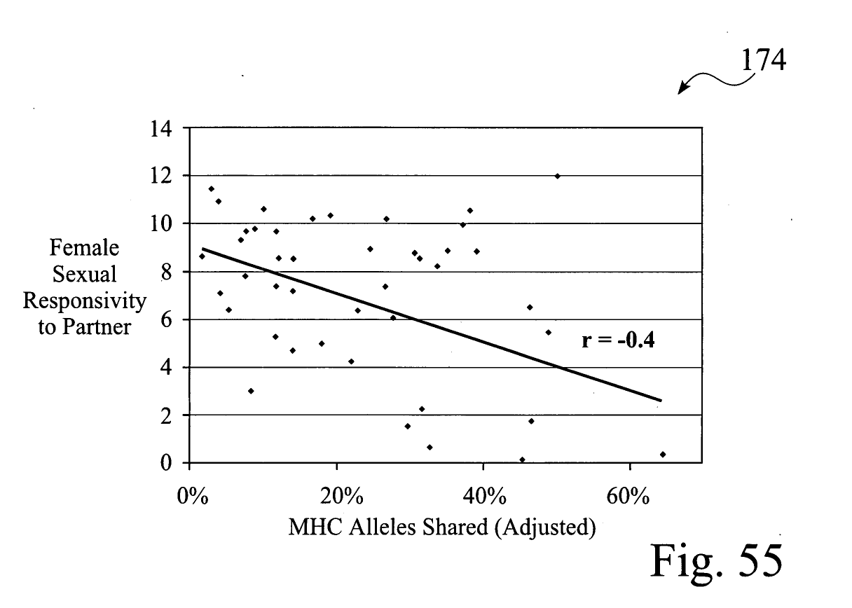

FIG. 55 is a graph 174 which plots experimentally measured human female sexual responsivity to another person on the y-axis, and the number of MHC alleles shared with that other person on the x-axis. The graph shows that a woman's sexual response, or responsivity, to a man is much higher if the man has MHC alleles which are different from her own. The greater the dissimilarity, the greater her response. The highest responsivity occurs when the proportion of shared MHC alleles is zero percent, while the lowest responsivity occurs when the proportion of shared MHC alleles approaches seventy percent.

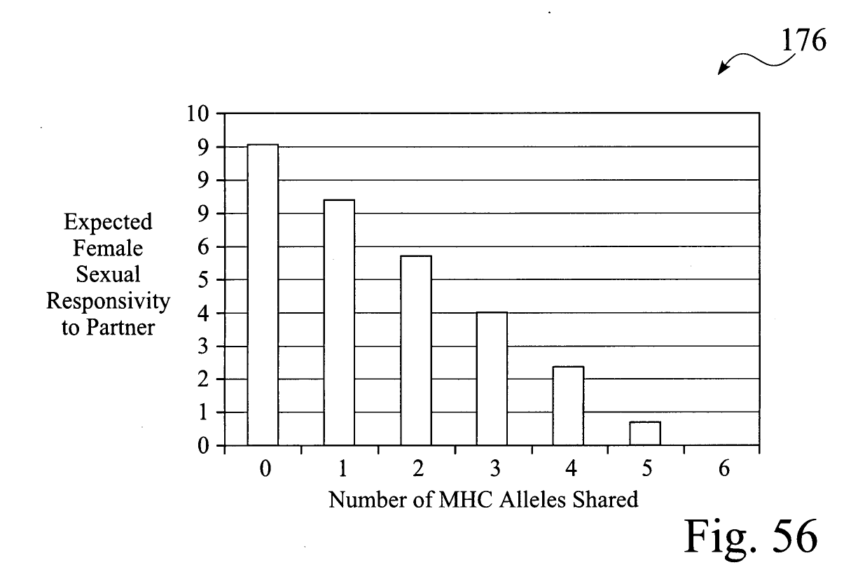

FIG. 56 depicts similar experimentally measured data in the form of a bar chart 176, and shows an expected female sexual responsivity to a partner along the y-axis, and the number of shared MHC alleles on the x-axis.

After a sample that has been obtained from a customer is received at a laboratory, the sample is processed to extract DNA. DNA is the chemical inside the nucleus of a cell that carries the genetic instructions for making living organisms. A cell is the basic unit of any living organism. It is a small, watery, compartment filled with chemicals and a complete copy of the organism's genome. Each cell contains a nucleus, which is the central cell structure that houses the chromosomes. Chromosomes are one of the threadlike “packages” of genes and other DNA in the nucleus of a cell. Chromosomes enclosed within the nucleus, which is, in turn, enclosed in the center of the cell.

Different species have different numbers of chromosomes. Humans have twenty-three pairs of chromosomes, forty-six in all: forty-four autosomes and two sex chromosomes. Each parent contributes one chromosome to each pair, so children get half of their chromosomes from their mothers and half from their fathers.

Part of the chromosome is called a gene. The gene is the functional and physical unit of heredity passed from parent to offspring. Genes are pieces of DNA, and most genes contain the information for making a specific protein.

A strand of DNA comprises a pair of helical ribbons attached by bases that resemble the rungs of a ladder. These bases are named adenine, thymine, guanine and cytosine. Sometime uracil is substituted for thymine. A section of one of the spiral sides of the DNA together with one of the bases comprises a nucleotide. Nucleotides are one of the structural components, or building blocks, of DNA and ribonucleic acid (RNA). A nucleotide consists of a base (one of four chemicals: adenine, thymine, guanine, and cytosine) plus a molecule of sugar and one of phosphoric acid.

Another set of chemicals that are important building blocks in humans are amino acids. Amino acids are the “building blocks” of proteins. There are twenty different kinds of amino acids in the human body. When two or more amino acids are bonded together, they form a peptide.

An allele is one of the forms of a gene at a particular location or “locus” on a chromosome. Alleles are specific sequences of base pairs that can be present at a given locus. For example, at the HLA-A locus in a particular individual, alleles in the A*01 and A*02 groups may be found. The “*” in the allele group name indicates that it was determined by DNA typing, as opposed to serological methods.

Different alleles produce variation in inherited characteristics such as hair color or blood type. In an individual, the dominant form of the allele is expressed, while the recessive form is not expressed. An exception to this rule is the case in which the genes at a particular locus are expressed codominantly, in which case they are both expressed.

In accordance with the present invention, small amounts of DNA are obtained from the sample submitted to a laboratory by a user who has submitted a saliva sample or skin scraping. In one embodiment of the invention, personnel at the laboratory cut the sample using a punch to make three separate disc-shaped pieces. These pieces are each placed in a different test tube. All the pieces are washed several times with chemicals that purify the sample on each piece. After washing, each piece is dried in its tube.

In an alternative embodiment, if a saliva sample is obtained from the customer, the saliva is poured directly into three separate test tubes, washed and then the DNA analysis is performed.

When DNA is analyzed, a laboratory technician looks at particular places or “loci,” (which are the positions in a chromosome in which specific genes are known to occur) to determine the particular allele (variation of the gene). Previous research has determined that every person has a characteristic sequence of genetic material (allele) that resides at each of his or her genetic loci.

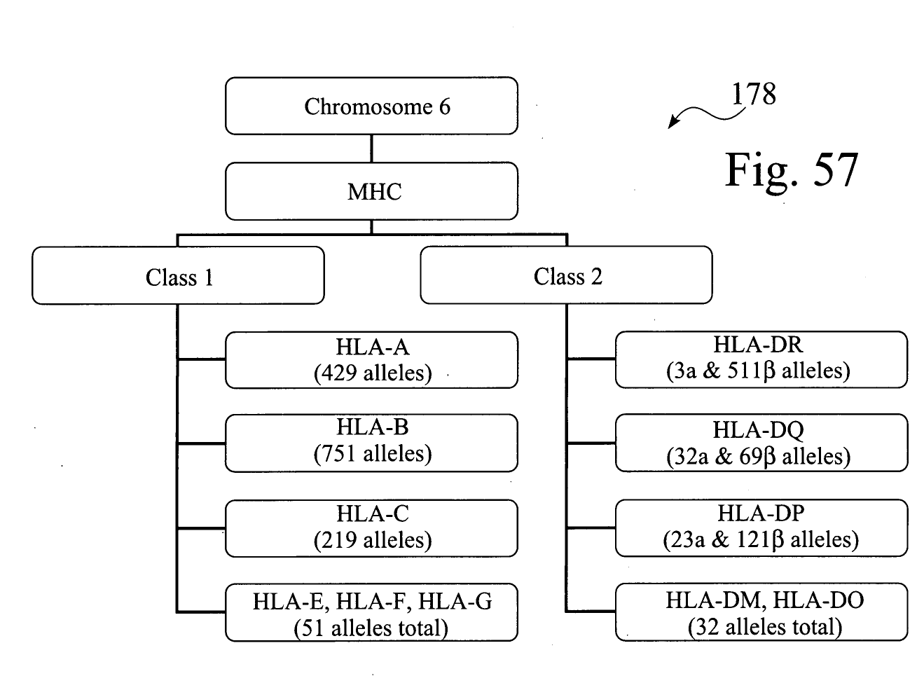

The laboratory technician basically examines particular sets of alleles that are found at a particular group of loci on a particular chromosome. To match alleles in the MHC region of the genome, the technician “takes an inventory” of the genetic material in the MHC region on Chromosome 6. Parts of the MHC are broken down into smaller groups of genetic material, and are given names. In one embodiment, the parts of the MHC that need to be inventoried are named “HLA-A,” “HLA-B” and “HLA-DRβ1.” These parts of the MHC are on a particular region of a particular chromosome. All these relationships 178 are illustrated in FIG. 57.

The term “allele groups” are also known as “2-digit alleles” and “2 alleles.” “High resolution alleles” are also known as “4-digit alleles” and “4 alleles.”

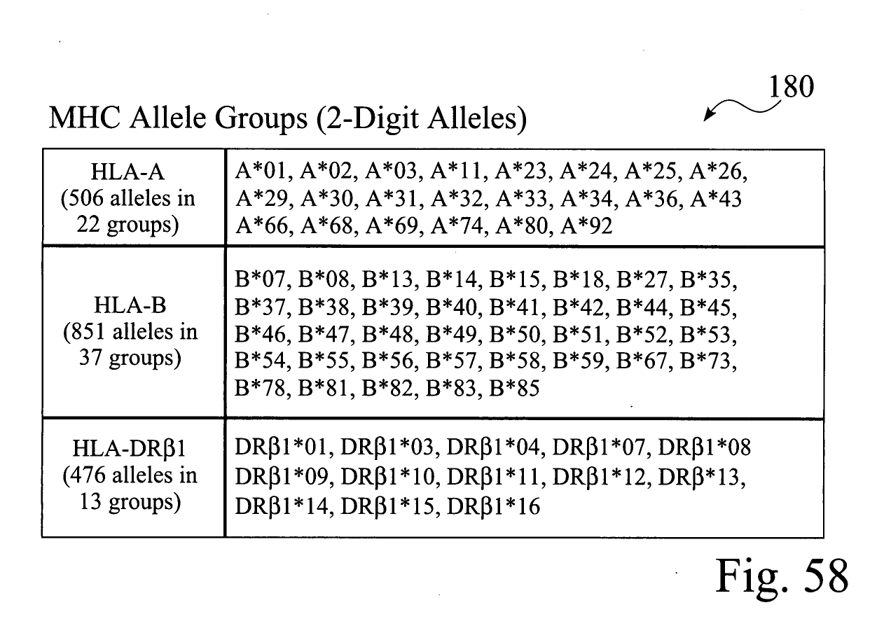

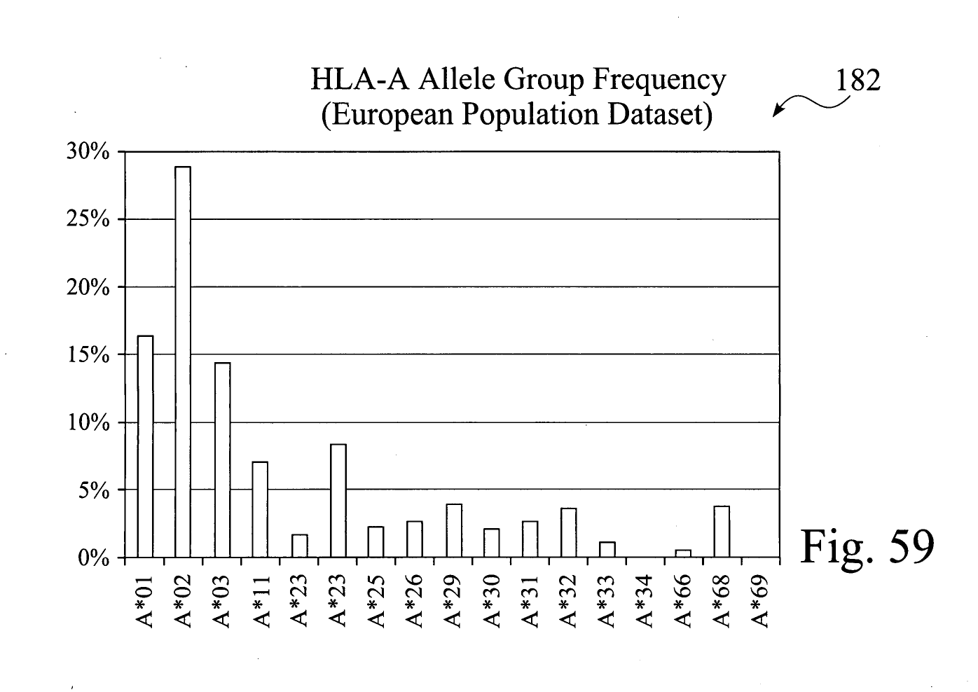

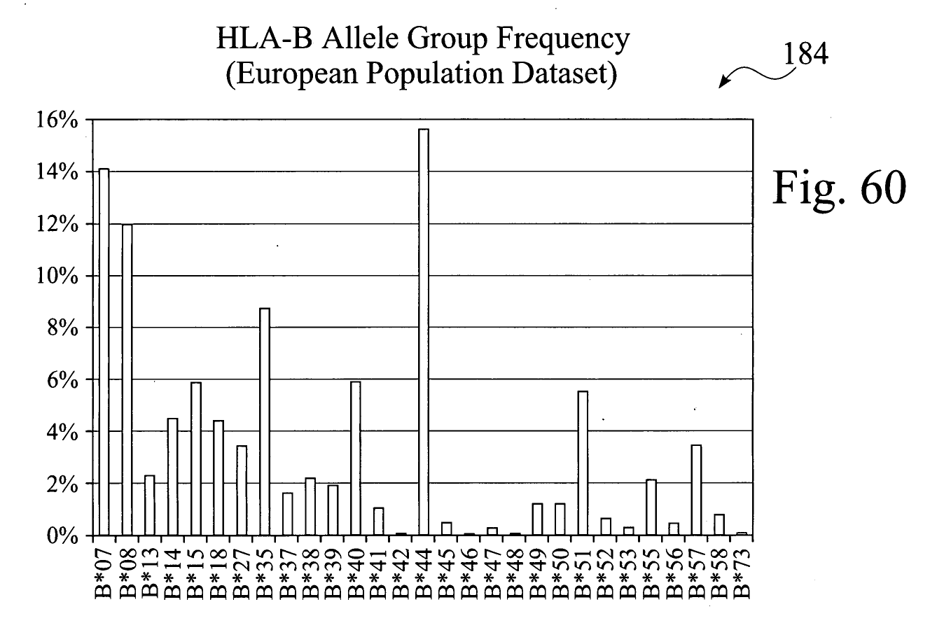

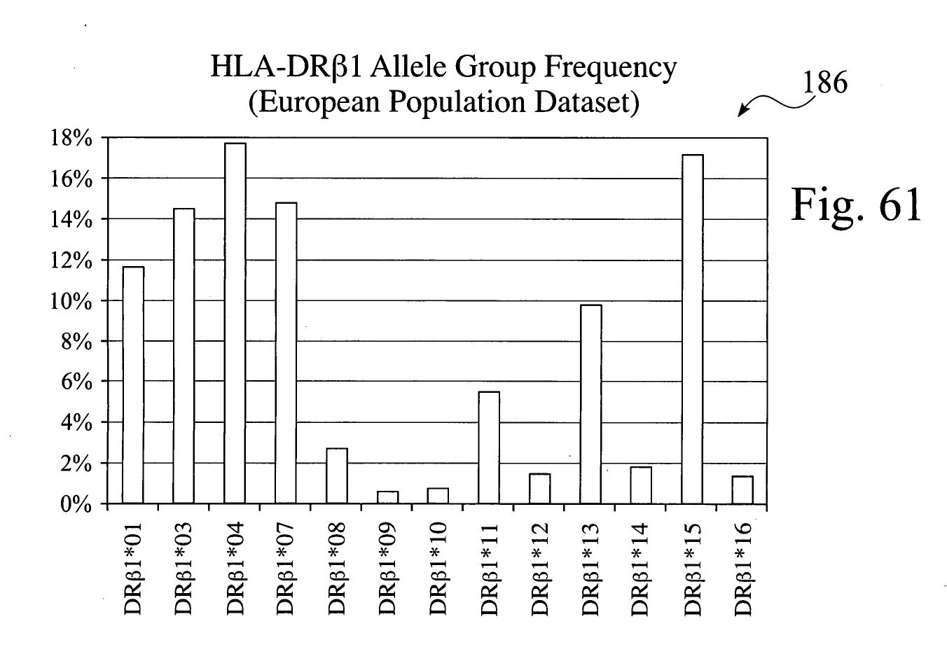

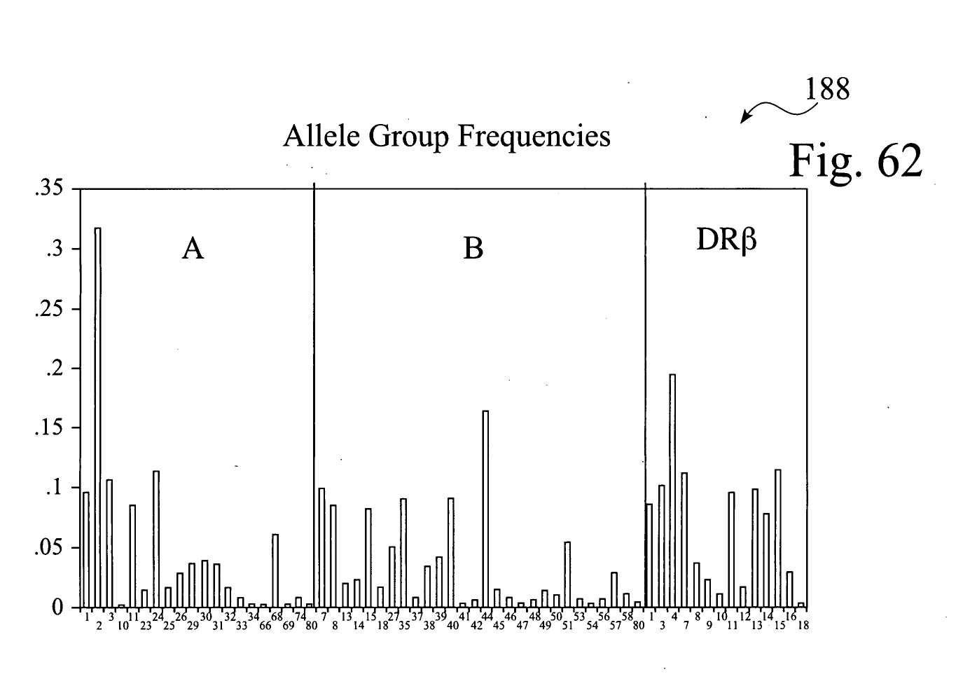

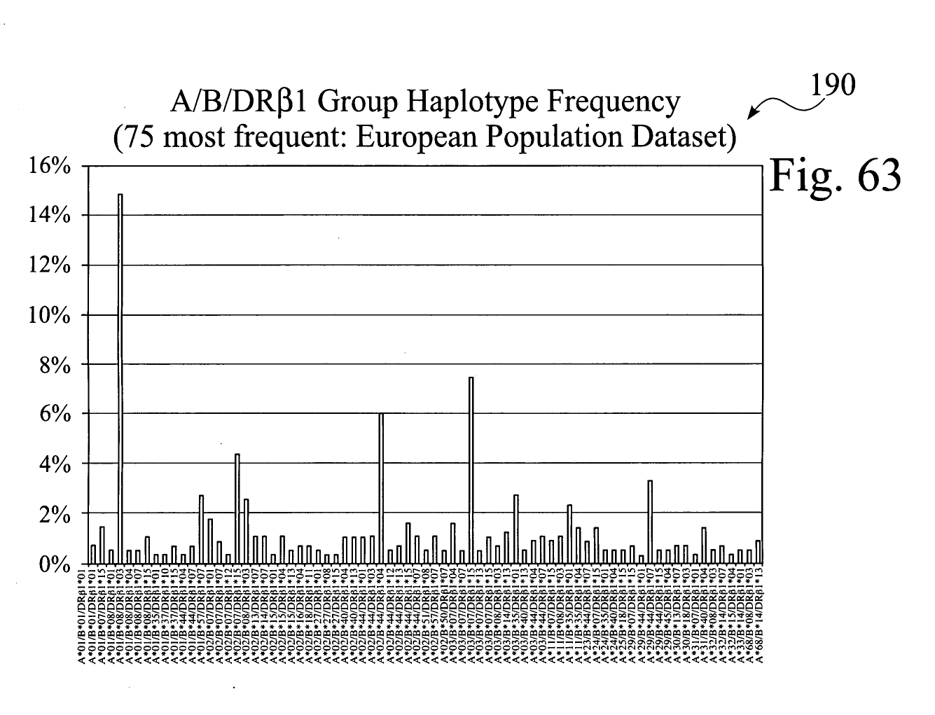

There are 21 HLA-A allele groups, 37 HLA-B allele groups, and 13 HLA-β1 allele groups. The various MHC Allele Groups 180, such as “A*01,” “A*02” and “A*03” are presented in FIG. 58. FIG. 59 depicts HLA-A Allele Group Frequency 182. FIG. 60 depicts HLA-B Group Frequency 184. FIG. 61 depicts HLA-DRβ1 Group Frequency 186. FIG. 62 depicts Allele Group Frequencies 188. FIG. 63 depicts A/B/DRβ1 Group Haplotype Frequency 190.

The sequence-specific oligonucleotide probe (SSOP) method is used. The basis of this method is HLA locus-specific amplification by polymerase chain reaction (PCR), and the subsequent probing of the resulting product by SSOP. A battery of probes is required. The pattern of reaction to these probes distinguishes the HLA alleles.

For each sample, the laboratory uses PCR for HLA locus-specific amplification at HLA-A, HLA-B, and HLA-DRβ1. Each of the three PCR amplifications results in a product. Each of the three products is then tested with a battery of probes. The HLA-A amplified product is tested with 12 probes at exon 2 and 16 probes at exon 3. The HLA-B amplified product is tested with 18 probes at exon 2 and 18 probes at exon 3. The HLA-DRβ1 amplified product is tested with 25 probes at exon 2. These are sufficient numbers of probes so that the reaction patterns will distinguish the HLA allele groups (2-digit alleles), for example, A*02.

After all the genetic codes that are contained on a sample piece is identified, this information is entered into a database along with the personal information and match preferences of the customer who submitted the sample.

Previous scientific research has determined that a woman's attraction to a particular man and her sexual response to him is based on the correlation between the alleles in the woman's MHC, and in the man's MHC. Specifically, a woman and a man who have different MHC genetic codes are more sexually compatible than a man and a woman who have similar MHC genetic codes.

So, when the lab technician takes an inventory of all the different allele groups (2-digit alleles) in a user's DNA sample, the technician is creating an identification or map of the person who submitted the sample. By comparing this identification or map with that of a different person, a technician can predict which other people will be attractive and sexually responsive to the customer, all based on the genetic code of each individual. In addition to the HLA-A, HLA-B and HLA-DRβ1 loci specified above, genetic information from other loci on Chromosome 6 or any other chromosome may be used to enhance a match.

In alternative embodiment of the invention, genetic attributes are determined by analyzing serologically typed HLA antigens. While “allele groups” are determined by genetic testing, such as PCR-SSOP, HLA antigens are determined by serological, or blood reaction, testing. Serological typing provides approximately the same resolution as “2-digit alleles.” It cannot provide the higher resolution comparable to “4-digit alleles.”

More detailed information concerning this analysis may be found in Methods in Molecular Biology, Vol. 210: MHC Protocols, edited by S. H Powis and Robert W. Vaughan, Humana Press Inc., Totowa, N.J., 2003. (See Chapter 5, “PCR-Sequence-Specific Oligonucleotide Probe Typing for HLA-A, -B, and -DR, by Derik Middleton and F. Williams). Another useful publication is Histocompatibility Testing, edited by Jeffrey L. Bidwell and Cristina Navarrete, Imperial College Press, 2000. (See Chapter 6, “PCR-SSOP Typing” by D. Middleton.) These publications explain how to type the MHC loci of interest using a two-tier system. The first level of resolution determines the allele group (2-digit alleles), and the second level uses this knowledge to determine the allele subgroup (4-digit alleles). Alleles in the MHC region may also be identified by the antigens produced by the proteins manufactured in the cells, using the “blueprint” provided by the allele. These Human Leucocyte Antigens (HLAs) may be typed by the complement-dependent lymphocytotoxicity.

HLA typing can be performed by the complement dependent lymphocytotoxicity reaction (serology). Live peripheral blood mononuclear cells are required for this assay (CD8+T-cells and/or CD19+). B-cells are purified from whole blood, and incubated against a panel of antibodies with specificity against polymorphic epitopes expressed on HLA-A and -B proteins. In the presence of complement cells expressing HLA proteins which react with a particular antibody are lysed, allowing these damaged cells to uptake a stain which is detected by fluorescent microscopy. The pattern of negative and positive reactions is scored and interpreted to give an HLA serological type. HLAs may also be identified by their odor, and it is this method that humans and other mammals use for mate selection and personal identification, and by the electronic odor sensing process described above.

Additional information concerning HLA analysis may be found in Histocompatibility Testing, edited by Jeffrey L. Bidwell and Cristina Navarrete, Imperial College Press, 2000. (See Chapter 1, “HLA Typing by Alloantibodies and Monoclonal Antibodies” by G. M. Th. Schreuder; and Chapter 2, “Screening for HLA-Specific Antibodies” by C. Brown and C. Navarrete.) These publications explain how to type the MHC loci of interest using antibody reactions.

As genome sequencing has become less expensive, there has been a great deal of interest in pairing variations in certain genes with variations in behavior (“Molecular Psychiatry”). This science is still young: the following are recent discoveries. This invention can be used to refine its relationship-predicting service by including some or all of these genetic loci:

The brain neuropeptide arginine vasopressin (AVP) is a pituitary hormone which regulates blood pressure and kidney function in mammals. Studies of voles (one of the few non-human mammals that exhibit pair-bonding) found that AVP exerts a strong influence on their pair-bonding. This work has recently been extended to humans, and has revealed an association between one of the alleles of the AVPR1a gene (this gene codes for cellular receptors for AVP) and traits reflecting pair-bonding behavior in men, including partner bonding, perceived marital problems and marital status. The study also shows that it affects marital quality as perceived by their spouses. See Walum, Hasse et al., “Genetic variation in the vasopressin receptor 1a gene (AVPR1a) associates with pair-bonding behavior in humans,” Proceedings of the National Academy of Sciences, Vol. 105, No. 37, Sep. 16, 2008).

Oxytocin is a hormone “ . . . which seems to modulate a wide range of sexual and social behaviors from social recognition, pair bonding, mate guarding and parental care in rodents, to love, trust or fear in humans.” Certain alleles of the CD38 gene lead to impaired nurturing behaviors, social amnesia (failure to recognize others) and is suspected of causing “ . . . some forms of impaired human behavior in the spectrum of autism disorders.” See Jin, Duo et al., “CD38 is critical for social behavior by' regulating oxytocin secretion,” Nature, Vol. 446, pp. 41-45 (2007).

Variations in a dopamine receptor gene (DRD4, on Chromosome 11 in humans) contribute to individual differences in human sexual behavior: desire, arousal and sexual function, and in particular predicts overall sexual interest. Studies that have shown this effect in animals have now been extended to humans and show similar results. See Ben Zion, I Z, et al., “Polymorphisms in the dopamine D4 receptor gene (DRD4) contribute to individual differences in human sexual behavior: desire, arousal and sexual function,” Molecular Psychiatry Vol. 11, pp. 782-786 (2006), and Pearson, Helen, “Sexual desire traced to genetics,” Nature Online, doi:10.1038/news060529-6 (Published online 31 May 2006).

Recently-published work finds that variations in the ER (Chromosome 6) locus predict psychoticism, neuroticism, non-conformity and extraversion in women, including sexual behavior. See Westberg et al., Association between a dinucleotide repeat polymorphism of the estrogen receptor alpha gene (ERα) and personality traits in women, Molecular Psychiatry 8, Pages 118-122 (2003).

A more detailed description of matches using the information obtained by analyses of MHC, HLA and other genome loci such as those described above, as well as the Attributes listed in Table 1, may be found in a related Pending U.S. Patent Application, U.S. Ser. No. 11/514,285, entitled Matching System, which was filed on 30 Aug. 2006.

### IX. Finding Good Matches with a MateFinder™

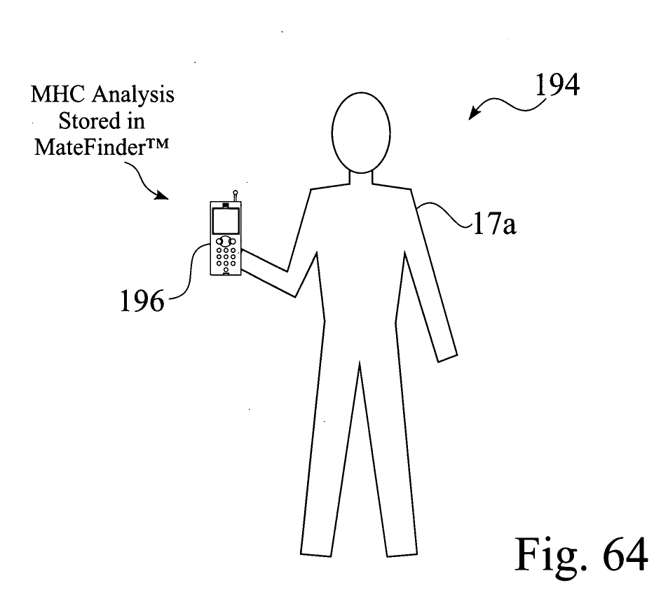

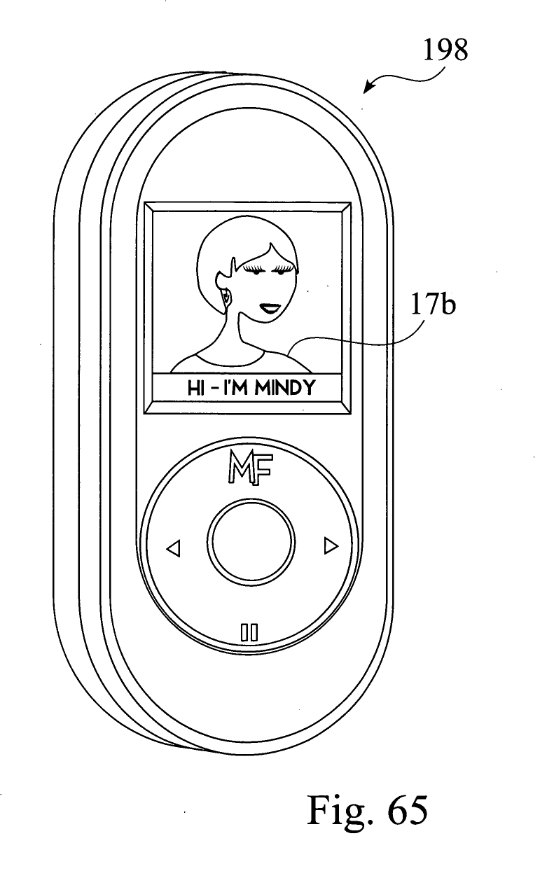

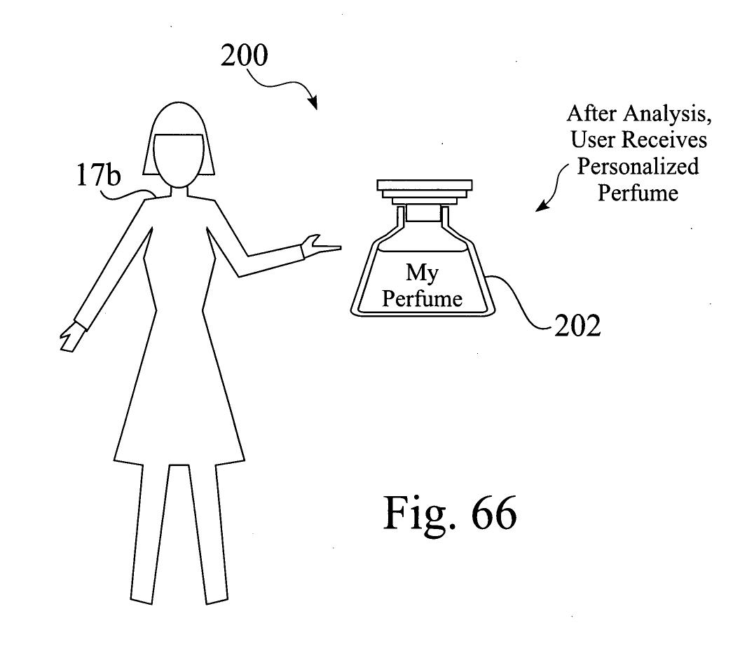

FIG. 64 shows the step 194 of a customer using a MateFinder™ device 196 which has been programmed with his genetic attributes, as determined in accordance with the present invention. FIG. 65 offers a detailed view of one embodiment of a MateFinder™ device 198.

In one particular embodiment, the MateFinder™ comprises a radio and a microprocessor with a non-volatile memory, such as a static random-access memory (RAM). Information that describes both the user and the ideal match can be written to the non-volatile memory. The radio automatically and periodically broadcasts a “seeking signal” over a short range. When the seeking signal is received by another MateFinder™, it is analyzed to determine the degree of correlation with the receiver's preferences. If the degree of correlation exceeds a preset minimum, the sender, the receiver, or both are alerted.

Another embodiment combines the MateFinder with a network radio or device, such as a cellular or Voice over Internet Protocol (VoIP) telephone or some other suitable device to provide communications over a wireless network. This combination enables voice calls, text-messaging, instant messaging, e-mails and Internet browsing. The user may also arrange to transfer gifts of music, photographs, video clips and other matter purchased from a third party. The MateFinder may be connected to a network using Wi-Fi, Wi-MAX, UltraWide Band (UWB) radio or any other suitable wireless system. The MateFinder may also communicate over a wired network such as the conventional telephone network, the Internet or may use VoIP.

In another embodiment of the invention, the MateFinder is programmed with information concerning the genetic attributes of a number of individuals. Romantic matches are suggested by correlating the genetic attributes of different individuals. These genetic attributes are first determined by testing tissue or fluid samples.

A more detailed description of this aspect of the present invention may be found in a related Pending U.S. Patent Application, U.S. Ser. No. 11/514,285, entitled Matching System, which was filed on 30 Aug. 2006.

### X. Benefits of the Invention

### Reducing Consanguinity

The present invention includes a method for selecting candidates for a relationship based on diversity in the Major Histocompatibility Complex (MHC) region of their genomes. This method of the invention reduces the risk of couples' producing children with birth defects that may arise from parents who are too closely related, and who may carry the same deleterious recessive gene. When two individuals share similar genetic characteristics, their relationship may be described as “consanguineous.” According to Wikipedia, the terms consanguineous and consanguinity indicate a relationship in which two persons are “of the same blood or origin; specifically: descended from the same ancestor.”

It has been known since prehistoric times that closely-related members of a mated pair, be they plants, domesticated animals or humans, are at a much higher risk of having offspring with birth defects and other weaknesses, or to lose their progeny as embryos or fetuses. It has also been recognized since antiquity that outbred offspring tend to have better health and general fitness. This is the origin of the term, “hybrid vigor,” or heterosis.

This effect also drives a major facet of human ethical behavior. Few human transgressions are viewed with as much odium is incest; all known cultures have strong taboos prohibiting this activity. Inbreeding avoidance is also seen in many non-human species, including invertebrates.

The deleterious effects of inbreeding are well-explained in Wikipedia:

“Two leading hypotheses explain the genetic basis for fitness advantage in heterosis.

“The overdominance hypothesis implies that the combination of divergent alleles at a particular locus will result in a higher fitness in the heterozygote than in the homozygote. Take the example of parasite resistance controlled by gene A, with two alleles A and a. The heterozygous individual will then be able to express a broader array of parasite resistance alleles and thus resist a broader array of parasites. The homozygous individual, on the other hand, will only express one allele of gene A (either A or a) and therefore will not resist as many parasites as the heterozygote.

“The second hypothesis involves avoidance of deleterious recessive genes (also called the general dominance hypothesis), such that heterozygous individuals will express fewer deleterious recessive alleles than its homozygous counterpart.”

Since the MHC region of the genome has a very high degree of variation among individuals, similarity in the MHC region argues for close relationship, and thus for the defective offspring. Use of the present invention for pair matching strongly increases the chances that offspring will be healthy.

For over two centuries in Western cultures, people of childbearing age have been highly mobile and thus often have obscure ancestry. People can thus not always be sure they are not pairing themselves with closely-related partners. The present invention provides a safe, confidential and discreet way of managing this issue.

### Increasing Fertility

The present invention includes a method which selects for more diversity in a couple's children's immune systems, increasing the chance that its children will survive, thrive, and increase the couple's fertility.

The term “fertility” is usually defined as a measure: “fertility rate” is the number of children born per couple, person or population. In this Specification, and in the Claims that follow, the term “fertility” is used in a longer-term sense, describing the number of a couple's descendants over a few generations compared to that of the population as a whole.

It has been known since antiquity that couples who are closely related have relatively few children who survive until adulthood. The couples often fail to conceive, and their offspring suffer a higher-than-average number of birth defects. As we have shown elsewhere, fetal loss from defects in the embryo, premature delivery and complications of pregnancy are higher for closely-related couples.

The fertility (as defined above) of couples who are first or second cousins is poor. First and second cousins had very few grandchildren, while third and fourth cousins had the largest number. In more distant relationships, fertility declined, so that sixth cousins have about the same number of grandchildren as first cousins. Fertility tends to level off at seventh cousins and more distant relationships.

This loss of fertility is not inconsistent with the linear increase in attraction and responsivity noted above. It is important to note that humans and their hominid forebears lived for 3 million years—until about 50,000 years ago—in hunting-gathering camps that contained no more than 50 people; usually about 30. Many times, depending on the culture, men or women would move to a neighboring camp to take a mate. Thus the likelihood of outbreeding beyond fifth or sixth cousin was very low, and there was no evolutionary pressure to limit the degree of outbreeding. A linear increase in attraction and responsivity is completely consistent with those anthropological findings.

### Increasing Fitness

The present invention increases the likelihood of reproductive success. This benefit is accomplished by ensuring that the couple is not, without its knowledge, closely-enough related that their children run a high risk of defects arising from inbreeding, for example those arising from each partner's carrying a recessive deleterious gene.

The term “fitness” is defined as “the probability of reproductive success through one's own offspring.” People who select mates with alleles of genes in the Major Histocompatibility Complex (MHC) that are different from theirs in accordance with the present invention will have more successful pregnancies, offspring with more robust immune systems, and in many cases a greater number of grandchildren. These beneficial consequences comprise the elements of reproductive success.

### Enhancing Immune System Diversity

The present invention enhances the immune system diversity of offspring. One method of the invention selects for more diversity in the immune systems of children, increasing the chance that the children will survive and thrive, and since their children will pass their more-diverse genomes to their own children, thus enhancing their chances of survival and reproduction, the couple's fertility is increased.

Genes in the Major Histocompatibilty Complex (MHC), a region of the short arm of Chromosome 6 in humans, contain information on foreign substances from the environment such as bacteria or viruses causing infectious diseases (antigens) that have been experienced and overcome by individuals and their ancestors. Like most genes, MHC genes contain instructions for cells to manufacture proteins. When an MHC protein is made, mechanisms in the cell clip (ligate) short strands of protein (peptides) from the large protein molecule. These ligands or peptides contain information on the molecular structure of the foreign substances listed above. They migrate to the cell's surface, and inform the immune system of the structure of these legacy substances, and are thus also called antigens (antigen is a general name for a substance that elicits an immune response). The antigens generated by the MHC genes may be called either “histocompatibility antigens” or “human leucocyte antigens.” Cells bearing these antigens on their surfaces are called antigen-presenting cells. That term applies to any of various cells (as a macrophage or a B cell) that take up and process an antigen into a form that, when displayed at the cell surface in combination with a molecule ofthe Major Histocompatibility Complex, is recognized by and serves to activate a specific Helper T cell. Helper T cells are an important part of the human immune system.

Alleles in the MHC genes are codominantly expressed, meaning that if the mother and father carry different alleles (that is, variations) of the same gene, each allele is expressed. The offspring thus carry information on the antigens that have beset both of their ancestral lines. For this reason, if a child's parents' MHC alleles are more diverse (that is, if they share fewer alleles in the MHC region), the offspring have innate immunity to a larger number of diseases.

The present invention's matching method, which selects possible parenting partners on the basis of greater diversity in their MEC alleles, also selects for more diversity in the couple's children's immune systems. This increases the chance that their children will survive and thrive, thus increasing the couple's fertility.

The children not only receive information from infections overcome by their parents' ancestors, but also from those overcome by the parents themselves, since the body has a recently-discovered (and quite complex) mechanism to modify its own genome in response to infections. These modified genes are passed on to those of their offspring who are conceived after the parents have survived the infections.

### Greater Marital Stability

A match predicted by the present invention leads to greater stability of a couple's marriage. Women who are paired with men who have dissimilar alleles in the Major Histocompatibility Complex (MHC) of their genome are not only more strongly attracted to their mates and are more responsive to them, but are also more faithful to them. Men in such pairings are also more faithful to their partners. Men are more likely to be faithful to a partner who not only holds him in high regard, but who is more responsive to him during coitus. See Garver-Apgar, C. E., Gangestad, S. W., Thornhill, R., Miller, R. D., & Olp, J. J., “Major Histocompatibility Complex Alleles, Sexual Responsivity, and Unfaithfulness in Romantic Couples.” Psychological Science, Vol. 17 No. 10, Pages 830-835 (2006).

Pair-bonded women who were near ovulation reported greater extra-pair flirtation and greater mate guarding by their primary partner. As predicted, however, these effects were exhibited primarily by women who perceived their partners to be low on hypothesized good genes indicators (low in sexual attractiveness relative to investment attractiveness). See Haselton, “Conditional expression of women's desires and men's mate guarding across the ovulation cycle,” Hormones and Behavior, Vol. 49, Pages 509-518 (2006).

By analyzing the genomes of offspring of an inbred human population, Ober found strong evidence that there was a greater-than-chance probability that a child's parents had assortative (different) alleles in the MHC region. This implies that couples who had different MHC alleles were responsible for more offspring, whether they were married to each other or not, and further implies that those married couples who had different alleles tended to be more faithful. See Ober, C. Weitkamp, L. R., Cox, N., Dytch, H., Kostyu, D., Elias, S., “HLA and mate choice in humans.” American Journal of Human Genetics, Vol. 61, Pages 497-504 (1997).

Hormonal birth control (“The Pill”) reverses women's preference for complementary MHC alleles. The reason for this is that hormonal birth control (HBC) mimics pregnancy, and that pregnant women prefer to be with their own family, whose MHC alleles are similar to hers. When a woman who is not using hormonal birth control is not pregnant, her unconscious search for the best complement of genes for her children, i.e., a man whose MHC alleles are different from hers, may lead her to be unfaithful to her husband if his alleles are similar to hers.

A couple who meet and marry while the woman is using hormonal birth control is likely to have similar MHC alleles; and thus, it is also more likely that, if for any reason she stops her HBC regimen, she will be less attracted to her husband and more attracted to men with complementary MHC alleles, and thus more likely to stray. Put another way, she will be less attracted to her husband and more likely to stray. The present invention provides a powerful means of counteracting that effect, since it predicts the man's attractiveness to the woman after their marriage has been solemnized, thus leading to a more stable union.

### Mate Assessment

The present invention provides the following benefits:
1. Subscribers to online dating and other dating or introduction services will be able to predict a woman's attraction and sexual responsivity to and compatibility with a candidate man, thus improving the chances of a compatible match.
2. Individuals will be able to compare their genomes with the goal of entering into satisfying and lasting relationships.
3. Couples considering a long-term relationship or marriage will be able to assess the probable stability of that relationship and the prospective health of their offspring.
4. Because the present invention will reduce birth defects and spontaneous abortions, enormous amounts ofpublic and private money will be saved, and will, at least for a few individuals, provide a much higher quality of life.
5. Research has shown that women who have children fathered by a man with assortative (different) alleles in the MHC region have fewer miscarriages and are less likely to experience preeclampsia, a serious complication of pregnancy, and that it is less likely that their children will have birth defects.

In addition to being attracted to men with complementary MHC alleles, heterosexual women who are not using hormonal birth control (HBC) are also sexually more responsive to those men. When women are in physical proximity to men, for example in a social or work setting, they distinguish the degree of difference in their and the man's MHC alleles by scent. Although women are not usually aware of this, numerous studies have proven this beyond reasonable doubt. Surprisingly, in spite of humans' relatively poor sense of smell, people are able to distinguish among MHC variations of the same species of mouse by smell alone. The taste and smell of bodily fluids exchanged during kissing also play an important role in mate assessment.

These odors and tastes play an important role in pair-bonding and the maintenance of relationships, as is dramatically illustrated by the pervasive habit of smelling one's partner's clothes in his absence.

For obvious reasons, none of these means of mate assessment is available to people who have never met; and some substitutes that seem quite reasonable, such as viewing still photographs of partnering candidates, actually result in poorer matches than could be achieved by chance.

Poor matches can result even when the prospective partners are in close contact. The use of hormonal contraceptives such as birth-control pills reverses usual female preferences for male scent, increasing the chances that a union would result in birth defects, pregnancy complications, such as miscarriages and spontaneous abortions, and marital infidelity.

These benefits are limited to heterosexual individuals. People of other sexual orientations have different odor preferences. The relationship prediction methods of the present invention can also be used to assist these prospective couples in finding compatible mates.

### Reducing Miscarriages

The present invention reduces the likelihood that a woman will suffer a miscarriage. One embodiment of the invention ensures that a couple is not, without its knowledge, closely-enough related that its children run a high risk of defects arising from inbreeding, for example those arising from each partner's carrying a recessive deleterious gene. Couples without “chemistry” are twice as likely to miscarry.

There is a considerable body of research pointing to the relationship of miscarriages (spontaneous abortions) and preterm births (premature babies) to parents who have similar alleles (that is, variations) of genes in the Major Histocompatibilty

Complex (MHC), a region of the short arm of Chromosome 6 in humans. The antigens generated by the MHC genes are called both histocompatibility antigens and human leucocyte antigens (HLA). In a survey of the field published in 1999, Ober found that “Increased fetal loss rates among couples matching for HLA-B or for the entire haplotype suggest that compatible fetuses are less likely to survive to term than incompatible fetuses.” See Ober, Carole, “Studies of HLA, fertility and mate choice in a human isolate,” Human Reproductive Update 1999 (Publication of the European Society of Human Reproduction and Embryology), Vol. 5, No. 2 Pages 103-107 (1999). Elsewhere in the cited paper, she notes that Komlos and Schacter show “evidence demonstrating increased HLA sharing among couples with recurrent spontaneous abortion (RSA) compared with control couples . . . ” Other work by Ober provides an enormous volume of data supporting the relationship of fetal loss to similarity in MHC alleles. See Komlos, L., Zamir, R., Joshua, H., and Halbrecht, I., “Common HLA Antigens in Couples with Repeated Abortions,” Clinical Immunology and Immunopathology 7, Pages 330-335 (1977). See Schacter, B., Muir, A., Gyves, M. et al., “HLA-A, B compatibility in parents of offspring with neural-tube defects or couples experiencing involuntary fetal wastage,” The Lancet, Apr. 14, 1979, Pages 796-799.

Differing alleles in the HLA-G gene in the MHC region may decrease the chance of spontaneous abortions and preeclampsia, a complication of pregnancy which endangers both the mother and her fetus.

Preterm births levy an enormous cost on society. The Institute of Medicine (part of the National Academy of Sciences, estimates that, preterm births in the U.S. cost at least $26.2 billion in 2005, or an average of $51,600 per infant.

Women tend to select mates with differing alleles in the MHC region of their genome. The method of the present invention will substantially reduce fetal loss in couples.

### Reducing Preeclampsia

The present invention reduces the chance that a woman will suffer preeclampsia in her pregnancy. There is a higher risk of preeclampsia in couples with similar alleles in the MHC region of their genome. There are two mechanisms for this effect:
1. Women who carry a polymorphic allele of the HLA-G gene, which is expressed by the fetus and influences its placenta's attachment to the uterus) are at a higher risk of preeclampsia and fetal loss. The presence of the usual (monomorphic) form of the gene in the father's genome halves the chance that the fetus will inherit (and express) the variant polymorphic form.
2. The incidence of preeclampsia is related to the mother's tolerance to the father's genetic material. This tolerance increases through continued physical contact.

Since marital fidelity and pair bonding are higher between partners who have differing alleles in the MHC region of their genome, the present invention's use of genetic matching to increase the chances of diversity in the MHC regions of the couple's genomes will reduce the chance of preeclampsia in the mother and its consequent risk to her and her unborn child.

Hormonal birth control, e.g, the Pill, reverses women's preference for men with complementary MHC alleles. The reason for this is that the hormones used in hormonal birth control (HBC) are similar to those present in a woman's body during pregnancy, and their effect therefore mimics pregnancy; and that a pregnant woman prefers to be with her own family, whose MHC alleles are similar to hers. When a woman who is not using hormonal birth control is not pregnant, her quest for a good father for her children—a man whose MHC alleles are different from hers—may lead her to be unfaithful to her husband if his alleles are similar to hers.

A couple who meet and marry while the woman is using hormonal birth control is likely to have similar MEC alleles; and thus, it is also more likely that, if for any reason she stops her HBC regimen, she will be less attracted to her husband and more attracted to men with complementary MHC alleles, and thus more likely to stray.

As discussed elsewhere in this Application, if she conceives with her husband and her husband has similar MHC alleles, this may also lead to difficulties in pregnancy, unwanted miscarriages, poor fertility and impaired immunity in the couple's children. The present invention provides a powerful means of counteracting that effect, since it predicts the man's attractiveness to the woman after their marriage has been solemnized, thus leading to a more stable union.

Women who are presented with an array of still photographs of men and are asked to select men with whom they would consider having a relationship tend to select men with similar, not different, MHC alleles. In cultures where arranged marriages are common and in situations in which a matchmaker or other gobetween is involved, and the woman, having selected a man from such a photographic array, is under great pressure to proceed with the relationship, the chances of the woman's not being attracted to the man, and thus having an unsatisfactory relationship and the other adverse effects discussed above, is high. See Roberts, S. Craig, et al., “MHC-assortative facial preferences in humans,” Biology Letters, Vol. 1, Pages 400-403 (2005).

In cultures with arranged marriages or in those where matchmakers are used, the bride-to-be is usually quite young and has had little contact with men outside her family. She is therefore not in a position to select among candidates based upon the natural means (scent) at her disposal.

It is therefore of considerable value to dating services, matchmakers, parents in societies in which arranged marriages are common, and to the prospective partners themselves, to be able to predict the woman's attraction to a particular man during the fertile part of a long-term relationship, when for obvious reasons HBC is not used.

### XI. Responsivity

One embodiment of the present invention may be used to predict a good relationship. This prediction may be determined, in whole or in part, upon a woman's responsivity to a prospective male match. In this Specification, and in the Claims that follow, the term “responsivity” is defined as:
Sexual responsivity refers to the extent to which women are willing, interested, and enthusiastic about having sex with a romantic partner, the degree to which they are interested in trying to please a romantic partner sexually, and the degree to which they are sexually “turned on” and satisfied by a romantic partner.

### XII. Alternative Method: When a Woman is Using Hormonal Birth Control

Hormonal birth control (“The Pill”) reverses women's preference for men with complementary MHC alleles. The reason for this is that the hormones used in hormonal birth control (HBC) are similar to those present in a woman's body during pregnancy, and their effect therefore mimics pregnancy; and that a pregnant woman prefers to be with her own family, whose MHC alleles are similar to hers. When a woman who is not using hormonal birth control is not pregnant, her quest for a good father for her children—a man whose MHC alleles are different from hers—may lead her to be unfaithful to her husband if his alleles are similar to hers.

If a woman who uses the present invention to obtain a relationship prediction uses hormonal birth control, she may be provided with a report or instructions which may help her make a better-informed decision. So, for example, a relationship prediction for a woman using hormonal birth control may be generated based on the woman's preference for a man with complementary MHC alleles.

### XIII. Hormonal Birth Control & Attractiveness

One embodiment of the present invention may be used to predict an enduring relationship between a man and a woman. In this embodiment, a woman is advised that a man may find her less attractive if she changes her hormonal birth control regimen. The man's diminished attraction to the woman results from a change caused when the woman starts or stops using hormonal birth control.

In another embodiment, a website is operated which enables customers to access information presented on the website. The customer may request advice concerning the maintenance of a good relationship. Advice is provided to the customer in response to a request conveyed to the website. In one embodiment of the invention, this advice may include a recommendation that a man may find a woman less attractive if she changes her hormonal birth control regimen. In an alternative embodiment, the customer's request and the advice furnished in response may be conveyed in person, at a doctor's office or clinic, over the telephone, or by some other suitable means.

In yet another embodiment, the website may be used to ask a female if she has recently started or stopped using hormonal birth control, and if she believes that her male mate finds her less attractive since this change in her use of hormonal birth control. These responses are then correlated, and relationship advice is furnished to others based on the correlated data. This relationship advice may be supplied free of charge as a public service.

In this Specification and in the Claims that follow, the terms “hormonal birth control” is intended to include all hormonal contraceptives that contain progestin or one of its analogues and/or estrogen or one of its analogues. They include birth-control pills, certain intra-uterine devices (e.g., Mirena), vaginal rings, Norplant implants, contraceptive injections and their ilk.

### XIV. Custom-Fabricated Perfumes

FIG. 66 illustrates the step 200 of a customer 17b receiving a custom-formulated perfume 202, “MyAroma™” or “MyCologne™,”which contains olfactory reagents that correspond to her genetic attributes, and specifically, which correspond to his or her MHC-derived peptide profile.

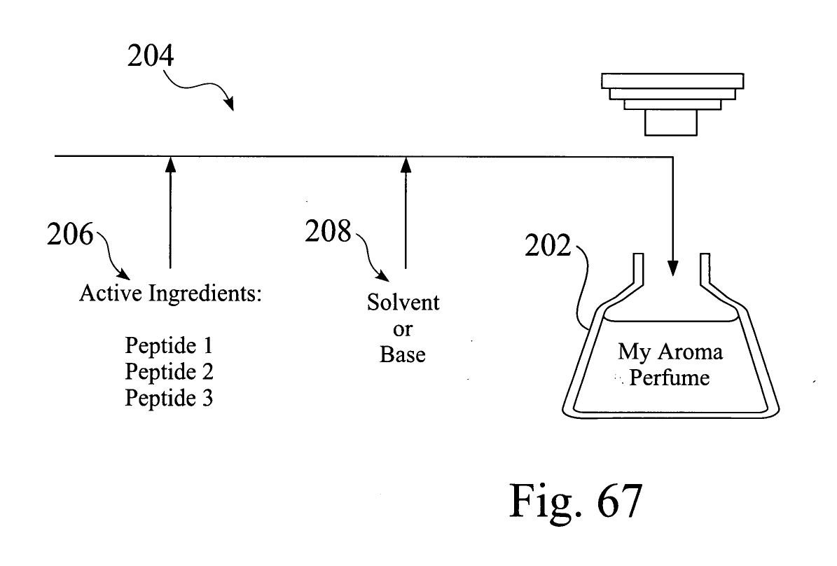

FIG. 67 depicts a method 204 of manufacturing a customized perfume 202. General methods for manufacturing compositions for dispensing fragrances, aromas and perfumes are well known in the art. According to the Scented Products Education and Information Association of Canada, ingredients in a typical fragrance “recipe” generally include:
“extracts from plants and flowers (naturals), synthetic recreations (synthetic duplications of natural fragrance materials), synthetic innovations (variations of naturally-occurring materials which have unique olfactory properties).
In general, typical fragrance formulae contain 100-350 ingredients, with an average concentration of usually less than 1%.
“In a perfume, ethyl alcohol (of the same grade and purity as in alcoholic beverages) composes 50-90% of the product, purified water may constitute 5-20% of the product, with the fragrance component accounting from 10-30% of the finished product. Also present are UV inhibitors (to prevent degradation in the bottle) and any additional colouring agents.”

### SPEIAC, 20 Britannia Road East, Suite 102, Mississauga, Ontario L4Z 3L5.

In one embodiment of the present invention, appropriate combinations of biological, synthetic or other agents such as peptides or other substances are added as active ingredients 206 to a base 208 to a mixture, together with and/or any other suitable solvents, stabilizers, agents, preservatives, dispersants, inhibitors or components. In one embodiment, the base is a solvent, such as alcohol or water. These biological agents are selected to match a genetic attribute possessed by a person.

In one implementation, the perfume or cologne 202 made in accordance with the invention contains substances which are complementary to the user's Major Histocompatibility Complex (MHC profile), which will be attractive to the same user. In the same implementation, that person may ask a spouse or mate to wear this perfume or cologne 202, which pleases the person for whom the customized perfume or cologne was made. The present invention includes both perfume or cologne intended to be used by a person selecting the perfume or cologne for herself or himself, as well as an “inverse perfume or cologne,” which is selected by one person and used by another.

The biological agents may be selected to promote the responsivity of the person using the mixture, or may be selected to promote the responsivity of another person using the mixture. The biological agents in the mixture may be used to broadcast or indicate sexual compatibility, interest, awareness or attraction. As an alternative, the biological agents may be selected to promote confidence, self-esteem or the interest or attraction of another. The invention may be used to promote relationships between members of the opposite sex, or between members of the same sex.

The specific composition of the mixture may take many forms, including, but not limited to a perfume, a cologne, a salve, a paste, an aerosol spray, a powder, or a cosmetic. The cosmetic may include skin cream, lipstick, lip balm, gel, ointment, colorant, or some other preparation that be applied to the body. The mixture is generally intended to be applied to, dispensed on or worn on the skin or hair, but may be applied on or used in conjunction with an article of clothing, which may be impregnated with the active ingredients. In yet another embodiment, the perfume 44 may be encapsulated or contained in a pill or medication that is taken internally, and which is then secreted through the skin or which causes a biological reaction which produces or mimics an odor. The mixture may also be dispensed using a variety of devices, including, but not limited to air fresheners, aroma-dispensing devices, candles and incense.

This specialized perfume 202 contains a strong preparation of personal peptides, enabling the user to “broadcast” his or her “MHC” over a wide area, and increasing his or her chances of meeting a compatible partner.

The MHC is a cluster of genes that determines details of cellular surfaces and thus immune responses, and specifies certain peptides that appear in skin secretions and urine. These peptides are responsible for odors which uniquely identify individuals who are not identical twins. Detailed information concerning the MHC may be found in Leslie A. Knapp's publication entitled The ABCs of MHC, published in Evolutionary Anthropology 14:28-37 (2005) Wiley-InterScience. MyAroma™, MyPerfume™, MyEssence™ are Trade & Service Marks owned by the Assignee of the Present Patent Application.

### XV. A Graphical Aid for Interpreting Test Results

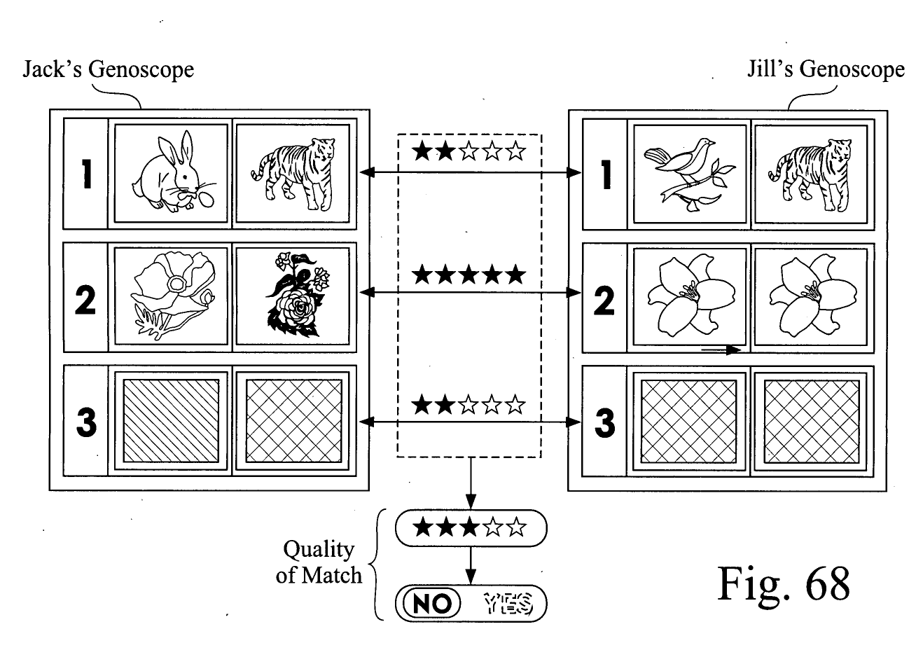

FIG. 68 presents one particular version of a graphic representation or “Genoscope™,” which illustrates a hypothetical portion of test results for a customer, and which enables the customer to easily understand the quality of a match with another person.

The same prediction method described elsewhere in this Application is useful in the absence of a dating service, or in situations where a person prefers to make their own initial contacts with prospective mates or in cases in which a person wishes to assess a potential mate from a field of known candidates. In one embodiment, a person (hereafter the “User”) submits his or her tissue, fluid or other biological sample to a laboratory for typing, and the laboratory provides the User with an alphanumeric code (the “Code”) which describes his or her genetic information, i.e., genome in the MHC region and any other regions of interest. The User may then compare his or her Code with that of another User to estimate their mutual compatibility and thus the quality of a romantic relationship that might ensue. Each User would be provided with a written guide or computer program for comparing the data embedded in the Codes and estimating the quality of the contemplated relationship.

In another embodiment, the laboratory would keep records of the genomes or Codes of each User. On request, the laboratory would compare the User's genomes or Codes for compatibility and issue a report.

An example of such a report, in easily-understood graphical form, is shown in FIG. 68. A variety of symbols are presented in a grid along rows and columns. The more symbols match, the more genomes are similar, which predict a bad match. The stars in the center of FIG. 68 indicate the approximate strength or quality of a match, with zero being the lowest quality, and five stars representing the highest. An added feature of the report could be a Compatibility Score which rates the predicted quality of the contemplated relationship in a way that can be compared with other relationships, for example on a scale of one to ten, with ten being the best possible genetic compatibility score.

### GLOSSARY

Allele:
Either of a pair of alternative Mendelian characters (as smooth or wrinkled seed in the pea) (Webster).
Antigen:
1. A usually protein or carbohydrate substance (as a toxin, enzyme, or any of certain constituents of blood corpuscles or of other cells), that when introduced into the body stimulates the production of an antibody;
2. A substance that reacts in complement fixation with an antibody to bind complement, the antigen and antibody usually being specific (Webster).
Antigen-presenting cell:
Any of various cells (as a macrophage or a B cell) that take up and process an antigen into a form that when displayed at the cell surface in combination with a molecule of the major histocompatibility complex is recognized by and serves to activate a specific Helper T cell.
Attractive:
Having qualities that arouse interest, pleasure, or affection in the observer. attractiveness.
Attribute:
A quality, character, or characteristic ascribed usually commonly: a: a characteristic either essential and intrinsic or accidental and concomitant b: a quality intrinsic, inherent, naturally belonging to a thing or person (Webster).
Attribute (genetic):
An attribute as defined above which is controlled or caused by a creature's genome.
Body odor:
The characteristic odor of a living animal body.
Chromosome:
One of the more or less rodlike chromatin-containing basophilic bodies constituting the genome and chiefly detectable in the mitotic or meiotic nucleus that are regarded as the seat of the genes, consist of one or more intimately associated chromatids functioning as a unit, and are relatively constant in number in the cells of any one kind of plant or animal (Webster).
Codominant genes:
A set of two or more alleles, each expressed phenotypically in the presence of the other (Online Medical Dictionary).
Consanguinity:
The quality or state of being related by blood or descended from a common ancestor (Webster).
Diversity in the MHC regions:
The degree to which the alleles in the Major Histocompatibility Complex differ between two individual members of the same species.
Dominant gene:
A gene that is expressed phenotypically in heterozygous or homozygous individuals.
Fertility:
Actual reproductive capacity as measured by production of offspring (Webster). In the context of this Application, this includes descendants more distant than direct offspring.
Fitness:
The fitness of the individual—having an array x of phenotypes—is the probability, s(x), that the individual will be included among the group selected as parents of the next generation.” See Hartl, D. L. A Primer of Population Genetics. Sinauer, Sunderland, Mass., 1981 (Wikipedia).
Gene:
One of the elements of the germ plasma serving as specific transmitters of hereditary characters and usually regarded as portions of deoxyribonucleic acids linearly arranged in fixed positions and as functioning through control of the synthesis of specific polypeptide chains.
Group frequency:
The frequency of occurrence of a particular group of genes or alleles in a population.
Haplotype:
A combination of alleles at multiple loci that are transmitted together on the same chromosome. Haplotype may refer to as few as two loci or to an entire chromosome depending on the number of recombination events that have occurred between a given set of loci (Wikipedia).
HBC:
See hormonal birth control.
HBC regimen:
The process of maintaining an effective level of birth-control hormones in one's body.
Heterozygote:
A cell formed by the union of heterozygous gametes : a fertilized egg : broadly : the developing individual produced from such a cell.
Heterozygous:
Producing two types of gametes with respect to one or more allelomorphic characters.
Histocompatibility antigen:
Any of the antigenic glycoproteins on the surface membranes of cells that enable the body's immune system to recognize a cell as native or foreign and that are determined by the major histocompatibility complex.
HLA:
See Human Leucocyte Anitgen.
Homozygote:
A cell formed by the union of homozygous gametes: a fertilized egg: broadly: the developing individual produced from such a cell.
Homozygous: possessing genes for only one member of at least one pair of allelomorphic characters.
Hormonal birth control (HBC):
The use of drugs containing progestin (or one of its analogues) and/or estrogen (or one of its analogues) or any other natural or synthetic hormone to control ovulation, implantation or conception and thus prevent unwanted pregnancy. These drugs may be administered orally, parentarilly or by any other means.
Human leukocyte antigen:
Any of various proteins that are encoded by genes of the major histocompatibility complex in humans and are found on the surface of many cell types (as white blood cells).
Infectious disease:
A disease caused by the entrance into and growth and multiplication in the body of bacteria, protozoans, fungi, or analogous organisms (such as filterable viruses).
Immune system diversity:
The ability of a creature's immune system to recognize a variety of threats.
Locus, plural loci:
A fixed position on a chromosome such as the position of a biomarker that may be occupied by one or more genes.
Major Histocompatibility Complex:
A group of genes that function especially in determining the histocompatibility antigens found on cell surfaces and that in man comprise the alleles occurring at four loci on the short arm of chromosome 6—abbreviation MHC.
Marital stability:
The degree to which a marriage persists.
MHC: See Major Histocompatibility Complex.
Ovulation cycle:
In a mammal, the periodic release of eggs into the uterus. More generally, the cycle which includes menstruation, ovulation, and in most mammals, estrus.
Peptide:
Any of a class of amides that are derived from two or more amino acids by combination of the amino group of one acid with the carboxyl group of another, that yield these acids on hydrolysis, that are classified according to the number of component amino acids, and that are obtained by partial hydrolysis of proteins or by synthesis (as from alpha-amino acids or their derivatives). A chain of amino acids produced by a living cell.
Perfume:
A substance that emits an odor.
Preeclampsia:
A toxic condition developing in late pregnancy characterized by a sudden rise in blood pressure, excessive gain in weight, generalized edema, albuminuria, severe headache, and visual disturbances (Webster's Unabridged).
Prediction:
An inference regarding a future event based on probability theory Webster's Unabridged).
Polymorphic:
Having or occurring in several distinct forms: exhibiting polymorphism. “Polymorphic” refers to the rare occurrence of a variant of the usually-monomorphic HLA-G gene.
Population dataset:
A set of data derived from statistics from a study of population of humans.
Recessive gene:
A gene that is phenotypically expressed in the homozygous state but has its expression masked in the presence of a dominant gene.
Relationship:
The state of affairs existing between two people or among two or more people.
Responsivity:
The extent to which women are willing, interested, and enthusiastic about having sex with a romantic partner, the degree to which they are interested in trying to please a romantic partner sexually, and the degree to which they are sexually “turned on” and satisfied by a romantic partner.
Citations marked “Webster” are from Webster's Third New International Dictionary, Unabridged. Merriam-Webster, 2002.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Personal Radio Location System that have been disclosed above are intended to educate the reader about preferred embodiments of the invention, and are not intended to constrain the limits of the invention or the scope of Claims.

### LIST OF REFERENCE CHARACTERS

10 MateFinder™
10a Man's MateFinder
10b Woman's MateFinder
11 Interrogation or seeking signal
11a First interrogation signal
11b Second interrogation signal
12 Housing
14 Power switch
15 “Seeking” indicator light
16 “Match Found” indicator light
16a First match indicator
16b Second match indicator
17a Man
17b Woman
18 LCD message screen
19 Website
20 USB port
22 Personal computer
24 USB cable
26 Battery
28 Radio/Processor assembly
30 Antenna
32 Memory
32a First memory
32b Second memory
33 Attribute
33a First set of attributes
33b Second set of attributes
34 Mask switch
35 Correlation thumbwheel
36 Microprocessor
37 Local wireless network
38 Downconverter
40 Amplifier
42 Modulator
44 Upconverter
46 Amplifier
48 Bandpass filter
111 Personal computer
112 Internet Dating Service Website
113 Web page for opening new account
114 Web page for placing order
115 Test Kit
117 Telephone
118 Retail store
119A Physician or health care provider
119B Religious leader or cleric
120 Bottle of cleaning solution
122 Cotton ball
124 Sample patch
124C Central area of patch
124S Strips extending away from central area
125 Plaster
126 Antibiotic
127 Adhesive
128 Sealable plastic bag
130 Mailing envelope, pouch or box
132 Lab technician
134 Sample analyzer
135 Analysis results
136 Good matches suggested to customer on website
137 Test results received from physician
138 Postal worker
140 Tissue sample obtained from cheek swab
142 Shopping mall
144 Kiosk
146 Odor sample captured from air surrounding person
148 Collect sample
150 Open saliva collection cup
152 Screw cap on cup and mix sample
154 Cap
156 Place closed cap in bag and seal
158 Place bag in mailer
160 Seal mailing box
162 Mail box containing saliva sample to laboratory
164 Laboratory collection kit preparation tasks
166 Internet Dating Service tasks
168 Customer tasks
170 Laboratory analysis, matching and reporting tasks
172 Dating Service and laboratory cooperative tasks
174 Graph of MHC alleles shared on the horizontal axis, a female sexual responsivity to partner on the vertical axis
176 Bar chart showing the number of MHC alleles shared on the horizontal axis, and the expected female sexual responsivity to partner on the vertical axis
178 Chart that shows the relationship of alleles in the MHC Group on Human Chromosome No. 6
180 MHC Allele Groups
182 HLA-A Allele Group Frequency for a European Population Dataset
184 HLA-B Allele Group Frequency for a European Population Dataset
186 HLA-DRβ1 Allele Group Frequency for a European Population Dataset
188 Allele Group Frequencies
190 AB/DR 1 Group Haplotype Frequency
194 Man using a MateFinder™ device
196 MateFinder™ device
198 Detailed view of a MateFinder™ device
200 Woman whose tissue sample has already been analyzed receives a custom-formulated perfume which contains aromas that correspond to her genetic attributes
202 Custom perfume based on genetic attributes
204 Method of manufacturing a customized perfume
206 Active ingredients
208 Solvent or base

1. An apparatus comprising:
a first transceiver device (10a);
said first device transceiver (10a) including a first memory (32a); said first memory (32a) for storing a first set of attributes first attribute (33a) that are associated with selected by a first user (17a), wherein said first set of attributes (33a) comprise at least one genetic attribute (33a) associated with said first user (17a);
said first device transceiver (10a) including a first match indicator (16a);
a second device transceiver (10b);
said second device transceiver (10b) including a second memory (32b); said second memory (32b) for storing a second set of attributes attribute (33b) that are associated with selected by a second user (17b), wherein said second set of attributes (33b) comprise at least one genetic attribute (33b) associated with said second user (17b);
said second device transceiver (10b) including a second match indicator (16b);
said first device transceiver (10a) for transmitting emitting a first interrogation signal (11a);
said first interrogation signal (11a) being received by said second device transceiver (10b); and
said first match indicator (16a) on said first device transceiver (10a) being activated when said first interrogation signal (11a) finds a match between said first set of attributes attribute (33a) stored in said first memory (32a) in said first device transceiver (10a) and said second set of attributes attribute (33b) stored in said second memory (32b) in said second device transceiver (10b);
said first attribute (33 a) and said second attribute (33b) include personal characteristics and the analysis of genetic characteristics of said first user (17a) and said second user (17b); and
said first and said second attributes (33a, 33b) being used to predict a good match.

2. An apparatus as recited in claim 1, in which said second match indicator (16b) is activated if said first interrogation signal (11a) from said first device transceiver (10a) finds a match between said first set of attributes attribute (33a) stored in said first memory (32a) in said first device transceiver (10a) and said second set of attributes attribute (33b) stored in said second memory (32b) in said second device transceiver (10b).

3. An apparatus as recited in claim 1, in which both said first and said second devices transceivers (10a,b) generate radio waves.

4. An apparatus as recited in claim 1, in which both said first and said second devices transceivers (10a,b) generate light signals.

5. An apparatus as recited in claim 1, in which both said first and said second devices transceivers (10a,b) generate ultrasonic signals.

6. An apparatus as recited in claim 3, in which said radio waves are generally in an ISM frequency band.

7. An apparatus as recited in claim 3, in which said radio waves are generally in the 900 MHz frequency band.

8. An apparatus as recited in claim 3, in which said radio waves are generally in the 2.4 GHz frequency band.

9. An apparatus as recited in claim 3, in which said radio waves are generally in the 5.8 GHz frequency band.

10. An apparatus as recited in claim 3, in which said radio waves are generally in the 59-64 GHz frequency band.

11. An apparatus as recited in claim 3, in which said first and said second devices transceivers (10a,b) operate as unlicensed radio frequency devices under Part 15 of the Rules of the Federal Communication Commission.

12. An apparatus as recited in claim 3, in which said first and said second devices transceivers (10a,b) operate under Part 95 of the Rules of the Federal Communication Commission.

13. An apparatus as recited in claim 1, in which said first and said second memory (32a,b) are non-volatile solid-state memories.

14. An apparatus as recited in claim 1, in which said first and said second memories (32a,b) are programmed by a user's interaction with a website (19).

15. An apparatus as recited in claim 1, in which said first set of attributes attribute (33a) describes the user (17a) of said first device transceiver (10a).

16. An apparatus as recited in claim 1, in which said second set of attributes attribute (33b) describes the user of said first device transceiver (10a).

17. An apparatus as recited in claim 1, in which said second set of attributes attribute (33b) describes the user (17b) of said second device transceiver (10b).

18. An apparatus as recited in claim 1, in which said first set of attributes attribute (33a) describes the user (17b) of said second device transceiver (10b).

19. An apparatus as recited in claim 1, in which said first and said second match indicators (16a,b) comprise a light.

20. An apparatus as recited in claim 1, in which said first and said second match indicators (16a,b) comprise an audible alarm.

21. An apparatus as recited in claim 1, in which said first and said second match indicators (16a,b) comprise a vibrator.

22. An apparatus as recited in claim 1, in which said match is a correlation of said first and said second sets of attributes (33a,b).

23. An apparatus as recited in claim 1, further comprising a correlation switch that allows said user (17a,b) to adjust a level of correlation required to find a match between first and said second sets of attributes (33a,b).

24. An apparatus as recited in claim 1, in which said first set of attributes attribute (33a) comprises a set containing a plurality of attributes.

25. An apparatus as recited in claim 1, further comprising a mask switch (34) for avoiding direction finding.

26. An apparatus as recited in claim 1, further comprising a screen (18) for displaying a message.

27. An apparatus as recited in claim 1, further comprising a local wireless network (37); said local wireless network (37) for receiving said first and said second interrogation signals (11a,b).

28. An apparatus as recited in claim 1, further comprising a local wireless network;
said local wireless network for relaying said first and said second interrogation signal.

29. An apparatus as recited in claim 1, in which said first interrogation signal (11a) is broadcast to a plurality of other transceivers (10).

30. An apparatus as recited in claim 1, which enables said user (17a,b) to reduce the risk inhertent in Internet dating by allowing said user (17a,b) to evaluate a prospective mate before initiating contact.

31. An apparatus as recited in claim 12, in which said user (17a,b) employs said website (19) to request a background check.

32. An apparatus as recited in claim 12, in which said user (17a,b) employs said website (19) to request a certification of said first set of attributes attribute (33a).

33. An apparatus as recited in claim 32, in which said certification is broadcast as part of said interrogation signal (11).

34. A method comprising the steps of:
transmitting a emitting an interrogation signal (11);
attempting to establish a match between a first set of attributes attribute (33a) and a second set of attributes attribute (33b) using said interrogation signal (11), wherein said first set of attributes (33b) comprises at least one genetic attribute (33b) associated with a first user (17b), and wherein said second set of attributes (33b) comprises at least one genetic attribute (33b) associated with a second user (17b); and
activating a match indicator (16) when said match is found.

35. A method as recited in claim 34, in which said interrogation signal (11) is a radio signal.

36. A method as recited in claim 34, in which said interrogation signal (11) is emitted by a transceiver device (10).

37. A method as recited in claim 34, in which said interrogation signal (11) is received by a plurality of other transceivers devices (10).

38. A method as recited in claim 34, in which matching said first set of attributes attribute (33a) to said second set of attributes attribute (33b) is accomplished by a mathematical calculation which measures the correlation of said first set of attributes attribute (33a) and said second set of attributes attribute (33b).

39. A method as recited in claim 34, in which said match indicator (16) is an indicator light.

40. A method as recited in claim 34, in which said match indicator (16) is an audible alarm.

41. A method as recited in claim 34, in which said match indicator (16) is a vibrator.

42. A method as recited in claim 34, further comprising the step of:
using a website (19) to select enter said first set of attributes attribute (33a).

43. A method as recited in claim 34, further comprising the step of:
using a website (19) to select enter said second set of attributes attribute (33b).

44. A propagated signal comprising:
an interrogation signal (11);
said interrogation signal (11) for seeking a match between a first attribute (33a) and a second attribute (33b); and
an alert signal (16); said alert signal (16) being initiated when said match is established.

45. A method comprising the steps of:
providing a website; said website being accessible to a plurality of persons; said plurality of persons including a plurality of women and a plurality of men;
receiving a plurality of sets of personal characteristics from said plurality of persons via said website; said sets of personal characteristics including a first set of personal characteristics which describe one of said persons who submit a first set of personal characteristics, and a second set of personal characteristics which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to one of said plurality of persons who provided said sample upon receiving a request from said same one of said plurality of persons; and
providing a relationship prediction to one of said plurality of persons; said relationship prediction being based on a combination of both a positive correlation of said first and said second sets of personal characteristics, and a measured dissimilarity between-the sequence of genetic characteristics of a pair of said samples.

46. A method as recited in claim 45, in which said website includes a guide for helping said plurality of persons to provide said first and said second set of personal characteristics.

47. A method as recited in claim 45, in which said sample is obtained from a skin patch.

48. A method as recited in claim 45, in which said sample is obtained from saliva.

49. A method as recited in claim 45, in which said sample is obtained from blood.

50. A method as recited in claim 45, in which said first and said second sets of personal characteristics include information that describe desirable personality attributes.

51. A method as recited in claim 45, in which said first and said second sets of personal characteristics include information that describes desirable physical attributes.

52. A method as recited in claim 45, in which said first and said second sets of personal characteristics include information that describes desirable educational attributes.

53. A method as recited in claim 45, in which said samples are received by U.S. Mail.

54. A method as recited in claim 45, in which said samples are collected at a physical site.

55. A method as recited in claim 45, in which said sequences of genetic characteristics include a sequence of genetic information from the Major Histocompatibility Complex.

56. A method as recited in claim 45, in which said sequences of genetic characteristics include a sequence of genetic information from the DRD4 locus.

57. A method as recited in claim 45, in which said sequences of genetic characteristics include a sequence of genetic information from the AVPR1a locus.

58. A method as recited in claim 45, in which said sequences of genetic characteristics include a sequence of genetic information from the CD38 locus.

59. A method as recited in claim 45, in which said sequences of genetic characteristics include a sequence of genetic information from the ER-α locus.

60. A method as recited in claim 45, comprising the additional step of:
increasing the chances that an offspring of one of said plurality of women and one of said plurality of men will be healthy.

61. A method as recited in claim 45, further comprising the step of:
reducing the risk producing a child with a birth defects that may arise from one of said plurality of women and one of said plurality of men who are too closely related, and who may carry the same deleterious recessive gene.

62. A method as recited in claim 45, further comprising the step of:
increasing the fertility of one of said plurality of women and one of said plurality of men.

63. A method as recited in claim 45, further comprising the step of:
increasing the likelihood of reproductive success for one of said plurality of women and one of said plurality of men.

64. A method as recited in claim 45, further comprising the step of:
enhancing the immune system diversity of an offspring of one of said plurality of women and one of said plurality of men.

65. A method as recited in claim 45, further comprising the step of:
increasing the stability of a marriage between one of said plurality of women and one of said plurality of men.

66. A method as recited in claim 45, further comprising the step of:
enabling a subscriber to an online dating service to predict one of said plurality of women's attraction to one of said plurality of men, thus improving the chances of a compatible match.

67. A method as recited in claim 45, further comprising the step of:
enabling an individual to compare their own genome to another's genome with the goal of entering into a satisfying and lasting relationship.

68. A method as recited in claim 45, further comprising the step of:
enabling one of said plurality of women and one of said plurality of men, who are considering a long-term relationship, to assess the probable stability of said relationship and the prospective health of their offspring.

69. A method as recited in claim 45, further comprising the step of:
reducing the likelihood that one of said plurality of women will suffer a miscarriage.

70. A method as recited in claim 45, further comprising the step of:
reducing fetal loss for one of said plurality of women and one of said plurality of men.

71. A method as recited in claim 45, further comprising the step of:
reducing the chance that one of said plurality of women will suffer preeclampsia in her pregnancy.

72. A method comprising the steps of:
providing a relationship prediction service to an organization for a fee paid by said organization;
sending a sample collection kit to each of a plurality of persons; said persons being affiliated with said organization;
receiving a plurality of samples from a portion of said plurality of persons;
analyzing each of a plurality of said samples which have been received to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person;
providing a relationship prediction to said organization; said relationship prediction being based on a combination of both a positive correlation of said first and said second sets of personal characteristics and a measured dissimilarity between the sequence of genetic characteristics of a pair of said samples; and
furnishing said relationship prediction to the person who provided said sample.

73. A method as recited in claim 72, in which said organization is an online dating service.

74. A method as recited in claim 72, in which said organization is a resort.

75. A method as recited in claim 72, in which said organization is a club.

76. A method as recited in claim 72, in which said organization is a church.

77. A method as recited in claim 72, in which said organization is a cruise line.

78. A method as recited in claim 72, in which said organization is a casino.

79. A method as recited in claim 72, in which said samples are received by a test facility.

80. A method as recited in claim 72, in which said samples are collected at a sample collection site.

81. A method as recited in claim 72, in which said sample is obtained from a skin patch.

82. A method as recited in claim 72, in which said sample is obtained from saliva.

83. A method as recited in claim 72, in which said sample is obtained from blood.

84. A method as recited in claim 72, in which said first and said second sets of Personal characteristics include information that describe desirable personality attributes.

85. A method as recited in claim 72, in which said first and said second sets of personal characteristics include information that describe desirable physical attributes.

86. A method as recited in claim 72, in which said first and said second sets of personal characteristics include information that describe desirable educational attributes.

87. A method as recited in claim 72, in which said samples are received by a postal service.

88. A method as recited in claim 72, in which said samples are collected at a physical site.

89. A method as recited in claim 72, in which said sequences of genetic characteristics include a sequence of genetic information from the Major Histocompatibility Complex.

90. A method as recited in claim 89, further comprising the steps of:
storing said person's set of genetic attributes and said set of genetic attributes for a member of the opposite sex in a personal radio device; and
using a personal radio to find a match.

91. A method comprising the steps of:
providing a relationship prediction service to a matchmaker for a fee paid by said matchmaker;
sending a sample collection kit to each of a plurality of persons; said persons being customers of said matchmaker;
receiving a plurality of samples from a portion of said plurality of persons;
analyzing each of a plurality of said samples which have been received to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person;
providing a relationship prediction to said matchmaker; said relationship prediction being based on a combination of both a positive correlation of said first and said second sets of personal characteristics and a measured dissimilarity between the sequence of genetic characteristics of a pair of said samples; and
furnishing said relationship prediction to the person who provided said sample.

92. A method comprising the steps of:
providing a website; said website being accessible to a plurality of persons;
receiving a plurality of sets of personal characteristics from said plurality of persons via said website; said sets of personal characteristics including a first set of personal characteristics which describe one of said persons who submit a first set of personal characteristics, and a second set of personal characteristics which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person; and
providing a relationship prediction to one of said plurality of individuals; said relationship prediction being based on a combination of both a positive correlation of said first and said second sets of personal characteristics, and a measured responsivity of a female to a male based upon the comparison of genetic characteristics.

93. A method comprising the steps of:
providing a website; said website being accessible to a plurality of persons; said plurality of persons including a plurality of women and a plurality of men;
receiving a plurality of sets of personal characteristics from said plurality of persons via said website; said sets of personal characteristics including a first set of personal characteristics which describe one of said persons who submit a first set of personal characteristics, and a second set of personal characteristics which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person; and
providing a relationship prediction to one of said plurality persons; said relationship prediction being based on a combination of both a positive correlation of said first and said second sets of personal characteristics, and a measured dissimilarity between the sequence of genetic characteristics of a pair of said samples.

94. A method comprising the steps of:
providing a database; said database containing data concerning a plurality of persons;
said plurality of persons including a plurality of women and a plurality of men;
said sets of personal characteristics including a first set of personal characteristics which describe one of said persons who submit a first set of personal characteristics, and a second set of personal characteristics which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person; and
providing a relationship prediction to one of said plurality of persons; said relationship prediction being based on a combination of both a positive correlation of said first and said second sets of personal characteristics, and a measured dissimilarity between the sequence of genetic characteristics of a pair of said samples.

95. A method comprising the steps of:
providing a website; said website being accessible to a plurality of persons; said plurality of persons including a plurality of women and a plurality of men;
receiving a plurality of sets of personal characteristics from said plurality of persons via said website; said sets of personal characteristics including a first set of personal characteristics which describe one of said persons who submit a first set of personal characteristics, and a second set of personal characteristics which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person;
providing a relationship prediction to one of said plurality of persons; said relationship prediction being based on a combination of both a positive correlation of said first and said second sets of personal characteristics, and a measured dissimilarity between the sequence of genetic characteristics of a pair of said samples; and
providing additional instructions to the person who provided said sample if said person who provided said sample is using hormonal birth control.

96. A method comprising the steps of:
providing a database; said database containing data concerning a plurality of persons;
said plurality of persons including a plurality of women and a plurality of men;
said sets of personal characteristics including a first set of personal characteristics which describe one of said persons who submit a first set of personal characteristics, and a second set of personal characteristics which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person;
providing a relationship prediction to one of said plurality persons; said relationship prediction being based on a combination of both a positive correlation of said first and said second sets of personal characteristics, and a measured dissimilarity between the sequence of genetic characteristics of a pair of said samples; and
providing additional instructions to the person who provided said sample if said person who provided said sample is using hormonal birth control.

97. A method comprising the steps of:
providing an introduction service; said introduction service for maintaining a database containing data concerning a plurality of persons; said plurality of persons including a plurality of women and a plurality of men;
said sets of personal characteristics including a first set of personal characteristics which describe one of said persons who submit a first set of personal characteristics, and a second set of personal characteristics' which describe a perceived match for another person;
collecting a sample from a portion of each of said plurality of persons;
analyzing each of a plurality of said samples which have been collected to determine a sequence of genetic characteristics for each of said plurality of samples;
storing the results of the analysis of said plurality of samples;
providing a copy of one of said sequences of genetic characteristics for one of said samples to the person who provided said sample upon receiving a request from the same person; and
providing a relationship prediction to one of said plurality persons; said relationship prediction being based on a combination of both a positive correlation of said first and said second sets of personal characteristics, and a measured dissimilarity between the sequence of genetic characteristics of a pair of said samples.

98. A composition of matter comprising:
an active ingredient (206);
a base (208);
said active ingredient (206) being added to said base (208) to compose a mixture;
said active ingredient (206) including a biological agent;
said biological agent being selected to match a genetic attribute possessed by a person.

99. A composition of matter as recited in claim 54, in which said base (208) is a solvent.

100. A composition of matter as recited in claim 54, in which said base (208) is alcohol.

101. A composition of matter as recited in claim 54, in which said base (208) is water.

102. A composition of matter as recited in claim 98, in which said biological agent is a peptide.

103. A composition of matter as recited in claim 98, in which said peptide is selected from a group of peptides related to a cluster of human genes called the Major Histocompatibility Complex.

104. A composition of matter as recited in claim 98, in which said peptide is selected to promote the responsivity of a person using said mixture.

105. A composition of matter as recited in claim 98, in which said peptide is selected to promote the responsivity of a person to another person using said mixture.

106. A composition of matter as recited in claim 98, in which said peptide is selected to promote the confidence of a person using said mixture.

107. A composition of matter as recited in claim 98, in which said peptide is selected to promote the interest of another person using said mixture.

108. A composition of matter as recited in claim 98, in which said peptide is selected to promote the attraction of a person using said mixture.

109. A composition of matter as recited in claim 98, in which said mixture is fabricated as a perfume.

110. A composition of matter as recited in claim 98, in which said mixture is fabricated as a cologne.

111. A composition of matter as recited in claim 98, in which said mixture is fabricated as a salve.

112. A composition of matter as recited in claim 98, in which said mixture is fabricated as an aerosol spray.

113. A composition of matter as recited in claim 98, in which said mixture is incorporated in a cosmetic.

114. A composition of matter as recited in claim 69, in which said cosmetic is a lipstick.

115. A composition of matter as recited in claim 98, in which said mixture is applied to the skin.

116. A composition of matter as recited in claim 98, in which said mixture is applied to an article of clothing.

117. A composition of matter as recited in claim 98, in which said mixture is contained in an air freshener.

118. A composition of matter as recited in claim 98, in which said mixture is contained in an aroma-dispensing device.

119. A composition of matter as recited in claim 98, in which said mixture is contained in a candle.

120. A composition of matter as recited in claim 98, in which said mixture is contained in a piece of incense.

121. A perfume comprising:
a base (208); and
a plurality of active ingredients (206); said plurality of active ingredients (206) being mixed with said base (208);
said plurality of active ingredients (206) being selected based on an analysis of a human sample; said human sample containing information regarding a genetic analysis of a user from whom said sample was obtained;
said plurality of active ingredients (206) being further selected to elicit a sexual response.

122. A perfume as recited in claim 98, which is worn by said user, from whom said human sample was obtained.

123. A perfume as recited in claim 98, which is worn by said user, from whom said human sample was obtained, to broadcast sexual compatibility.

124. A perfume as recited in claim 98, which is worn by another person designated by said user, from whom said human sample was obtained.

125. A perfume as recited in claim 99, which is worn by another person designated by said user, from whom said human sample was obtained, to broadcast sexual compatibility.

126. A perfume as recited in claim 98, which is contained in a medication that is taken internally, and which is then secreted through the skin.

127. A perfume as recited in claim 98, which is contained in a medication that is taken internally, and then which causes a biological reaction which produces an odor.

128. A method comprising the steps of:
predicting a good relationship; and
advising a woman that a man may find her less attractive if she has started using hormonal birth control.

129. A method comprising the steps of:
predicting a good relationship; and
advising a woman that a man may find her less attractive if she has stopped using hormonal birth control.

130. A method comprising the steps of:
operating a website;
enabling a customer to access said website;
allowing said customer to request advice concerning maintaining a good relationship; and
providing advice to said customer;
said advice including a recommendation that a man may find her less attractive if she has started using hormonal birth control.

131. A method comprising the steps of:
operating a website;
enabling a customer to access said website;
allowing said customer to request advice concerning maintaining a good relationship; and
providing advice to said customer;
said advice including a recommendation that a man may find her less attractive if she has stopped using hormonal birth control.

132. A method comprising the steps of:
operating a website;
enabling a customer to access said website;
asking a female customer if she has started using hormonal birth control;
asking a female customer if she believes that her male mate finds her less attractive since she changed her hormonal birth control;
correlating her responses; and
providing advice based on said responses to other female customers accessing said website as a public service.

133. A method comprising the steps of:
operating a website;
enabling a customer to access said website;
asking a female customer if she has stopped using hormonal birth control;
asking a female customer if she believes that her male mate finds her less attractive since she has stopped using her hormonal birth control;
correlating her responses; and
providing advice based on said responses to other female customers accessing said website as a public service.

134. A method comprising the steps of:
providing a website; said website being accessible to a plurality of persons; said plurality of persons including a plurality of women and a plurality of men;
receiving a set of personal characteristics from a woman via said website; said set of personal characteristics including a first set of personal characteristics which describe said woman, who submits a first set of personal characteristics, and a second set of personal characteristics which describe a suitable man;
collecting a plurality of samples from said woman and from said plurality of men;
analyzing said plurality of samples to determine a plurality of sequences of genetic characteristics;
storing the results of the analysis of said plurality of samples;
providing a copy sequence of genetic characteristics of said sample to said woman who provided said sample upon receiving a request from said woman; and
providing a relationship prediction to said woman; said relationship prediction being based on a combination of both a positive correlation of said first and said second sets of personal characteristics, and a measured dissimilarity between the sequence of genetic characteristics of a pair of said plurality of samples.

135. A method as recited in claim 134, further comprising the step of:
advising a woman that a man may find her less attractive if she has started using hormonal birth control.

136. A method as recited in claim 134, further comprising the step of advising a woman that a man may find her less attractive if she has stopped using hormonal birth control.

137. A method comprising the steps of:
obtaining a sample from a first person;
obtaining a sample from a second person;
analyzing both of said first and said second samples to produce a first and a second genetic sequence;
comparing said first and said second genetic sequences;
predicting a match between said first person and said second person based on the comparison of said first and said second genetic sequences; and
producing a graphic representation of said match;
said graphic representation of said match illustrating the quality of said match.

138. A method as recited in claim 137, further comprising the step of:
furnishing said first and said second samples to a laboratory for analysis;
said laboratory providing one of said first and said second persons with an alphanumeric code which describes their own genetic sequences.

139. A method as recited in claim 138, further comprising the step of:
comparing a code with that of another person to estimate mutual compatibility and quality of a potential romantic relationship.

140. A method as recited in claim 139, further comprising the step of:
comparing a code with that of another person to estimate mutual compatibility and quality of a potential romantic relationship.

141. A method as recited in claim 140, further comprising the step of:
providing a written guide for comparing the data embedded in a code to estimate the quality of a contemplated relationship.

142. A method as recited in claim 140, further comprising the step of:
providing a computer program for comparing the data embedded in a code to estimate the quality of a contemplated relationship.

143. A method as recited in claim 142, further comprising the step of:
keeping a record of said genetic sequence at said laboratory.

144. A method as recited in claim 143, further comprising the steps of:
comparing said first and said second genetic sequences at said laboratory; and
issuing a report.

145. A method as recited in claim 144, further comprising the steps of:
said report including a compatibility score which rates the predicted quality of a contemplated relationship.
